(19) United States
(12) Patent Application Publication
(10) Pub. No.: US 2024/0000173 A1
(43) Pub. Date: Jan. 4, 2024

(54) GLOVE WITH LONGITUDINAL STAYS

(71) Applicant: Summit Glove Inc., Minerva, OH (US)

(72) Inventor: James L. Hull, Malvern, OH (US)

(73) Assignee: Summit Glove Inc., Minerva, OH (US)

(21) Appl. No.: 18/363,578

(22) Filed: Aug. 1, 2023

Related U.S. Application Data
(63) Continuation-in-part of application No. 18/191,047, filed on Mar. 28, 2023.
Application No. 18/191,047 is a continuation-in-part of application No. 17/540,368, filed on Dec. 2, 2021.
Application No. 17/540,368 is a continuation of application No. 16/787,560, filed on Feb. 11, 2020, now Pat. No. 11,197,509.
Application No. 16/787,560 is a continuation of application No. 16/209,066, filed on Dec. 4, 2018, now Pat. No. 10,602,787.
Application No. 16/209,066 is a continuation-in-part of application No. 15/136,191, filed on Apr. 22, 2016, now Pat. No. 10,390,575.
(60) Provisional application No. 62/152,302, filed on Apr. 24, 2015.

(51) Int. Cl. A41D 19/00; B32B 25/08; B32B 25/14

(52) U.S. Cl. CPC A41D 19/0082; A41D 19/0058; A41D 19/0003; B32B 25/08; B32B 25/14; A41D 19/0055; B32B 2437/02; A41D 2400/80; A41D 19/01547

(57) ABSTRACT

A glove including a wrist region; a palm region extending outwardly from the wrist region; a plurality of digit regions extending outwardly from the palm region, wherein each digit region of the plurality of digit regions has a longitudinal axis extending along the digit region from the tip of the digit region to the palm region; an interior cavity bounded and defined by the wrist region, the palm region, and the plurality of digit regions, wherein the interior cavity is accessible via an opening defined by the wrist region. At least one gripping zone is provided on at least one digit region of the plurality of digit regions. The at least one gripping zone is oriented substantially parallel to the longitudinal axis of the at least one digit region.

### REFERENCE TO RELATED APPLICATIONS

This application is a Continuation-in-Part of U.S. application Ser. No. 18/191,047, filed Mar. 28, 2023, which is a Continuation-in-Part of U.S. application Ser. No. 17/540,368, filed Dec. 2, 2021, which is a Continuation of U.S. application Ser. No. 16/787,560 filed Feb. 11, 2020, now U.S. Pat. No. 11,197,509, which is a Continuation of U.S. application Ser. No. 16/209,066 filed Dec. 4, 2018, now U.S. Pat. No. 10,602,787, which is a Continuation-in-Part of U.S. application Ser. No. 15/136,191 filed Apr. 22, 2016, now U.S. Pat. No. 10,390,575, which application claims the benefit of U.S. Provisional Application Ser. No. 62/152,302 filed Apr. 24, 2015. The entire disclosures of all of these applications are incorporated herein by reference in their entirety.

### TECHNICAL FIELD

This disclosure is directed to gloves. More particularly, the disclosure relates to gloves for use in tasks which require dexterity and tactile sensitivity. Specifically, the present disclosure relates to a glove having at least one gripping zone in one or more digit regions of the glove, where each gripping zone is oriented substantially parallel to an imaginary longitudinal axis of the associated digit region. Each gripping zone locally reduces the circumference of the associated digit region such that there is direct contact between the gripping zone and the user's finger or thumb received in an interior of the digit region. During use of the glove the frictional contact between the at least one gripping zone and the user's skin helps to prevent relative movement between the digit region and the user's finger or thumb.

### BACKGROUND ART

Nitrile or nitrile rubber gloves are well known for use in the medical field. One of the problems with previously known medical gloves is that tactile sensitivity and dexterity may be reduced or lost because of the presence of glove material between the user's sensitive fingertips and the patient or equipment contacted with the user's gloved hand. If surgical gloves are worn for a long period of time there is a tendency for the glove to stretch. The stretching can result in the gloves losing their ability to cling to the user's hand and, more particularly, to the user's fingertips. When the glove material stretches and stops clinging tightly to the user thumb or fingers, the glove material can tend to slide along the length of the thumb or fingers. There is therefore a tendency for the user's tactile sensitivity and finger dexterity to deteriorate over the course of a few hours while wearing the gloves.

### SUMMARY OF THE INVENTION

A glove is disclosed herein. The glove has one or more gripping zones which tend to grip onto a user's thumb or finger and thereby tends to remain in clinging-engagement with the user's hand during use of the glove. Tactile sensitivity and finger dexterity while wearing the glove is therefore maintained for a longer period of time relative to previously-known gloves.

The glove according to the present disclosure includes a wrist region, a palm region extending outwardly from the wrist region, and a plurality of digit regions extending outwardly from the palm region. Each digit region has a longitudinal axis extending from a tip of the digit region to the palm region of the glove. An interior cavity is bounded and defined by the wrist region, the palm region, and the plurality of digit regions. The interior cavity is accessible via an opening defined by the wrist region.

In accordance with the present disclosure, at least one gripping zone is provided on at least one digit region of the plurality of digit regions. The at least one gripping zone is oriented substantially parallel to the longitudinal axis of the associated digit region. The at least one gripping zone extends for less than quarter of the circumference of the digit region. The at least one gripping zone extends for more than half of a total length of the at least one digit region but less than three quarters of the total length thereof, where the total length is measured from the tip of the at least one digit region to the palm region of the glove.

The gripping zone is in the form of an indentation in the material of the glove. The concave indentation forms a projection that extends into a portion of the interior cavity of the glove as defined by the digit region. The projection contacts the user's finger or thumb received within the portion of the interior cavity and frictionally engages the user's finger or thumb. This frictional engagement opposes the tendency of the digit region to slide relative to the person's finger or thumb during use of the glove.

In one embodiment the at least one gripping zone comprises a first stay and a second stay which are arranged on opposed surfaces of the associated digit region. In one embodiment, the first stay and the second stay are provided on the front and back of the associated digit region. In one embodiment, the first stay and the second stay are provided on the first side and the second side of the associated digit region.

The glove disclosed herein is fabricated from any suitable material such as nitrile, nitrile rubber, or natural rubber. The glove material preferably is free of or essentially free of zinc and/or sulfur and/or fluoride, and/or cross-links, and/or accelerators and/or accelerants. Some accelerators/accelerants that the glove's material may be free of or essentially free of may include carbonates or thiurams. The glove material which is free of or essentially free of zinc and/or sulfur and/or fluoride, and/or cross-links, and/or accelerators and/or accelerants will at least comprise a portion of the glove which will contact the user's skin when the glove is worn. The glove material preferably is also formulated to be resistant to a variety of toxic or corrosive compounds or chemicals, such as fentanyl. The composition of the disclosed glove may tend to reduce hypersensitivity or allergic reactions in populations which may be required to frequently wear protective gloves, such as medical practitioners.

In one aspect, an exemplary embodiment of the present disclosure may provide a glove comprising a wrist region; a palm region extending outwardly from the wrist region; a plurality of digit regions extending outwardly from the palm region; at least one gripping zone provided on at least one digit region of the plurality of digit regions; wherein the at least one gripping zone is oriented substantially parallel to an imaginary longitudinal axis of the at least one digit region, wherein the imaginary longitudinal axis extends from a tip of the at least one digit region to the palm region; wherein a respective digit region of the plurality of digit regions includes a first circumference which includes the at least one gripping zone and a second circumference which does not include the at least one gripping zone; and wherein the first circumference is smaller than the second circumference.

In one embodiment, the at least one gripping zone comprises a concave indentation formed in the at least one digit region. In one embodiment, the concave indentation projects into an interior cavity defined by the at least one digit region and is configured to frictionally engage a person's finger or thumb received within the interior cavity. In one embodiment, the at least one digit region has a circumference and the at least one gripping zone extends for less than the circumference of the at least one digit region. In one embodiment the at least one gripping zone extends for less than the total circumference of the at least one digit region. In one embodiment, the at least one gripping zone extends for less than one quarter of the total circumference of the at least one digit region.

In one embodiment, the at least one gripping zone may be provided in one or both of a front and a back of the at least one digit region. In one embodiment, the at least one gripping zone may be provided in one or both of a first side and a second side of the at least one digit region. In one embodiment, the at least one gripping zone may comprise a first stay and a second stay, wherein the first stay and the second stay are opposed to one another. In one embodiment, the first stay and the second stay may be laterally aligned with one another. In one embodiment, the first stay and the second stay each may comprise less than one quarter of a circumference of the at least one digit region. In one embodiment, an end of the first stay and an end the second stay may be circumferentially spaced a distance away from one another. In one embodiment, the first stay may be provided in a front of the at least one digit region and the second stay may be provided in a back of the at least one digit region. In one embodiment, the first stay may be provided on a first side of the at least one digit region and the second stay may be provided on a second side of the at least one digit region.

In one embodiment, the glove may further comprise texturing on an exterior surface of the at least one gripping zone. In one embodiment, the texturing may be applied to the exterior surface via a micro-etching process.

In one embodiment, each of the at least one digit region may include a fingertip region and a remaining portion, wherein the fingertip region originates at a tip of the at least one digit region and extends towards the palm region of the glove. The fingertip region terminates in a location which will be adjacent to i.e., near where a first knuckle of a person's finger or thumb will be when the glove is worn. The remaining portion extends from the fingertip region to the palm region. The fingertip region is of a reduced circumference relative to the remaining portion. In one embodiment, the remaining portion may include a transition portion which extends outwardly from the fingertip region, wherein the transition portion tapers in circumference moving in a direction from the palm region towards the fingertip region. In one embodiment, the fingertip region may be of a bullet-tip configuration.

In another aspect, an exemplary embodiment of the present disclosure may provide a method comprising inserting a person's hand through an opening defined in a wrist region of a glove; receiving a person's finger or thumb into a digit region of the glove, wherein the digit region has an imaginary longitudinal axis extending from a tip of the digit region to a palm region of the glove; contacting the person's finger or thumb with at least one gripping zone provided on the digit region, wherein the at least one gripping zone is oriented substantially parallel to the imaginary longitudinal axis of the digit region; and the method further comprises frictionally retaining the digit region in position on the person's finger or thumb through the contact between the at least one gripping zone and the person's finger or thumb.

In one embodiment, the at least one gripping zone may be provided as a first stay and a second stay opposed to one another, and wherein the first stay and the second stay comprise an arcuate indentation into an interior cavity defined by the digit region and the arcuate indentations of the first stay and the second stay frictionally engage opposing surfaces of the person's finger or thumb.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a front elevation view of a first example of a first embodiment of a glove in accordance with the present disclosure, wherein the first example is an ambidextrous glove shown worn on a left hand of a user, showing a reduced-circumference fingertip region on all digits regions, and showing at least one gripping zone on each of the digit regions;

FIG. 2 is a rear elevation view of the glove illustrated in FIG. 1;

FIG. 3 is a first side elevation view of the glove of FIG. 1;

FIG. 4 is a second side elevation view of the glove of FIG. 1;

FIG. 5A is a front elevation view of the highlighted middle finger region shown in FIG. 1;

FIG. 5B is a first side elevation view of the middle finger region taken along line 5B-5B of FIG. 5A;

FIG. 5C is a cross-section view of the middle finger region taken along line 5C-5C of FIG. 5A;

FIG. 6A is an enlarged longitudinal cross-section of the middle finger region showing a person's middle finger being inserted into the interior cavity defined by the middle finger region;

FIG. 6B is an enlarged longitudinal cross-section of the middle finger region similar to FIG. 6A, showing the person's middle finger fully inserted in the interior cavity of the middle finger region and showing the gripping zones contacting the front and back surfaces of the person's middle finger;

FIG. 7A is a front elevation view of a second example of the first embodiment of a glove in accordance with an aspect of the present disclosure, where the glove is an ambidextrous glove having a gripping zone on only the index finger region;

FIG. 7B is a front elevation view of a third example of the first embodiment, where the glove is an ambidextrous glove having a gripping zone on each of the thumb region and index finger region;

FIG. 7C is a front elevation view of a fourth example of the first embodiment where the glove is an ambidextrous glove having a gripping zone on each of the thumb region, the index finger region and the middle finger region;

FIG. 7D is a front elevation view of a fifth example of the first embodiment where the glove is an ambidextrous glove that has a gripping zone on each of the thumb region, the index finger region, the middle finger region, and the ring finger region;

FIG. 8 is a front elevation view of a first example of a second embodiment of a glove in accordance with the present disclosure, wherein the first example is a hand-specific glove shown worn on a left hand of a user, showing a reduced-circumference fingertip region on all digits regions, and showing at least one gripping zone on each of the digit regions;

FIG. 8A is a rear elevation view of the glove of FIG. 8;

FIG. 8B is a front elevation view of a second example of the second embodiment of a glove in accordance with an aspect of the present disclosure, where the glove is a hand-specific glove having a gripping zone on only the index finger region;

FIG. 8C is a front elevation view of a third example of the second embodiment, where the glove is a hand-specific glove having a gripping zone on each of the thumb region and index finger region;

FIG. 8D is a front elevation view of a fourth example of the second embodiment where the glove is a hand-specific glove having a gripping zone on each of the thumb region, the index finger region and the middle finger region;

FIG. 8E is a front elevation view of a fifth example of the second embodiment where the glove is a hand-specific glove that has a gripping zone on each of the thumb region, the index finger region, the middle finger region, and the ring finger region;

FIG. 9 is a front elevation view of a first example of a third embodiment of a glove in accordance with the present disclosure, wherein the first example is an ambidextrous glove shown worn on a left hand of a user, showing a fingertip region on all digits regions which is of substantially a same circumference as a remaining portion of the digit region, and showing at least one gripping zone on each of the digit regions;

FIG. 9A is a rear elevation view of the first example of the third embodiment of the glove shown in FIG. 9;

FIG. 9B is a front elevation view of a second example of the third embodiment of a glove in accordance with an aspect of the present disclosure, where the glove is an ambidextrous glove having a gripping zone on only the index finger region;

FIG. 9C is a front elevation view of a third example of the third embodiment, where the glove is an ambidextrous glove having a gripping zone on each of the thumb region and index finger region;

FIG. 9D is a front elevation view of a fourth example of the third embodiment where the glove is an ambidextrous glove having a gripping zone on each of the thumb region, the index finger region and the middle finger region;

FIG. 9E is a front elevation view of a fifth example of the third embodiment where the glove is an ambidextrous glove that has a gripping zone on each of the thumb region, the index finger region, the middle finger region, and the ring finger region;

FIG. 10 is a front elevation view of a first example of a fourth embodiment of a glove in accordance with the present disclosure, wherein the first example is a hand-specific glove shown worn on a left hand of a user, showing a fingertip region on all digits regions which is of substantially a same circumference as a remaining portion of the digit region, and showing at least one gripping zone on each of the digit regions;

FIG. 10A is a rear elevation view of the first example of the fourth embodiment of the glove in accordance with the present disclosure illustrated in FIG. 10;

FIG. 10B is a front elevation view of a second example of the fourth embodiment of a glove in accordance with an aspect of the present disclosure, where the glove is a hand-specific glove having a gripping zone on only the index finger region;

FIG. 10C is a front elevation view of a third example of the fourth embodiment, where the glove is a hand-specific glove having a gripping zone on each of the thumb region and index finger region;

FIG. 10D is a front elevation view of a fourth example of the fourth embodiment where the glove is a hand-specific glove having a gripping zone on each of the thumb region, the index finger region and the middle finger region;

FIG. 10E is a front elevation view of a fifth example of the fourth embodiment where the glove is a hand-specific glove that has a gripping zone on each of the thumb region, the index finger region, the middle finger region, and the ring finger region;

FIG. 11 is a front elevation view of a first example of a fifth embodiment of a glove in accordance with the present disclosure, wherein the first example is an ambidextrous glove shown worn on a left hand of a user, showing a reduced-circumference fingertip region on all digits regions, and showing at least one gripping zone on the sides of each of the digit regions;

FIG. 12 is a rear elevation view of the glove illustrated in FIG. 11;

FIG. 13 is a first side elevation view of the glove of FIG. 11;

FIG. 14 is a second side elevation view of the glove of FIG. 11;

FIG. 15A is a front elevation view of the highlighted middle finger region shown in FIG. 11;

FIG. 15B is a first side elevation view of the middle finger region taken along line 15B-15B of FIG. 15A;

FIG. 15C is a cross-section view of the middle finger region taken along line of FIG. 15A;

FIG. 16A is a front elevation view of a second example of the fifth embodiment of a glove in accordance with an aspect of the present disclosure, where the glove is an ambidextrous glove having a gripping zone on the sides of only the index finger region;

FIG. 16B is a front elevation view of a third example of the fifth embodiment, where the glove is an ambidextrous glove having a gripping zone on the sides of each of the thumb region and index finger region;

FIG. 16C is a front elevation view of a fourth example of the fifth embodiment where the glove is an ambidextrous glove having a gripping zone on each of the thumb region, the index finger region and the middle finger region;

FIG. 16D is a front elevation view of a fifth example of the fifth embodiment where the glove is an ambidextrous glove that has a gripping zone on each of the thumb region, the index finger region, the middle finger region, and the ring finger region;

FIG. 17 is a front elevation view of a first example of a sixth embodiment of a glove in accordance with the present disclosure, wherein the first example is a hand-specific glove shown worn on a left hand of a user, showing a reduced-circumference fingertip region on all digits regions, and showing at least one gripping zone on the sides of each of the digit regions;

FIG. 17A is a rear elevation view of the first example of the sixth embodiment of the glove illustrated in FIG. 17;

FIG. 17B is a front elevation view of a second example of the sixth embodiment of a glove in accordance with an aspect of the present disclosure, where the glove is a hand-specific glove having a gripping zone on the sides of only the index finger region;

FIG. 17C is a front elevation view of a third example of the sixth embodiment, where the glove is a hand-specific glove having a gripping zone on the sides of each of the thumb region and index finger region;

FIG. 17D is a front elevation view of a fourth example of the sixth embodiment where the glove is a hand-specific glove having a gripping zone on the sides of each of the thumb region, the index finger region and the middle finger region;

FIG. 17E is a front elevation view of a fifth example of the sixth embodiment where the glove is a hand-specific glove that has a gripping zone on the sides of each of the thumb region, the index finger region, the middle finger region, and the ring finger region;

FIG. 18 is a front elevation view of a first example of a seventh embodiment of a glove in accordance with the present disclosure, wherein the first example is an ambidextrous glove shown worn on a left hand of a user, showing a fingertip region on all digits regions which is of substantially a same circumference as a remaining portion of the digit region, and showing at least one gripping zone on the sides of each of the digit regions;

FIG. 18A is a rear elevation view of the first example of the seventh embodiment of the glove illustrated in FIG. 18;

FIG. 18B is a front elevation view of a second example of the seventh embodiment of a glove in accordance with an aspect of the present disclosure, where the glove is an ambidextrous glove having a gripping zone on only the sides of the index finger region;

FIG. 18C is a front elevation view of a third example of the seventh embodiment, where the glove is an ambidextrous glove having a gripping zone on the sides of each of the thumb region and index finger region;

FIG. 18D is a front elevation view of a fourth example of the seventh embodiment where the glove is an ambidextrous glove having a gripping zone on the sides of each of the thumb region, the index finger region and the middle finger region;

FIG. 18E is a front elevation view of a fifth example of the seventh embodiment where the glove is an ambidextrous glove that has a gripping zone on the sides of each of the thumb region, the index finger region, the middle finger region, and the ring finger region;

FIG. 19 is a front elevation view of a first example of an eighth embodiment of a glove in accordance with the present disclosure, wherein the first example is a hand-specific glove shown worn on a left hand of a user, showing a fingertip region on all digits regions which is of substantially a same circumference as a remaining portion of the digit region, and showing at least one gripping zone on the sides of each of the digit regions;

FIG. 19A is a rear elevation view of the first example of the first embodiment glove illustrated in FIG. 19;

FIG. 19B is a front elevation view of a second example of the eighth embodiment of a glove in accordance with an aspect of the present disclosure, where the glove is a hand-specific glove having a gripping zone on the sides of only the index finger region;

FIG. 19C is a front elevation view of a third example of the eighth embodiment, where the glove is a hand-specific glove having a gripping zone on the sides of each of the thumb region and index finger region;

FIG. 19D is a front elevation view of a fourth example of the eighth embodiment where the glove is a hand-specific glove having a gripping zone on the sides of each of the thumb region, the index finger region and the middle finger region;

FIG. 19E is a front elevation view of a fifth example of the eighth embodiment where the glove is a hand-specific glove that has a gripping zone on the sides of each of the thumb region, the index finger region, the middle finger region, and the ring finger region;

FIG. 20 is a front elevation view of a first example of a ninth embodiment of a glove in accordance with the present disclosure, wherein the first example is an ambidextrous glove shown worn on a left hand of a user, showing a fingertip region on all digits regions which is of substantially a same circumference as a remaining portion of the digit region, and showing one gripping zone on the thumb region and two gripping zones on each of the finger regions;

FIG. 20A is a rear elevation view of the first example of the ninth embodiment of the glove illustrated in FIG. 20;

FIG. 20B is a front elevation view of a second example of the ninth embodiment of a glove in accordance with an aspect of the present disclosure, where the glove is an ambidextrous glove having two gripping zones on only the index finger region;

FIG. 20C is a front elevation view of a third example of the ninth embodiment, where the glove is an ambidextrous glove having one gripping zone on the thumb region and two gripping zones on the index finger region;

FIG. 20D is a front elevation view of a fourth example of the ninth embodiment where the glove is an ambidextrous glove having one gripping zone on the thumb region, and two gripping zones on the index finger region and the middle finger region;

FIG. 20E is a front elevation view of a fifth example of the ninth embodiment where the glove is an ambidextrous glove that has one gripping zone on the thumb region, and two gripping zones on each of the index finger region, the middle finger region, and the ring finger region;

FIG. 21 is a front elevation view of a first example of a tenth embodiment of a glove in accordance with the present disclosure, wherein the first example is a hand-specific glove shown worn on a left hand of a user, showing a fingertip region on all digits regions which is of substantially a same circumference as a remaining portion of the digit region, and showing one gripping zone on the thumb region and two gripping zones on each of the finger regions;

FIG. 21A is a rear elevation view of the first example of the tenth embodiment of the glove illustrated in FIG. 21;

FIG. 21B is a front elevation view of a second example of the tenth embodiment of a glove in accordance with an aspect of the present disclosure, where the glove is a hand-specific glove having two gripping zones on only the index finger region;

FIG. 21C is a front elevation view of a third example of the tenth embodiment, where the glove is a hand-specific glove having one gripping zone on the thumb region and two gripping zones on the index finger region;

FIG. 21D is a front elevation view of a fourth example of the tenth embodiment where the glove is a hand-specific glove having one gripping zone on the thumb region, and two gripping zones on each of the index finger region and the middle finger region;

FIG. 21E is a front elevation view of a fifth example of the tenth embodiment where the glove is a hand-specific glove that has one gripping zone on the thumb region, and two gripping zones on each of the index finger region, the middle finger region, and the ring finger region;

FIG. 22 is a front elevation view of a first example of an eleventh embodiment of a glove in accordance with the present disclosure, wherein the first example is an ambidextrous glove shown worn on a left hand of a user, showing a fingertip region on all digits regions which is of substantially a same circumference as a remaining portion of the digit region, and showing one gripping zone on the sides of the thumb region and two gripping zones on the sides of each of the finger regions;

FIG. 22A is a rear elevation view of the first example of the eleventh embodiment of the glove illustrated in FIG. 22;

FIG. 22B is a front elevation view of a second example of the eleventh embodiment of a glove in accordance with an aspect of the present disclosure, where the glove is an ambidextrous glove having two gripping zones on the sides of only the index finger region;

FIG. 22C is a front elevation view of a third example of the eleventh embodiment, where the glove is an ambidextrous glove having one gripping zone on the sides of the thumb region and two gripping zones on the sides of the index finger region;

FIG. 22D is a front elevation view of a fourth example of the eleventh embodiment where the glove is an ambidextrous glove having one gripping zone on the sides of the thumb region, and two gripping zones on the sides of the index finger region and the middle finger region;

FIG. 22E is a front elevation view of a fifth example of the eleventh embodiment where the glove is an ambidextrous glove that has one gripping zone on the sides of the thumb region, and two gripping zones on the sides of each of the index finger region, the middle finger region, and the ring finger region;

FIG. 23 is a front elevation view of a first example of a twelfth embodiment of a glove in accordance with the present disclosure, wherein the first example is a hand-specific glove shown worn on a left hand of a user, showing a fingertip region on all digits regions which is of substantially a same circumference as a remaining portion of the digit region, and showing one gripping zone on the sides of the thumb region and two gripping zones on the sides of each of the finger regions;

FIG. 23A is a rear elevation view of the first example of the twelfth embodiment of the glove illustrated in FIG. 23;

FIG. 23B is a front elevation view of a second example of the twelfth embodiment of a glove in accordance with an aspect of the present disclosure, where the glove is a hand-specific glove having two gripping zones on the sides of only the index finger region;

FIG. 23C is a front elevation view of a third example of the twelfth embodiment, where the glove is a hand-specific glove having one gripping zone on the sides of the thumb region and two gripping zones on the sides of the index finger region;

FIG. 23D is a front elevation view of a fourth example of the twelfth embodiment where the glove is a hand-specific glove having one gripping zone on the sides of the thumb region, and two gripping zones on the sides of the index finger region and the middle finger region;

FIG. 23E is a front elevation view of a fifth example of the twelfth embodiment where the glove is a hand-specific glove having one gripping zone on the sides of the thumb region, and two gripping zones on the sides of each of the index finger region, the middle finger region, and the ring finger region.

Similar numbers refer to similar parts throughout the drawings.

### DETAILED DESCRIPTION

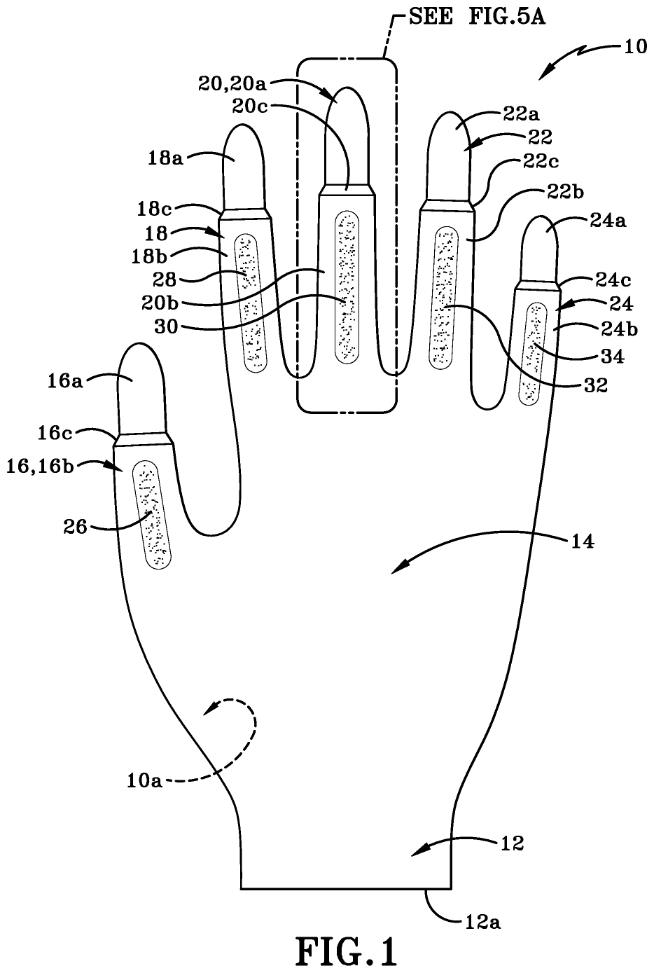

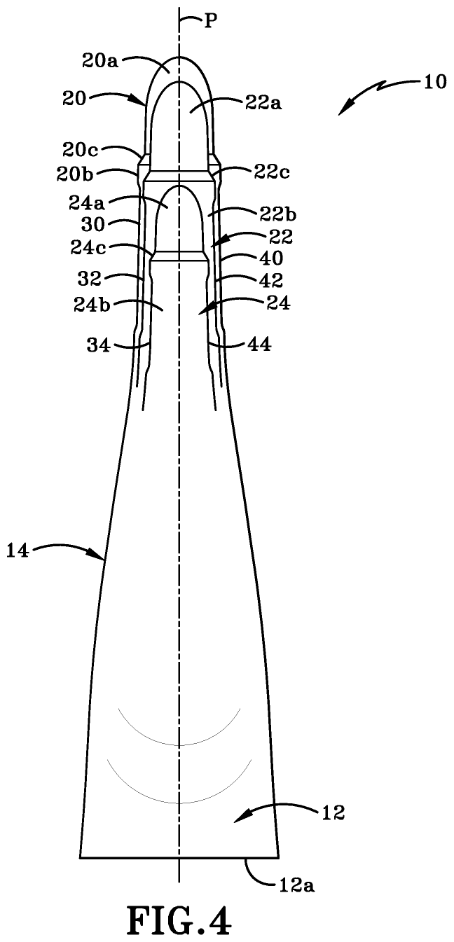

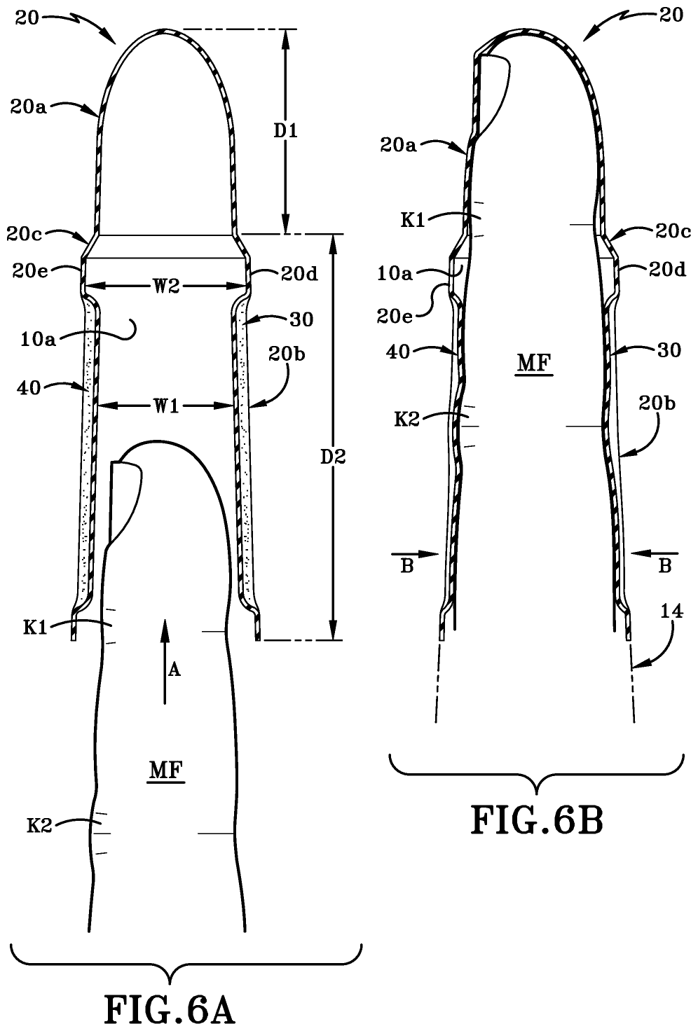

Referring now to FIGS. 1-6B there is shown a first example of a first embodiment of a glove in accordance with the present disclosure, generally indicated at 10. Glove 10 comprises a wrist region 12, a palm region 14, a thumb region 16, an index finger region 18, a middle finger region 20, a ring finger region 22, and a little finger region 24. Glove 10 defines an interior cavity 10a which is configured to receive a hand of a person therein. Thumb region 16, index finger region 18, middle finger region 20, ring finger region 22, and little finger region 24 comprise digit regions which are configured to receive an associated one of a thumb, an index finger, a middle finger, a ring finger, and a little finger of the person's hand, respectively. FIG. 6A, for example shows a person's middle finger “MF” received within a portion of the interior cavity 10a defined by middle finger region 20.

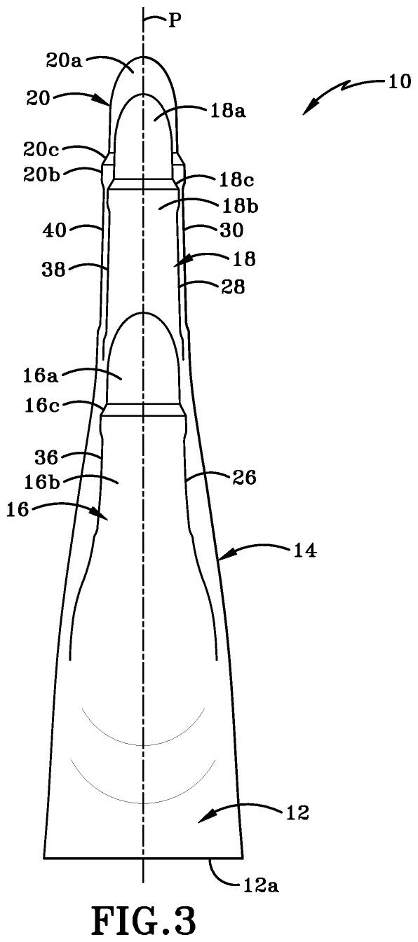

Glove 10 as illustrated in FIGS. 1-6B is an ambidextrous glove which is capable of being worn on either of a left hand or a right hand of the person. In the ambidextrous glove 10 each of the thumb region 16, index finger region 18, middle finger region 20, ring finger region 22, and little finger region 24 are aligned along a common plane “P” (FIG. 3).

As illustrated in each of FIGS. 1-6B, each digit region of glove 10 is comprised of a fingertip region and a remaining portion. The fingertip region originates in a tip of the respective digit region and extends downwardly towards palm region 14 for a distance. The distance is of a length such that a lower region of the fingertip region will generally be located adjacent to or near where a first knuckle of the person's associated thumb or finger will be when glove 10 is worn. The remaining portion extends between the fingertip region and the palm region 14. This arrangement can be seen in FIG. 6A, for example, where a fingertip region 20a of the middle finger region 20 originates in the tip of the middle finger region 20 and extends for a distance “D1” from the tip, terminating at a location which will be adjacent to or near where a first knuckle “K1” of the middle finger “MF” is located when the glove is worn. A remaining portion 20b of middle finger region 20 extends between fingertip region 20a and palm region 14. Remaining portion 20b extends for a distance “D2” between fingertip region 20a and palm region 14. As will be described later herein, fingertip region 20a is of a reduced circumference relative to remaining portion 20b. The remaining portion 20b includes a transition portion 20c which tapers in circumference moving in a direction from the remaining portion 20b towards the fingertip region 20a.

As illustrated in FIG. 1, thumb region 16 includes a fingertip region 16a, a remaining portion 16b, and a transition portion 16c. Index finger region 18 includes a fingertip region 18a, a remaining portion 18b, and a transition portion 18c. As discussed above, middle finger region 20 includes fingertip region 20a, remaining portion 20b, and transition portion 20c. Ring finger region 22 includes a fingertip region 22a, a remaining portion 22b, and a transition portion 22c. Little finger region 24 includes a fingertip region 24a, a remaining portion 24b, and a transition portion 24c.

FIGS. 1-6B show each of the fingertip regions 16a, 18a, 20a, 22a, and 24a are of a reduced circumference relative to the associated remaining portions 16b, 18b, 22b, and 24b. Most particularly, the fingertip regions 16a, 18a, 20a, 22a, and 24a are of a “bullet-tip” shape but it will be understood that other reduced-circumference configurations may be provided on the digit regions of glove 10 instead. A bullet-tip shaped fingertip region provided on a glove is described in detail in U.S. Pat. No. 10,602,788 (Hull), which patent is incorporated herein by reference.

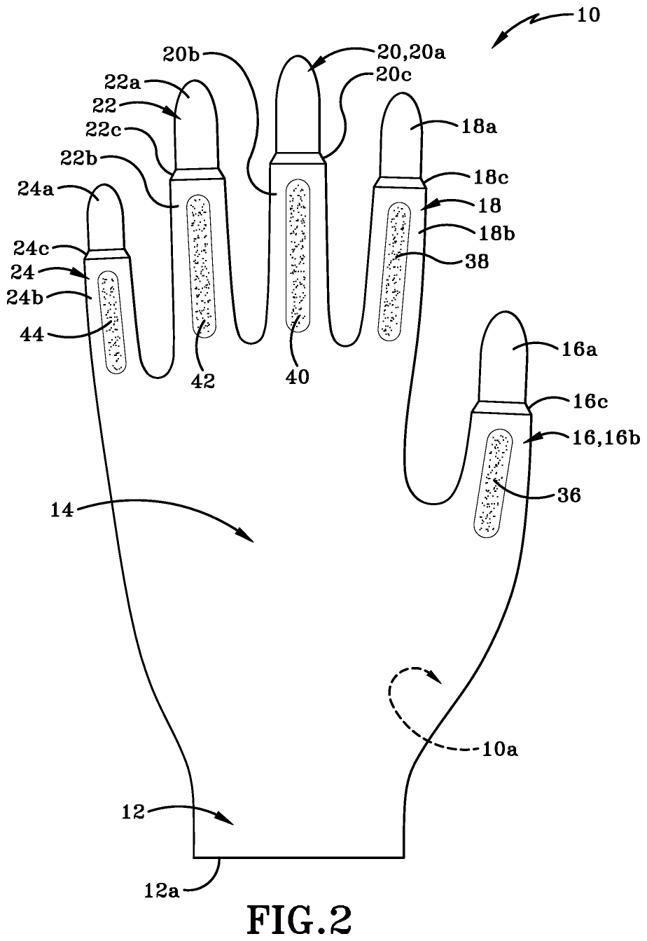

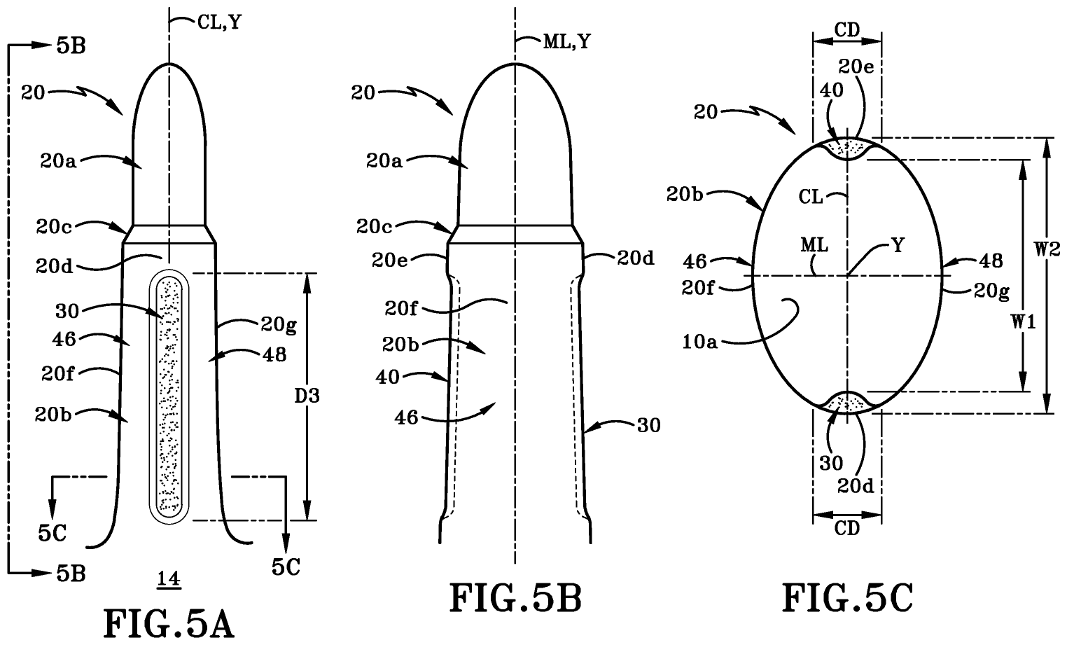

When glove 10 is worn on the left hand as illustrated in FIG. 1, the surface of the glove facing the viewer may be considered to be the “front” surface of the glove 10. The front of the glove is part of the glove which will contact an object held in a left hand of a person wearing the glove. Because FIG. 1 shows a “front” view, the surfaces of the wrist region 12, palm region 14, and digit regions facing the viewer of FIG. 1 may be considered to be the “front” surface of the wrist region 12, palm region 14, and digit regions 16, 18, 20, 22, and 24. FIG. 2 then illustrates a “back” surface of the glove so the surface of the wrist region 12, palm region 14, and digit regions facing the viewer of FIG. 2 may be considered to be the “back” surface of the wrist region 12, palm region 14, and digit regions 16, 18, 20, 22, and 24. Using FIGS. 5A, 5B and 5C as an exemplary digit region, the front of middle finger region 20 is designated by the reference number 20d. The front 20d extends from the tip of the middle finger region through to the palm region 14. Similarly the back of middle finger region 20 is designated by the reference number a first side of middle finger region 20 is designated by the reference number 20f, and a second side of middle finger region is designated by the reference number 20g. Each of back 20e, first side 20f, and second side 20g extends from the tip of middle finger region 20 to palm region 14. Together the front 20d, back 20e, first side 20f, and second side 20g form an exterior perimeter of middle finger region 20 which bounds and defines an interior cavity of the middle finger region 20. The interior cavity of the middle finger region 20 forms part of the interior cavity 10a of glove 10. It should be noted that the terms “front”, “back”, “left”, and “right” are used for ease of description and particularly describe the specific orientation of the glove 10 illustrated in FIGS. 1 and 2. The terms “front”, “back”, “left”, and “right” should therefore not be narrowly construed to necessarily describe the orientation of the glove 10 during use, particularly since glove 10 is an ambidextrous glove and can be worn on either of the left hand or right hand of a user.

FIG. 5A shows that middle finger region 20 has an imaginary centerline “CL” which is located midway between first side 20f and second side 20g. FIG. 5B shows that middle finger region also has an imaginary midline “ML” located midway between front and back 20e. FIG. 5C shows that centerline “CL” and midline “ML” are oriented orthogonal to one another and intersect one another along an imaginary longitudinal axis “Y” of middle finger region 20. The imaginary longitudinal axis “Y” extends along a length of middle finger region 20 from the tip thereof to the palm region 14.

Although not specifically called out in the attached drawings, it will be understood that each of the thumb region 16, index finger region 18, ring finger region 22, and little finger region 24 has a front substantially similar to front 20d, a back substantially similar to back 20e, a first side substantially similar to first side 20f, and second side substantially similar to second side 20g. Additionally, each of the thumb region 16, index finger region 18, ring finger region 22, and little finger region 24 has a centerline substantially identical to centerline “CL” of middle finger region 20, a midline substantially identical to midline “ML” of middle finger region 20, and an imaginary longitudinal axis substantially identical to imaginary longitudinal axis “Y”.

In accordance with an aspect of the present disclosure and as will be discussed in greater detail later herein, glove 10 is provided with at least one gripping zone provided on at least one digit region of glove 10, i.e., on at least one of the thumb region 16, index finger region 18, middle finger region 20, ring finger region 22, and little finger region 24. The at least one gripping zone is oriented substantially parallel to the imaginary longitudinal axis “Y” (FIG. 5A) of the respective least one digit region. The imaginary longitudinal axis “Y” extends from a tip of the at least one digit region to the palm region 14. FIG. 1 shows that glove 10 includes at least one gripping zone provided on each of the digit regions of glove. The at least one gripping zone is provided as a first stay 26 provided on thumb region 16, a first stay 28 provided on index finger region 18, a first stay 30 provided on middle finger region 20, a first stay 32 provided on ring finger region 22, and a first stay 34 provided on little finger region 24. The stays will be described hereafter with reference to FIG. 6A which shows an enlarged middle finger region 20 as an exemplary digit region of glove 10. It will be understood that the following description directed to middle finger region 20 applies equally to each of the thumb region 16, index finger region 18, ring finger region 22, and little finger region 24.

Middle finger region 20 is a tubular member which, as described above, has a front 20d, a back 20e, a first side 20e, and a second side 20f. As is evident from FIGS. 5A through 6B, the first stay 30 is formed in the front 20d of middle finger region 20. First stay 30 is an arcuate concave indentation which is formed in a section of the front located in remaining portion 20b. The concave indentation forms a projection which extends into the portion of interior cavity 10a defined by middle finger region 20. This can particularly be seen in FIG. 6A. FIGS. 5B and 6A shows that first stay 30 originates a distance downwardly from the transition portion 20c of middle finger region 20 and terminates a short distance upwardly from palm region 14. FIG. 5A shows that first stay is of a length “D3” which is shorter than the length “D2” of remaining portion 20b. The length “D3” is greater than half of a total length of middle finger region 20 (where the total length is equal to the distance “D1” plus the distance “D2”, i.e., from a tip of the middle finger region 20 to the palm region 14). “D3” is less than three quarters of the total length of middle finger region 20. First stay 30 is located entirely within remaining portion 20b in a position that, when glove 10 is worn, will fall below the first knuckle “K1” (FIG. 6B) of the person's middle finger “MF” and above the finger crotch located between the person's index finger and middle finger “MF” and/or the finger crotch between the person's middle finger “MF” and their ring finger. In other words, the first stay 30 will extend over the second knuckle “K2” of the person's middle finger 30. It will be understood that in the thumb region 16 of glove 10, the first stay 26 will extend over the first knuckle “L1” of the person' thumb.

The concave indentation which constitutes the first stay 30 only extends around part of a total circumference of remaining portion 20b of middle finger region 20. The circumference is oriented at ninety degrees relative to the imaginary longitudinal axis “Y” (FIG. 5C). As illustrated, the first stay 30 does not extend circumferentially across the entire width of the front 20d of middle finger region 20 but terminates a distance circumferentially inwardly from each of the first side 20f and second side 20g. The first stay 30 therefore extends for less than a quarter of the total circumference of the remaining portion 20b of middle finger region 20 as can be seen in FIG. 5C. It will be understood that the first stay 30 does not even extend for one quarter of the total circumference of middle finger region 20, as is further evident from FIG. 5C.

In accordance with an aspect of the present disclosure, a second stay is provided in each of the digit regions of glove 10. FIG. 2 shows a second stay 36 provided in thumb region 16, a second stay 38 provided in index finger region 18, a second stay 40 provided in middle finger region 20, a second stay 42 provided in ring finger region 22, and a second stay 44 provided in little finger region 24 and extending substantially parallel to the longitudinal axis of the associate digit region. Each second stay 36, 38, 40, 42, 44 comprises a concave indentation in the back of the associated one of the thumb region 16, index finger region 18, middle finger region 20, ring finger region 22, and little finger region 24. FIGS. 5B and 6A show that first stay 30 is located opposite to and laterally aligned with second stay 40 in middle finger region 20, and is oriented substantially parallel to the imaginary longitudinal axis “Y” of middle finger region 20. Similarly, first stay 26 and second stay 36 are located opposite to and laterally aligned with one another, and are oriented substantially parallel to the longitudinal axis of thumb region 16; first stay 28 and second stay 38 are located opposite to and laterally aligned with one another, and are oriented substantially parallel to the longitudinal axis of index finger region 18; first stay 32 and second stay 42 are located opposite to and laterally aligned with one another, and are oriented substantially parallel to the longitudinal axis of ring finger region 22; and first stay 34 and second stay 44 are located opposite to and laterally aligned with one another, and are oriented substantially parallel to the longitudinal axis of little finger region 24. The concavity of the first and second stays of any one of the digit regions is such that the stays open away from one another and the width W1″ (FIGS. 5C and 6A) between the opposed interior surfaces of the stays (such as first stay 30 and second stay 40) is reduced relative to the width “W2” between opposing interior surfaces of the rest of the remaining portion. The width “W3” of middle finger region 20 is not affected by the opposed first stay 30 and second stay 40.

Referring now to FIGS. 5A through 6B, the concave indentation which constitutes each of first stay 30 and second stay 40 extends around less than a quarter of the total circumference of the middle finger region 20. As a consequence, an “un-indented” section of middle finger region 20 is located between the lateral ends of first stay 30 and second stay 40 on each of the first side 20f and second side 20g of middle finger region 20. The “un-indented” regions are indicated by the reference characters 46 and 48 in FIGS. 5B and 5C.

In accordance with another aspect of the present disclosure, an exterior surface of glove 10 along first stays 26, 28, 30, 32, and 34, and along second stays 36, 38, 40, 42, and 44 is textured. In one embodiment the exterior surface of the glove along the stays is micro-etched to create the texturing. The micro-etching is accomplished through any process known in the art. In one embodiment, the micro-etching creates a sand pattern texture that occurs only on the first stays 26, 28, 30, 32, and 34 and second stays 36, 38, 40, 42, and 44. It will be understood that in other embodiments, other patterns, such as a diamond pattern or a herringbone pattern, or any other desired pattern, may be provided on the first stays and second stays by any other process.

As indicated earlier herein, the at least one gripping zone provided on at least one digit region comprises a stay which is oriented substantially parallel to the imaginary longitudinal axis “Y” (FIG. 5A) of the respective digit region. The at least one gripping zone is of a length “D3” shown in FIG. 5A and is of a circumferential distance “CD” shown in FIG. 5C. The circumferential distance “CD” is the distance that the concave indentation of the stay runs along the circumference of the associated digit region. (The circumference of the associated digit region is arranged orthogonal to the imaginary longitudinal axis.) It should be noted by comparing FIGS. 5A and 5C that the length “D3” of the stay is substantially greater than the circumferential distance “CD” of the stay. It should further be noted that all stays discussed herein with respect to all embodiments of the glove in accordance with the present disclosure have this same relationship between the length “D3” of the stay and the circumferential distance “CD” of the stay.

Referring now to FIGS. 1, 6A and 6B in particular, glove 10 is used in the following manner. Wrist region 12 of glove 10 has an end 12a which bounds and defines an opening (not shown) to interior cavity 10a. When a person wishes to don glove 10, he or she will insert their hand into interior cavity 10a through this opening and will slide each of their fingers and thumb into the appropriate one of the digit regions of glove 10. FIG. 6A shows middle finger “MF” sliding into the portion of interior cavity 10a defined by middle finger region 20 in the direction indicated by arrow “A”. Middle finger “MF” slides all the way into the interior cavity of middle finger region 20 until the tip of the person's middle finger contacts the interior surface at the tip of the middle finger region 20.

Fingertip region 20a of middle finger region 20 is of a circumference that is slightly smaller than the circumference of the fingertip of the person's middle finger “MF”. The material of the fingertip region 20a is therefore pulled tautly around the fingertip of the middle finger “MF”. The wall thickness of the material of the fingertip region 20a may actually be pulled taut enough to thin slightly relative to the thickness of the wall of the remaining portion 20b of middle finger region 20. FIG. 6B shows that the fingertip region is snugly received around the fingertip of middle finger “MF” such that there is direct contact between the pad on the middle finger “MF” and the interior surface of the front of fingertip region 20b. This snug-fitting engagement between fingertip region 20a and the fingertip of the middle finger “MF” ensures that the person's finger has substantially the same tactile sensitivity and dexterity as would be the case if the glove had not been donned.

FIG. 6B shows that the person's first knuckle “K1” is located adjacent or near the transition portion 20c of middle finger region 20. First and second stays 30, 40 originate a short distance downwardly from transition portion 20c, extend across the second knuckle “K2” and terminate a short distance above the palm region 14 (FIG. 1). The circumference of the remaining portion 20b of middle finger region 20 is such that, after some time of wearing glove 10, there may not be much direct contact between the exterior surface of the person's middle finger “MF” and the interior surface of the remaining portion 20b of middle finger region 20. However, the concave indentations of first stay 30 and second stay 40 project for a distance into the portion of interior cavity defined by middle finger region 20 and will contact the skin on the front and back of the middle finger “MF”. Because of this direct physical contact between the exterior surface of middle finger “MF” and the interior surfaces of first stay 30 and second stay 40 the first stay 30 and second stay 40 frictionally engage the middle finger “MF” as indicated by arrows “B” in FIG. 6B. This frictional contact helps first stay 30 and second stay 40 to grippingly engage the person's middle finger “MF” and thereby to aid middle finger region in resisting the tendency to slide along the length of the person's middle finger “MF” during use of glove 10. The first and second stays 30, 40 therefore help to ensure that the glove material in the fingertip region 20a remains taut around the tip of the person's middle finger “MF” and thereby helps to maintain tactile sensitivity and finger dexterity of the middle finger “MF”, even when the glove 10 is used for a period of time.

The micro-etch treatment or texturing provided on each of the first stays and second stays strengthens the glove material in the first stays and second stays. The micro-etching or texturing also improves the ability of glove 10 to grip objects, particularly since the rest of the exterior surface of the glove 10 is smooth.

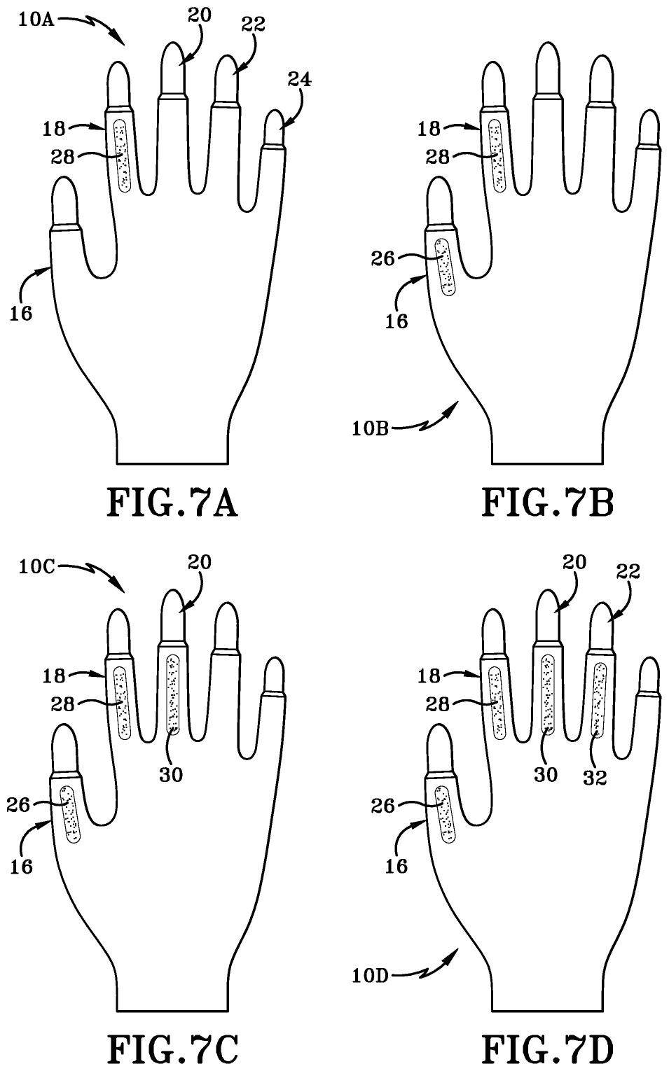

Referring now to FIGS. 7A to 7D there are shown a second example, a third example, a fourth example, and a fifth example of the first embodiment of glove 10 illustrated in FIGS. 1-6B. FIG. 7A shows the second example of the first embodiment of the glove, generally indicated as glove 10A. Glove 10A is identical to glove 10 in all aspects except that instead of all five of the thumb region 16, index finger region 18, middle finger region 20, ring finger region 22, and little finger region 24 including at least one gripping zone in the form of first stays 26, 28, 30, 32, 34 and second stays 36, 38, 40, 42, and 44; only one of the digit regions includes at least one gripping zone. By way of illustration only index finger region 18 has a first stay 28 formed in the front thereof. In some embodiments, a second stay (identical to second stay 38 (FIG. 2) is formed in the back of index finger region. The first stay 28 and the second stay (not shown in FIG. 7A) are opposed to and laterally aligned with one another. It will be understood that instead of the at least one stay being provided in the front or back of index finger region 18, the at least one stay may, instead, be provided in the front or back of any of thumb region 16, middle finger region 20, ring finger region 22, and little finger region 24. An opposing other stay may be provided in the other of the front or back of same one of the thumb region 16, middle finger region 20, ring finger region 22, and little finger region 24. The provided gripping zones in the form of the first stay and/or the second stay include texturing on an exterior surface of the glove 10 in the region of the first stay and/or the second stay. In one embodiment, the texturing is produced on the exterior surface of the glove by micro-etching the same. In one embodiment, the micro-etching creates a sand pattern on the exterior surface of the first stay and/or the second stay.

FIG. 7B shows a third example of the first embodiment of the glove, generally indicated as glove 10B. Glove 10B is identical to glove 10 in all aspects except that instead of all five of thumb region 16, index finger region 18, middle finger region 20, ring finger region 22, and little finger region 24 including at least one gripping zone in the form of first stays 26, 28, 30, 32, 34 and second stays 36, 38, 40, 42, and 44; only two of the digit regions include at least one gripping zone. By way of illustration only thumb region 16 and index finger region 18 are each provided with at least one stay formed in the front thereof. First stay 26 is provided in the front of thumb region 16 and first stay 28 is provided in the front of index finger region 18. In some embodiments, a second stay is formed in the back of each of thumb region 16 and index finger region 18. In particular, second stay 36 is formed in the back of thumb region 16 and second stay 38 is formed in the back of index finger region 18. First stay 26 and second stay 36 are opposed to and laterally aligned with one another; and first stay 28 and second stay 38 are opposed to and laterally aligned with one another. It will be understood that instead of the at least one stay being provided in thumb region 16 and index finger region 18, the at least one stay may be provided in the front or back of any two of the thumb region 16, index finger region 18, middle finger region 20, ring finger region 22, and little finger region 24. An opposing other stay may be provided in the other of the front or back of the same two of the thumb region 16, index finger region, middle finger region 20, ring finger region 22, and little finger region 24. The provided gripping zones in the form of the first stay and/or the second stay will include texture on the exterior surface of the glove. In particular the texture is formed by micro-etching of the exterior surface of the first stay and/or the second stay. In one embodiment, the micro-etching creates a sand texture on the exterior surface of the first stay or the second stay.

FIG. 7C shows a fourth example of the first embodiment of the glove, generally indicated as glove 10C. Glove 10C is identical to glove 10 in all aspects except that instead of all five of thumb region 16, index finger region 18, middle finger region 20, ring finger region 22, and little finger region 24 including at least one gripping zone in the form of first stays 26, 28, 30, 32, 34 and second stays 36, 38, 40, 42, and 44; only three of the digit regions include at least one gripping zone. By way of illustration only thumb region 16, index finger region 18, and middle finger region 20 are each provided with at least one stay formed in the front thereof. First stay 26 is provided in thumb region 16, first stay 28 is provided in index finger region 18, and first stay 30 is provided in middle finger region 20. In some embodiments, a second stay is formed in the back of each of thumb region 16, index finger region 18, and middle finger region 20. In particular, second stay (not shown in FIG. 7C) is formed in the back of thumb region 16, a second stay is formed in the back of index finger region 18, and a second stay is formed in the back of middle finger region 20. First stay 26 and the second stay in thumb region 16 are opposed to and laterally aligned with one another; first stay 28 and the second stay in index finger region 18 are opposed to and laterally aligned with one another; and first stay 30 and the second stay in the middle finger region 20 are opposed to and laterally aligned with one another. It will be understood that instead of the at least one stay being provided in one of the front and back of thumb region 16, index finger region 18, and middle finger region 20, the at least one stay may, instead, be provided in any three of the thumb region 16, index finger region 18, middle finger region 20, ring finger region 22, and little finger region 24. An opposing other stay may be provided in the other of the front and back of the same three of the thumb region 16, index finger region, middle finger region 20, ring finger region 22, and little finger region 24. The provided gripping zones in the form of the first stay and/or the second stay will include texture on the exterior surface of the glove. In particular the texture is formed by micro-etching of the exterior surface of the first stay and/or the second stay. In one embodiment, the micro-etching creates a sand texture on the exterior surface of the first stay or the second stay.

FIG. 7D shows a fifth example of the first embodiment of the glove, generally indicated as glove 10D. Glove 10D is identical to glove 10 in all aspects except that instead of all five of thumb region 16, index finger region 18, middle finger region 20, ring finger region 22, and little finger region 24 including at least one gripping zone in the form of first stays 26, 28, 30, 32, 34 and/or second stays 36, 38, 40, 42, and 44; only four of the digit regions include the at least one gripping zone. By way of illustration only thumb region 16, index finger region 18, middle finger region 20, and ring finger region 22 are each provided with at least one stay formed in the front thereof. First stay 26 is provided in thumb region 16, first stay 28 is provided in index finger region 18, first stay 30 is provided in middle finger region 20, and first stay 32 is provided in ring finger region 22. In some embodiments, a second stay is formed in the back of each of thumb region 16, index finger region 18, middle finger region 20, and ring finger region 22. In particular, a second stay is formed in the back of thumb region 16, a second stay is formed in the back of index finger region 18, a second stay is formed in the back of middle finger region 20, and a second stay is formed in the back of ring finger region 22. First stay 26 and the second stay in thumb region 16 are opposed to and laterally aligned with one another; first stay 28 and the second stay in index finger region 18 are opposed to and laterally aligned with one another; first stay 30 and the second stay in middle finger region 20 are opposed to and laterally aligned with one another, and first stay 32 and the second stay in the ring finger region 22 are opposed to and laterally aligned with one another. It will be understood that instead of the at least one stay being provided in thumb region 16, index finger region 18, middle finger region 20, and ring finger region 22, the at least one stay may be provided in the front or back any four of the thumb region 16, index finger region 18, middle finger region 20, ring finger region 22, and little finger region 24. An opposing other stay may be provided in the other of the front or back of the same four of the thumb region 16, index finger region, middle finger region 20, ring finger region 22, and little finger region 24. The provided gripping zones in the form of the first stay and/or the second stay will include texture on the exterior surface of the glove. In particular the texture is formed by micro-etching of the exterior surface in the region of the first stay and/or the second stay. In one embodiment, the micro-etching creates a sand texture on the exterior surface of the first stay or the second stay.

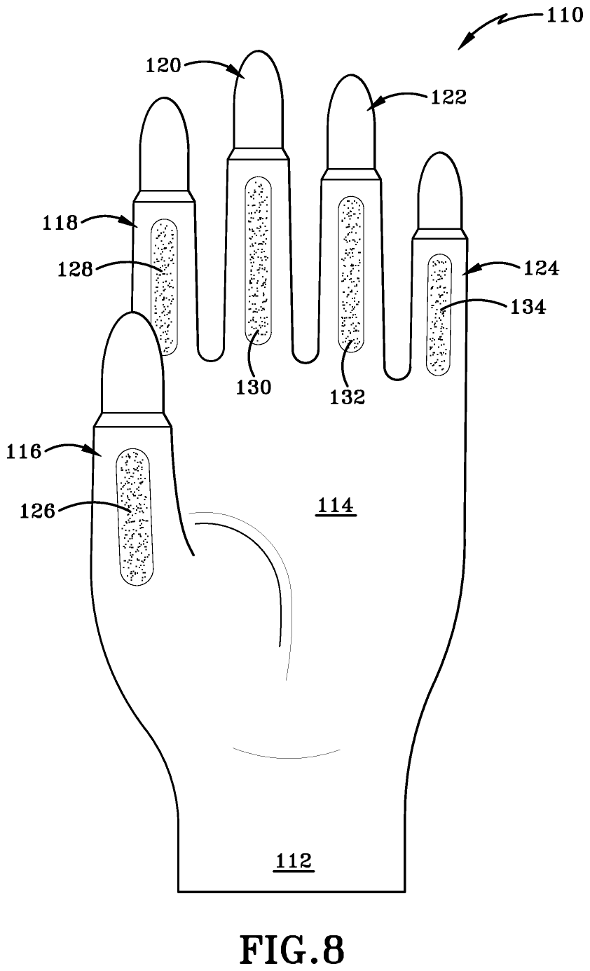

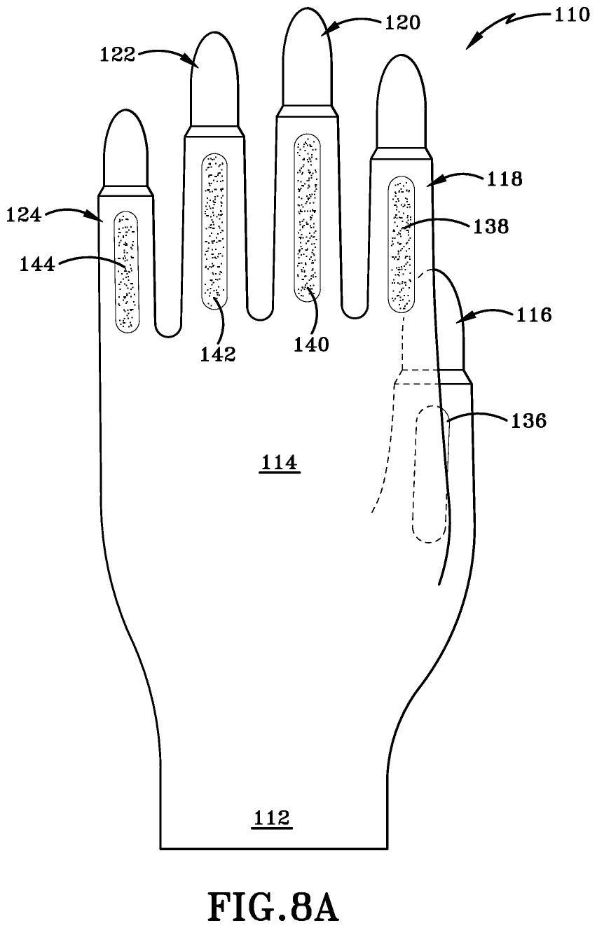

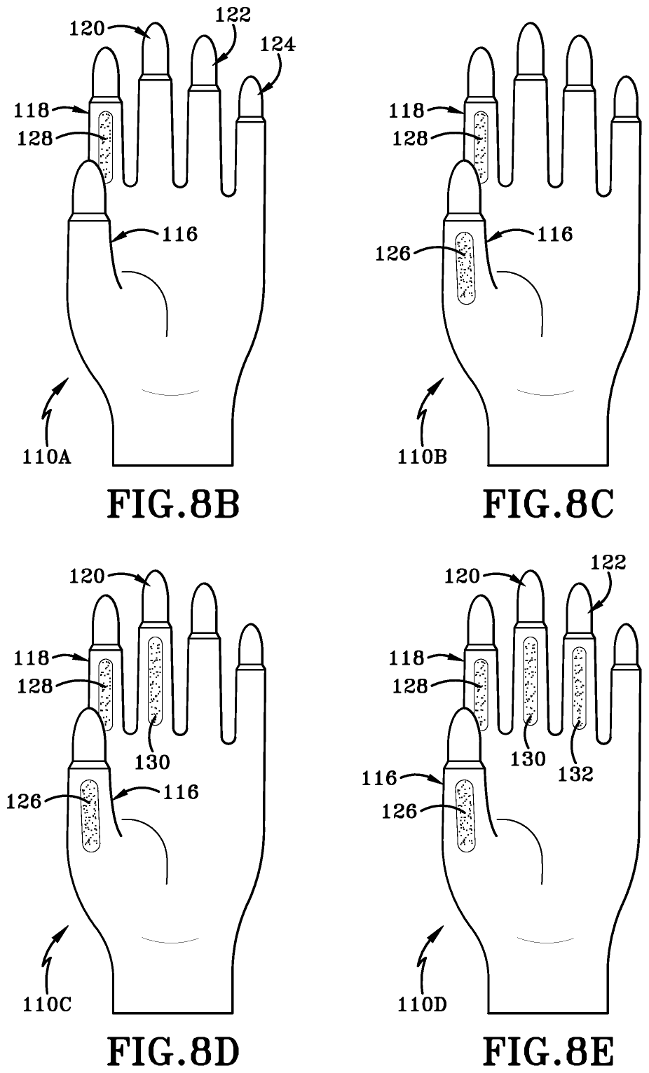

Referring now to FIG. 8 through 8E, there is shown a second embodiment of a glove in accordance with the present disclosure. FIG. 8 shows a first example of the second embodiment of the glove in accordance with the present disclosure, generally indicated at 110. Glove 110 includes a wrist region 112, a palm region 114, and digit regions which extend outwardly from the palm region 114. The digit regions include a thumb region 116, an index finger region 118, a middle finger region 120, a ring finger region 122, and a little finger region 124.

Glove 110 differs from glove 10 in that glove 110 is a hand-specific glove configured to be worn on a left hand of a person, while glove 10 is an ambidextrous glove. In the hand-specific glove 110 the index finger region 118, middle finger region 120, ring finger region 122, and little finger region 124 are aligned along a common plane but the thumb region 116 is in a different plane. Apart from the glove 110 being a hand-specific glove, all of the component parts of the glove are substantially identical in structure and function to glove 10. In particular, thumb region 116 is identical to thumb region 16; index finger region 118 is identical to index finger region 18, middle finger region 120 is identical to middle finger region 20, ring finger region 122 is identical to ring finger region 22, and little finger region 124 is identical to little finger region 24. Although not numbered in FIGS. 8 to 8E, each of these digit regions includes a fingertip region that is identical in structure and function to the associated fingertip region 16a, 18a, 20a, 22a, and 24a. Each of these digit regions includes a remaining portion that is identical in structure and function to the associated remaining portion 16b, 18b, 20b, 22b, and 24b. Each of these digit regions includes a transition portion that is identical in structure and function to the associated transition portion 16c, 18c, 20c, 22c, and 22d.

In accordance with an aspect of the present disclosure each of the thumb region 116, index finger region 118, middle finger region 120, ring finger region 122, and little finger region includes at least one gripping zone. The at least one gripping zone comprises at least a first stay. The at least one gripping zone may further include a second stay. As shown in FIGS. 8 and 8A, thumb region 116 includes a first stay 126 and a second stay 136; index finger region 118 includes a first stay 128 and a second stay 138; middle finger region 120 includes a first stay 130 and a second stay 140; ring finger region 122 includes a first stay 132 and a second stay 142; and little finger region 124 includes a first stay 134 and a second stay 142. First stays 126, 128, 130, 132, and 134 are identical in structure and function to first stays 26, 28, 30, 32, and 34. Second stays 136, 138, 140, 142, and 144 are identical in structure and function to second stays 36, 38, 40, 42, and 44. Each stay is provided with texturing, particularly via micro-etching. In one embodiment, the micro-etching will produce a sand pattern of texturing.

The use of glove 110 is substantially identical to glove 10 except the glove illustrated in FIGS. 8 and 8A can only be worn on a left hand while the glove 10 can be worn on either of the left hand or the right hand. (It will be understood that a glove for the right hand will be a mirror image of the glove 110.)

Referring now to FIGS. 8B to 8E there are shown a second example, third example, fourth example, and a fifth example of the second embodiment of glove 110 illustrated in FIGS. 8 and 8A. FIG. 8B shows the second example of the second embodiment of the glove, generally indicated as glove 110A. Glove 110A is identical to glove 110 in all aspects except that instead of all five of the thumb region 116, index finger region 118, middle finger region 120, ring finger region 122, and little finger region 124 including at least one gripping zone in the form of first stays 126, 128, 130, 132, 134 and second stays 136, 138, 140, 142, and 144; only one of the digit regions includes at least one gripping zone. By way of illustration only index finger region 118 has a first stay 128 formed in the front thereof. In some embodiments, a second stay (identical to second stay 138 (FIG. 8B) is formed in the back of index finger region 118. First stay 128 and the second stay are opposed to and laterally aligned with one another. It will be understood that instead of the at least one stay being provided in index finger region 118, the at least one stay may be provided in any of thumb region 116, middle finger region 120, ring finger region 122, and little finger region 124. An opposing other stay may be provided in the same one of the thumb region 116, middle finger region 120, ring finger region 122, and little finger region 124. The provided gripping zones in the form of the first stay and/or the second stay will be textured, particularly via micro-etching. In one embodiment, the micro-etching will produce a sand pattern on the first stay and/or the second stay.

FIG. 8C shows a third example of the second embodiment of the glove, generally indicated as glove 110B. Glove 110B is identical to glove 110 in all aspects except that instead of all five of thumb region 116, index finger region 118, middle finger region 120, ring finger region 122, and little finger region 124 including at least one gripping zone in the form of first stays 126, 128, 130, 132, 134 and second stays 136, 138, 140, 142, and 144; only two of the digit regions include the at least one gripping zone. By way of illustration only, thumb region 116 and index finger region 118 are each provided with at least one stay formed in the front thereof. First stay 126 is provided in thumb region 116 and first stay 128 is provided in index finger region 118. In some embodiments, a second stay is formed in the back of each of thumb region 116 and index finger region 118. In particular, a second stay is formed in the back of thumb region 116 and a second stay is formed in the back of index finger region 118. First stay 126 and the second stay in thumb region 116 are opposed to and laterally aligned with one another; and first stay 128 and the second stay in the index finger region 118 are opposed to and laterally aligned with one another. It will be understood that instead of the at least one stay being provided in thumb region 116 and index finger region 118, the at least one stay may be provided in the front or back of any two of the thumb region 116, index finger region 118, middle finger region 120, ring finger region 122, and little finger region 124. An opposing other stay may be provided in the other of the front or back of the same two of the thumb region 116, index finger region 118, middle finger region 120, ring finger region 122, and little finger region 124. The provided gripping zones in the form of the first stay and/or the second stay will be textured, particularly via micro-etching. In one embodiment, the micro-etching will produce a sand pattern on the first stay and/or the second stay.

FIG. 8D shows a fourth example of the second embodiment of the glove, generally indicated as glove 110C. Glove 110C is identical to glove 110 in all aspects except that instead of all five of thumb region 116, index finger region 118, middle finger region 120, ring finger region 122, and little finger region 124 including at least one gripping zone in the form of first stays 126, 128, 130, 132, 134 and second stays 136, 138, 140, 142, and 144; only three of the digit regions include at least one gripping zone. By way of illustration only thumb region 116, index finger region 118, and middle finger region 120 are each provided with at least one stay formed in the front thereof. First stay 126 is provided in thumb region 116, first stay 128 is provided in index finger region 118, and first stay 130 is provided in middle finger region 120. In some embodiments, a second stay is formed in the back of each of thumb region 116, index finger region 118, and middle finger region 120. In particular, a second stay is formed in the back of thumb region 116, a second stay is formed in the back of index finger region 118, and a second stay is formed in the back of middle finger region 120. First stay 126 and the second stay in thumb region 116 are opposed to and laterally aligned with one another; first stay 128 and the second stay in index finger region 118 are opposed to and laterally aligned with one another; and first stay 130 and the second stay in middle finger region 120 are opposed to and laterally aligned with one another. It will be understood that instead of the at least one stay being provided in thumb region 116, index finger region 118, and middle finger region 120, the at least one stay may be provided in the front or back of any three of the thumb region 116, index finger region 118, middle finger region 120, ring finger region 122, and little finger region 124. An opposing other stay may be provided in the other of the front or back of the same three of the thumb region 116, index finger region, middle finger region 120, ring finger region 122, and little finger region 124. The provided gripping zones in the form of the first stay and/or the second stay will be textured, particularly via micro-etching. In one embodiment, the micro-etching will produce a sand pattern on the first stay and/or the second stay. It will be understood that any other texturing configuration may be provided on any of the stays of glove 110, with that texturing being produced in any suitable manner thereon.

FIG. 8E shows a fifth example of the second embodiment of the glove, generally indicated as glove 110D. Glove 110D is identical to glove 110 in all aspects except that instead of all five of thumb region 116, index finger region 118, middle finger region 120, ring finger region 122, and little finger region 124 including at least one gripping zone in the form of first stays 126, 128, 130, 132, 134 and/or second stays 136, 138, 140, 142, and 144; only four of the digit regions include the at least one gripping zone. By way of illustration only thumb region 116, index finger region 118, middle finger region 120, and ring finger region 122 are each provided with at least one stay formed therein. First stay 126 is provided in the front of thumb region 116, first stay 128 is provided in the front of index finger region 118, first stay 130 is provided in the front of middle finger region 120, and first stay 132 is provided in the front of ring finger region 122. In some embodiments, a second stay is formed in the back of each of thumb region 116, index finger region 118, middle finger region 120, and ring finger region 122. In particular, a second stay is formed in the back of thumb region 116, a second stay is formed in the back of index finger region 118, a second stay is formed in the back of middle finger region 120, and a second stay is formed in the back of ring finger region 122. First stay 126 and the second stay in index finger region 116 are opposed to and laterally aligned with one another; first stay 128 and the second stay in index finger region 118 are opposed to and laterally aligned with one another; first stay 130 and the second stay in middle finger region 120 are opposed to and laterally aligned with one another, and first stay 132 and the second stay in ring finger region 122 are opposed to and laterally aligned with one another. It will be understood that instead of the at least one stay being provided in thumb region 116, index finger region 118, middle finger region 120, and ring finger region 122, the at least one stay may be provided in a front or back of any four of the thumb region 116, index finger region 118, middle finger region 120, ring finger region 122, and little finger region 124. An opposing other stay may be provided in the other of the front or back of the same four of the thumb region 116, index finger region, middle finger region 120, ring finger region 122, and little finger region 124. The provided gripping zones in the form of the first stay and/or the second stay will be textured, particularly via a micro-etching procedure. In one embodiment, the micro-etching will produce a sand pattern on the first stay and/or the second stay. It will be understood that any other texturing configuration may be provided on any of the stays of glove 210 through 210D, with that texture being produced in any suitable manner thereon.

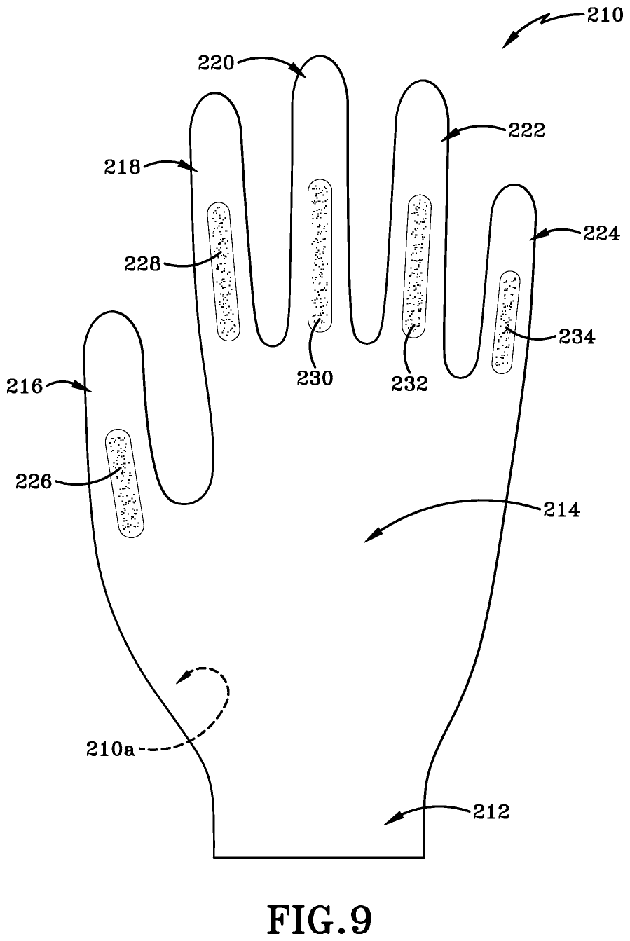

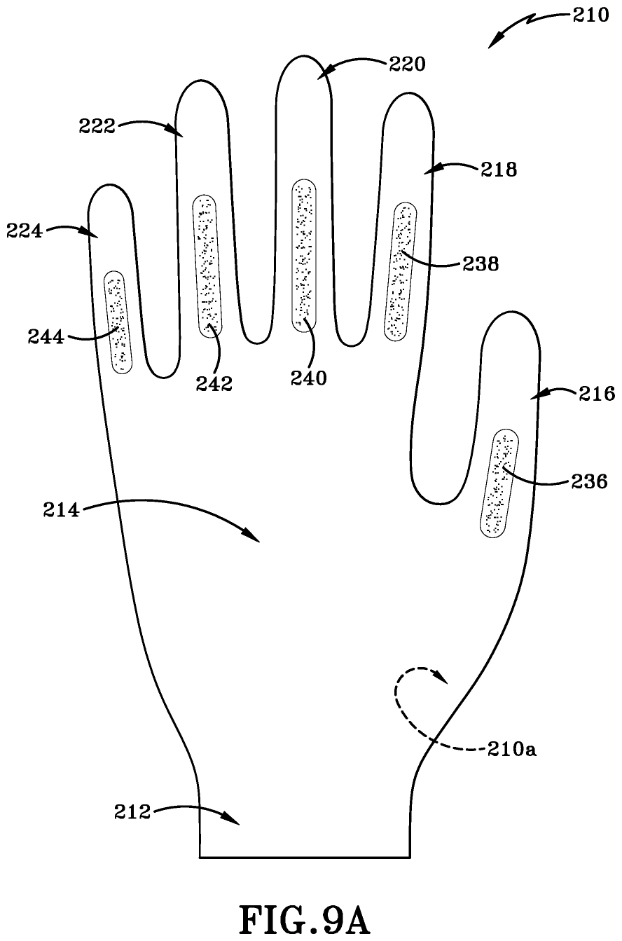

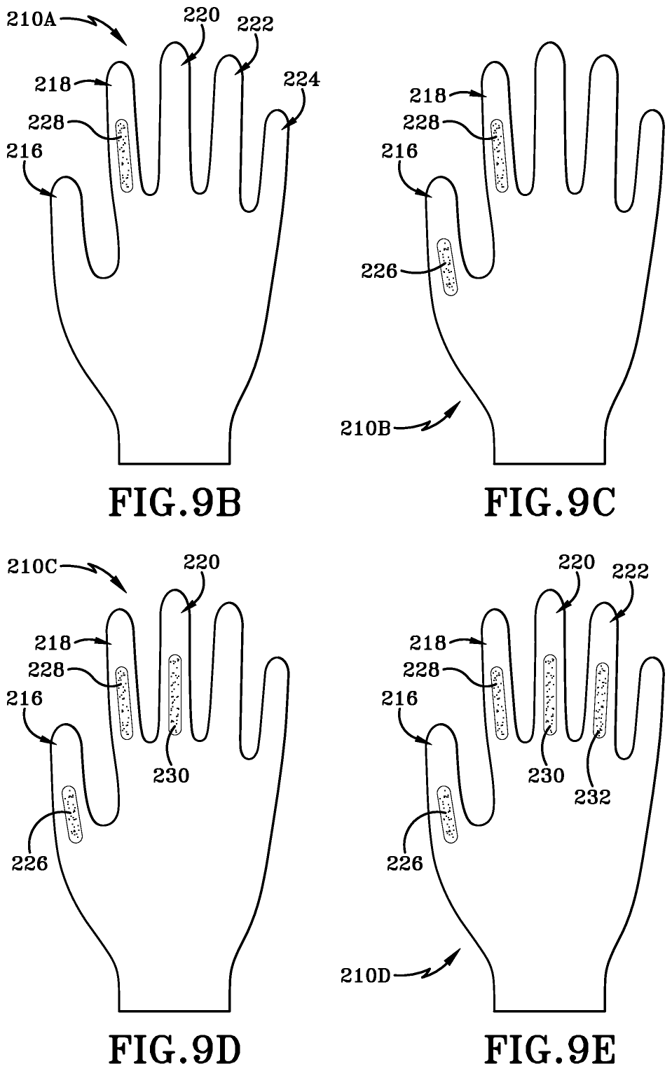

Referring now to FIGS. 9-9E there is shown a third embodiment of a glove in accordance with the present disclosure, generally indicated at 210. Glove 210 is substantially identical in structure and function to glove 10 except as shall be described hereafter.

Glove 210 comprises a wrist region 212, a palm region 214, a thumb region 216, an index finger region 218, a middle finger region 220, a ring finger region 222, and a little finger region 224. Glove 210 defines an interior cavity 210a which is configured to receive a hand of a person therein. Thumb region 216, index finger region 218, middle finger region 220, ring finger region 222, and little finger region 224 comprise digit regions which are configured to receive an associated one of a thumb, an index finger, a middle finger, a ring finger, and a little finger of the person's hand, respectively.

Glove 210 is an ambidextrous glove which is capable of being worn on either of a left hand or a right hand of the person. In the ambidextrous glove 210 each of the thumb region 216, index finger region 218, middle finger region 220, ring finger region 222, and little finger region 224 are aligned along a common plane identical to plane “P” shown in FIG. 3.

In accordance with an aspect of the present disclosure, glove 210 is provided with at least one stay in at least one of the digit regions. FIG. 9 shows a first stay 226 provided in the front of thumb region 216, a first stay 228 provided in the front of index finger region 218, a first stay 230 provided in the front of middle finger region 220, a first stay 232 provided in the front of ring finger region 222, and a first stay 234 provided in the front of little finger region 224. First stay 226 is substantially identical in structure and function to first stay 26. Similarly, first stay 228 is substantially identical to first stay 28; first stay 230 is substantially identical to first stay 30; first stay 232 is substantially identical to first stay 32; and first stay 234 is substantially identical to first stay 34. FIG. 9A shows a second stay 236 provided in the back of thumb region 216, a second stay 238 provided in the back of index finger region 218, a second stay 240 provided in the back of middle finger region 220, a second stay 242 provided in the back of ring finger region 222, and a second stay 244 provided in the back of little finger region 224. Each of the second stays 236, 238, 240, 242, and 244, is substantially identical in structure and function to second stays 36, 38, 40, 42, and 44.

Glove 210 differs from glove 210 in that all of the digit regions 216, 218, 220, 222, and 224 are of a gradually tapering circumference from palm region 214 to a tip of the respective digit region. In other words, each digit region does not include a reduced-circumference fingertip region which extends from the tip of the digit region to a flaring circumference transition portion, and then to a remaining portion of a larger circumference than the fingertip region. In particular, the digit regions of glove 210 do not have bullet-tip shaped fingertip regions.

FIGS. 9B through 9E show, respectively, a second example of the third embodiment glove indicated at 210A, a third example of the third embodiment glove indicated at 210B, a fourth example of the third embodiment glove indicated at 210C, and a fifth example of the third embodiment glove indicated at 210D. Glove 210A (FIG. 9B), like glove 10A, has a single digit region with the associated first and second stays formed therein. Glove 210A is illustrated as having index finger region 218 with first stay 228 on provided on the front thereof. It will be understood that a second stay may be provided on the back of index finger region 218 and that second stay may be laterally aligned with and opposed to first stay 228. It will be further understood that instead of index finger region 218 being provided with at least one stay, any other one of the digit regions may include a first stay and/or a second stay.

Glove 210B (FIG. 9C) shows thumb region 216 with at least first stay 226 provided thereon and index finger region 218 with at least first stay 228 provided thereon. It will be understood that any two of the digit regions on glove 210B may include a first stay and/or second stay thereon.

Glove 210C (FIG. 9D) shows thumb region 216 with at least first stay 226 provided thereon, index finger region 218 with at least first stay 228 provided thereon, and middle finger region 220 with at least first stay 230 provided thereon. It will be understood that any three of the digit regions on glove 210C may include a first stay and/or second stay thereon.

Glove 210D (FIG. 9E) shows thumb region 216 with at least first stay 226 provided thereon, index finger region 218 with at least first stay 228 provided thereon, middle finger region 220 with at least first stay 230 provided thereon, and ring finger region 222 with at least first stay 232 provided thereon. It will be understood that any four of the digit regions on glove 210C may include a first stay and/or second stay thereon.

It will further be understood that the exterior surface of gloves 210 through 210E in the region of one or more of first stays 226, 228, 230, 232, 234 and the second stays provided thereon may be textured. The texturing may be provided via any suitable mechanism. One suitable way of texturing glove 210 through 210E is through micro-etching, particularly to form a sand pattern. It will be understood, however, that in other embodiments, a diamond pattern, herringbone pattern etc., may be provided instead of the micro-etched sand pattern and that the texturing may be provided in ways other than through micro-etching.

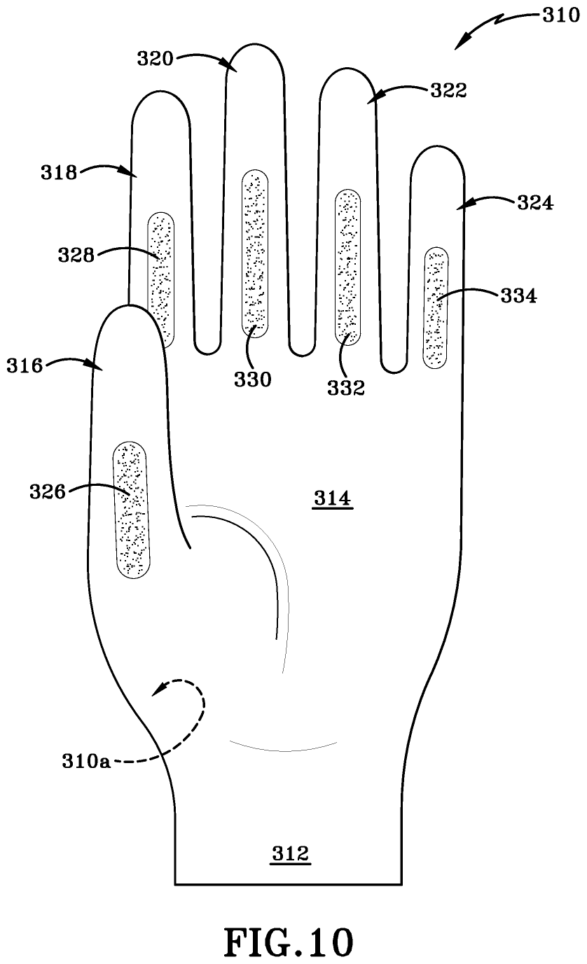

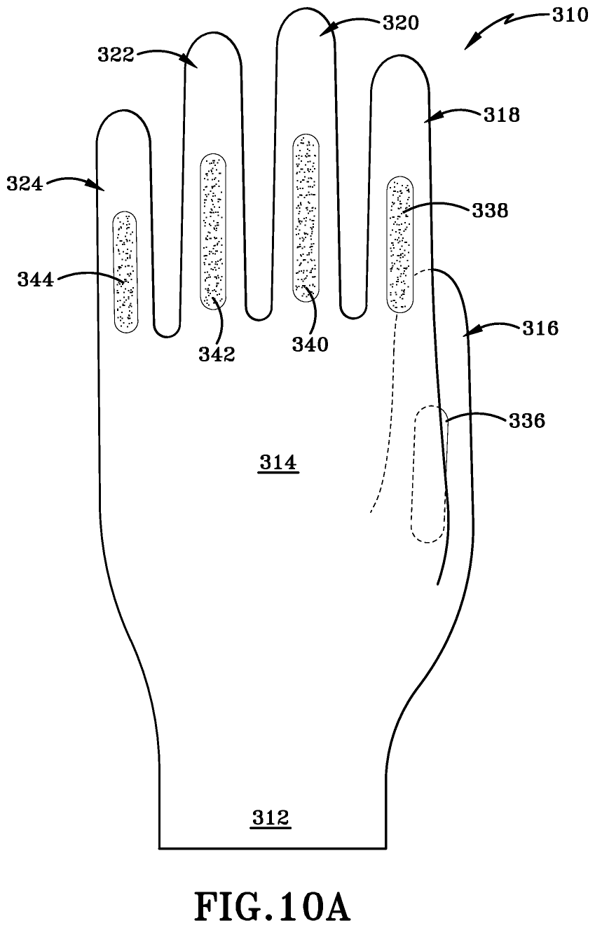

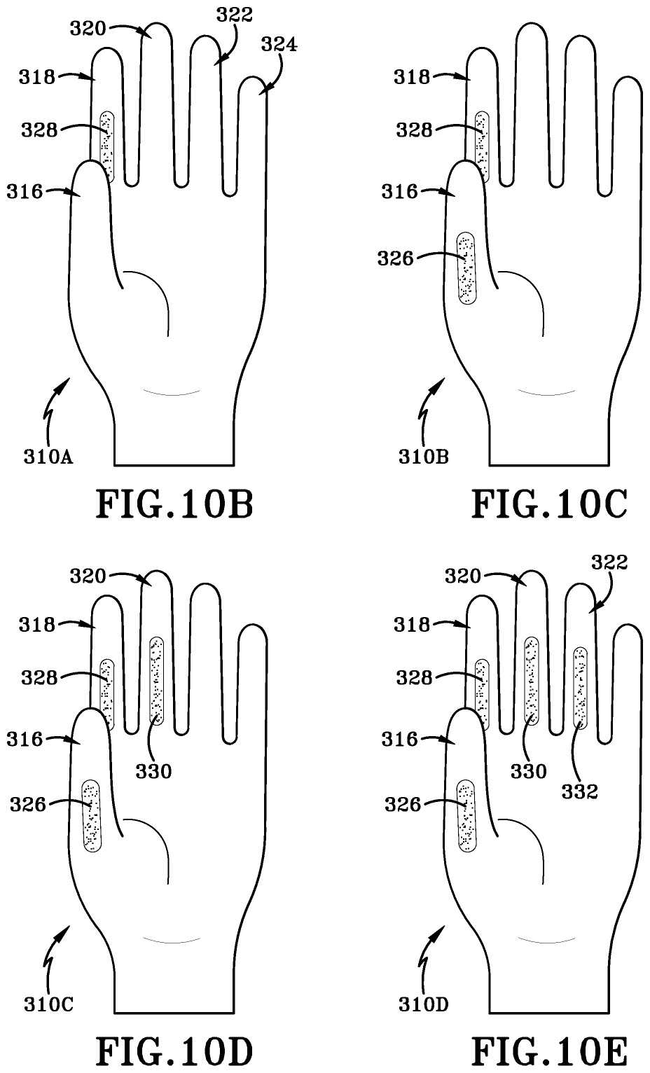

Referring now to FIGS. 10-10E there is shown a fourth embodiment of a glove in accordance with the present disclosure. FIGS. 10 and 10A show a first example of the fourth embodiment of the glove, generally indicated at 310. Glove 310 is substantially identical in structure and function to glove 110 except that instead of each digit region comprising a reduced-circumference fingertip region, a transition portion and a remaining portion as in glove 110, each of the digit regions of glove 310 gradually tapers in circumference from the palm region 314 of the glove to the tip of the associate digit region, similar to glove 210.

Glove 310 is a hand-specific glove (illustrated to be worn on a left had of a person) and comprises a wrist region 312, palm region 314, a thumb region 316, an index finger region 318, a middle finger region 320, a ring finger region 322, and a little finger region 324. Glove 310 defines an interior cavity 310a which is configured to receive the person's hand. Thumb region 316, index finger region 318, middle finger region 320, ring finger region 322, and little finger region 324 comprise digit regions which are configured to receive an associated one of a thumb, an index finger, a middle finger, a ring finger, and a little finger of the person's hand, respectively.

In accordance with an aspect of the present disclosure, glove 310, like glove 110 is provided with at least one stay in at least one of the digit regions. FIG. 10 shows a first stay 326 provided in the front of thumb region 316, a first stay 328 provided in a front of index finger region 318, a first stay 330 provided in a front of middle finger region 320, a first stay 332 provided in a front of ring finger region 322, and a first stay 334 provided in a front of little finger region 324. First stay 326 is substantially identical in structure and function to first stay 26. Similarly, first stay 328 is substantially identical to first stay 28; first stay 330 is substantially identical to first stay 30; first stay 332 is substantially identical to first stay 32; and first stay 334 is substantially identical to first stay 34. FIG. 10A shows a second stay 336 provided in a back of thumb region 316, a second stay 338 provided in a back of index finger region 318, a second stay 340 provided in a back of middle finger region 320, a second stay 342 provided in a back of ring finger region, and a second stay 342 provided in a back of little finger region 324. Each of the second stays 336, 338, 340, 342, and 344, is substantially identical in structure and function to second stays 36, 38, 40, 42, and 44.

FIGS. 9B through 9E show, respectively, a second example of the fourth embodiment glove indicated at 310A, a third example of the fourth embodiment glove indicated at 310B, a fourth example of the fourth embodiment glove indicated at 310C, and a fifth example of the fourth embodiment glove indicated at 310D. Glove 310A (FIG. 10B), like glove 110A, has a single digit region with one or both of the associated first and second stays formed therein. Glove 310A is illustrated as having index finger region 318 with first stay 328 on a front thereof. It will be understood that a second stay may be provided on the back thereof and that second stay may be laterally aligned with and opposed to first stay 328. It will be further understood that instead of index finger region 318 being provided with at least one stay, any other one of the digit regions may include first and/or second stays.

Glove 310B (FIG. 10C) shows thumb region 316 with at least first stay 326 provided thereon and index finger region 318 with at least first stay 328 provided thereon. Although not illustrated herein, it will be understood a second stay may be provided on the back of each of the thumb region 316 and index finger region 318. It will further be understood that any two of the digit regions on glove 310B may include a first stay and/or second stay thereon.

Glove 310C (FIG. 10D) shows thumb region 316 with at least first stay 326 provided on a front thereof, index finger region 318 with at least first stay 328 provided on a front thereof, and middle finger region 320 with at least first stay 330 provided on a front thereof. It will be understood that a second stay may be provided on the back of each of the thumb region 316, index finger region 318, and middle finger region 320. It will further be understood that any three of the digit regions on glove 310C may include a first stay and/or second stay thereon.

Glove 310D (FIG. 9E) shows a front of thumb region 316 with at least first stay 326 provided thereon, index finger region 318 with at least first stay 328 provided thereon, middle finger region 320 with at least first stay 330 provided thereon, and ring finger region 322 with at least first stay 332 provided thereon. It will be understood that a second stay may be provided on the back of each of the thumb region 316, index finger region 318, middle finger region 320, and ring finger region 322. It will further be understood that any four of the digit regions on glove 310D may include a first stay and/or second stay thereon.

It will further be understood that the exterior surface of gloves 310 through 310E in the region of one or more of first stays 326, 328, 330, 332, 334 and any second stays provided thereon may be textured. The texturing may be provided via any suitable mechanism. One suitable way of texturing glove 310 through 310E is through micro-etching, particularly to form a sand pattern. It will be understood, however, that in other embodiments, a diamond pattern, herringbone pattern etc., may be provided instead of the micro-etched sand pattern and that the texturing may be provided in ways other than through micro-etching.

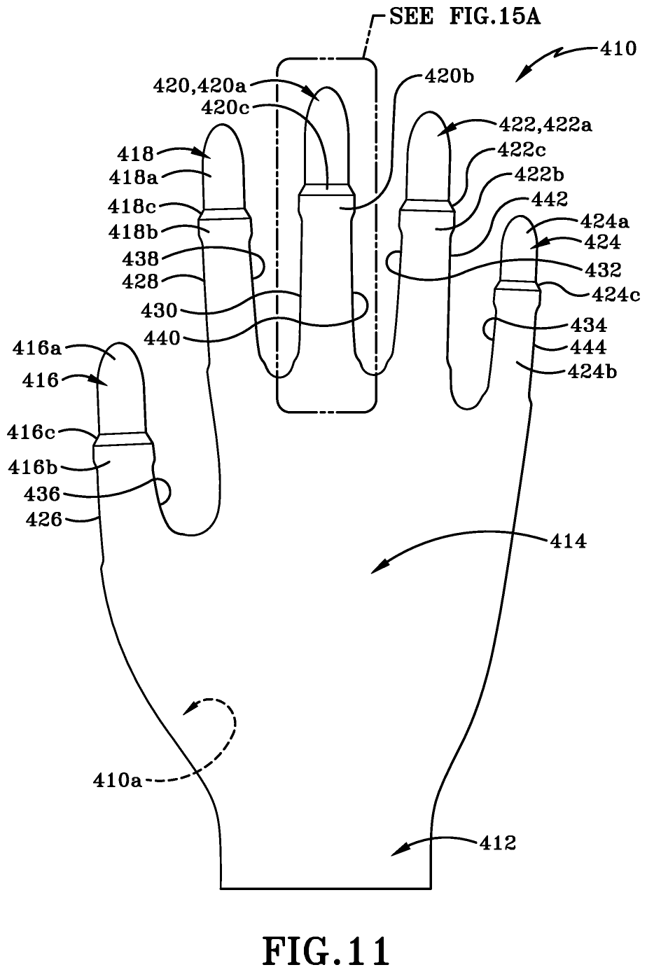

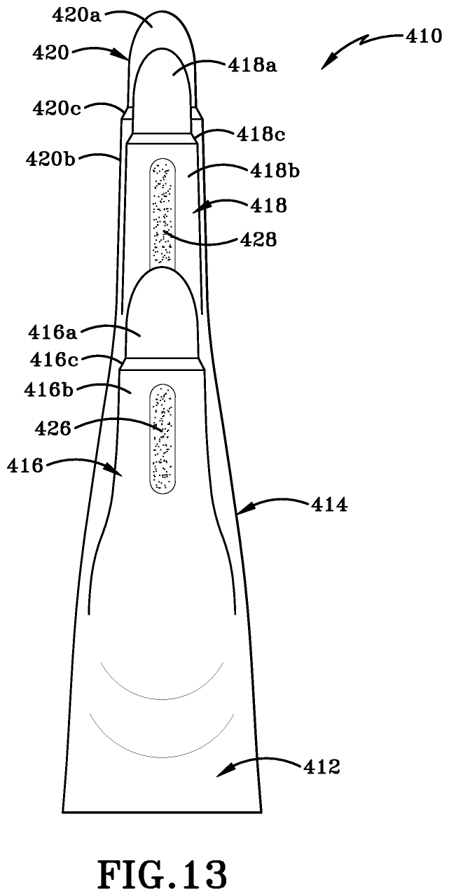

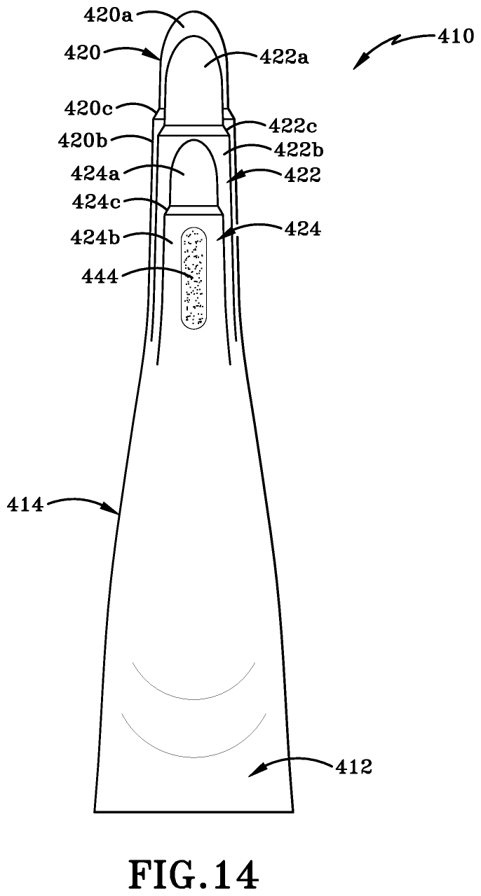

Referring now to FIGS. 11-15C there is shown a first example of a fifth embodiment of a glove in accordance with the present disclosure, generally indicated at 410. Glove 410 comprises a wrist region 412, a palm region 414, a thumb region 416, an index finger region 418, a middle finger region 420, a ring finger region 422, and a little finger region 424. Glove 410 defines an interior cavity 410a which is configured to receive a hand of a person therein. Thumb region 416, index finger region 418, middle finger region 420, ring finger region 422, and little finger region 424 comprise digit regions which are configured to receive an associated one of a thumb, an index finger, a middle finger, a ring finger, and a little finger of the person's hand, respectively.

Glove 410 as illustrated in FIGS. 11-15C is an ambidextrous glove which is substantially identical to glove 10 except for the placement of gripping zones in the form of first stays and second stays, as will be described later herein. In all other aspects, glove 410 is identical in structure and function to glove 10.

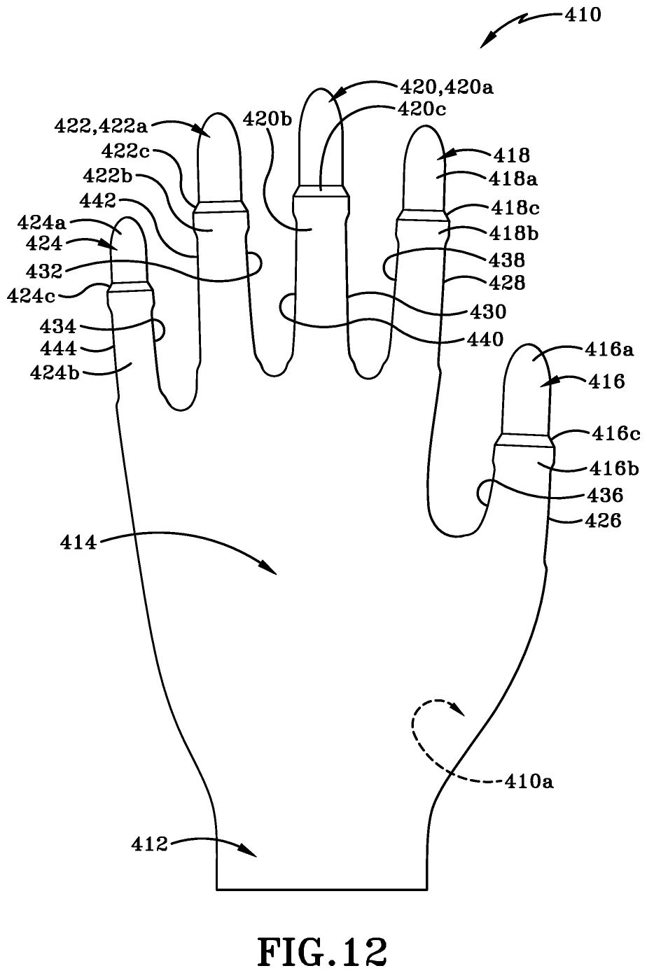

As illustrated in each of FIGS. 11-15C, each digit region of glove 410 is comprised of a fingertip region and a remaining portion. The fingertip region originates in a tip of the respective digit region and extends downwardly towards palm region 414 for a distance. The distance is of a length such that the fingertip region will generally be located adjacent or near a first knuckle of the person's associated thumb or finger when glove 410 is worn. The remaining portion extends between the fingertip region and the palm region 414 with a tapering transition portion being located between the remaining portion and the fingertip region as described with respect to glove 10. As illustrated in FIG. 12, thumb region 416 includes a fingertip region 416a, a remaining portion 416b, and a transition portion 416c. Index finger region 418 includes a fingertip region 418a, a remaining portion 418b, and a transition portion 418c. Middle finger region 420 includes fingertip region 420a, a remaining portion 420b, and a transition portion 420c. Ring finger region 422 includes a fingertip region 422a, a remaining portion 422b, and a transition portion 422c. Little finger region 424 includes a fingertip region 424a, a remaining portion 424b, and a transition portion 424c.

FIGS. 11-15B show each of the fingertip regions 416a, 418a, 420a, 422a, and 424a are of a reduced circumference relative to the associated remaining portions 416b, 418b, 420b, 422b, and 424b. The illustrated fingertip regions 416a, 418a, 420a, 422a, and 424a are of a “bullet-tip” shape but it will be understood that other reduced-circumference configurations may be provided on the digit regions of glove 410 instead.

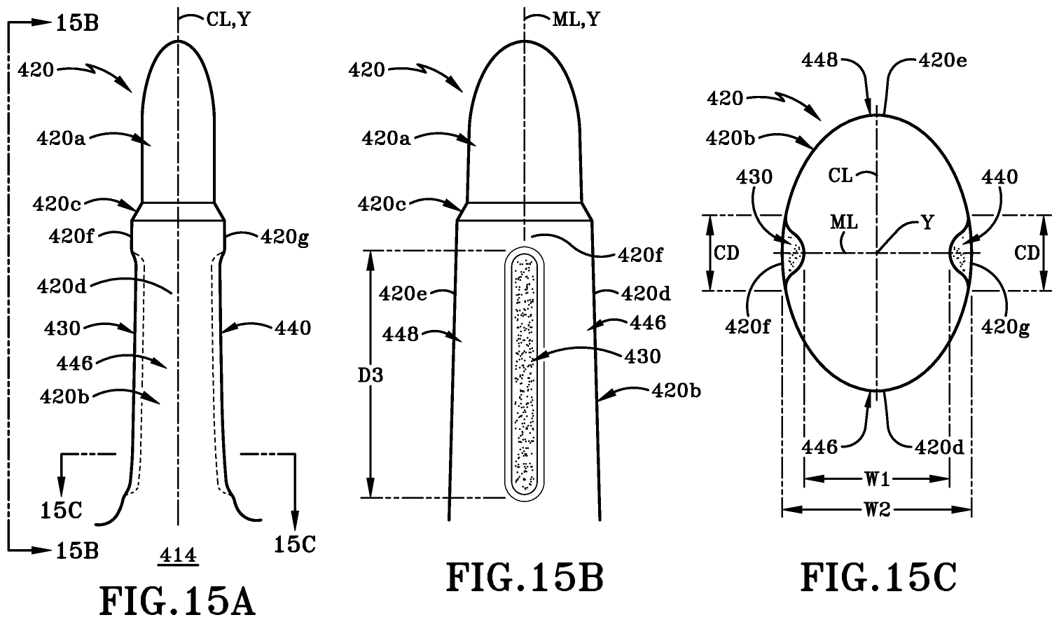

When glove 410 is worn on the left hand as illustrated in FIG. 11, the surface of the glove facing the viewer may be considered to be the “front” surface of the glove 410. Consequently, the surface of the wrist region 412, palm region 414, and digit regions facing the viewer of FIG. 11 may be considered to be the “front” surface of the wrist region 412, palm region 414, and digit regions 416, 418, 420, 422, and 424. FIG. 12 then illustrates a “back” surface of the glove so the surface of the wrist region 412, palm region 414, and digit regions facing the viewer of FIG. 12 are then the “back” surface of the wrist region 412, palm region 414, and digit regions 416, 418, 420, 422, and 424. Using FIGS. 15A, 15B and 15C as an exemplary digit region, the front of middle finger region 420 is designated by the reference number 420d. The front 420d extends from the tip of the middle finger region through to the palm region 414. Similarly the back of middle finger region 420 is designated by the reference number 420e, a first side of middle finger region 420 is designated by the reference number 420f, and a second side of middle finger region is designated by the reference number 420g. Each of back 420e, first side 420f, and second side 420g extend from the tip of middle finger region 420 to palm region 414. Together the front 420d, back 420e, first side 420f, and second side 420g form an exterior perimeter of middle finger region 420. It should be noted that the terms “front”, “back”, “left” or “first”, and “right” or “second” are used to describe the orientation of the glove 410 as illustrated in FIGS. 11 and 12. The terms “front”, “back”, “left”, and “right” should therefore not be narrowly construed to necessarily describe the orientation of the glove 410 during use, particularly since glove 410 is an ambidextrous glove.

FIG. 15A shows that front 420d of middle finger region 420 has a centerline “CL” which is midway between first side 420f and second side 420g. FIG. 15B further shows that first side 420f has a midline “ML” which is midway between front 420d and back 420e. FIG. 15C shows that centerline “CL” and midline “ML” are oriented orthogonally to one another and intersect along an imaginary longitudinal axis “Y” of middle finger region 420. The longitudinal axis “Y” extends middle finger region 420 from the tip of the middle finger region 420 to the palm region 414.

Although not specifically called out in the attached drawings, it will be understood that each of the thumb region 416, index finger region 418, ring finger region 422, and little finger region 424 has a front substantially similar to front 420d, a back substantially similar to back 420e, a first side substantially similar to first side 420f, and second side substantially similar to second side 420g. Each of the other digit regions will also have a centerline, a midline, and a longitudinal axis.

In accordance with an aspect of the present disclosure, glove 410 is provided with at least one stay in at least one of the digit regions. FIG. 11 shows a first stay 426 provided in a first side of thumb region 416, a first stay 428 provided in a first side of index finger region 418, a first stay 430 provided in a first side of middle finger region 420, a first stay 432 provided in a first side of ring finger region 422, and a first stay 434 provided in a first side of little finger region 424. Each first stay 426, 428, 430, 432, 434 comprises an arcuate concave indentation which is formed in a section of the first side of the associated digit region. In particular, the first stay of each digit region is located in remaining portion 416b, 418b, 420b, 422b, or 424b of the respective digit region. Referring to FIGS. 15A through 15C, the first stays will be described in greater detail with reference to middle finger region 420. It will be understood, however, that the description applies equally to all other digit regions on glove 410. First stay 430 of middle finger region 420 originates a short distance below the transition portion 420c thereof and extends downwardly towards palm region 414, terminating a short distance above the finger crotch between middle finger region 420 and index finger region 418 and above the finger crotch between middle finger region 420 and ring finger region 422, as can be seen in FIG. 11. First stay 430 extends substantially parallel to the longitudinal axis “Y” of middle finger region 420. First stay 430 is located in remaining portion 420b in a position such that, when glove 410 is worn, first stay 430 will extend from slightly below the first knuckle of the person's hand, along the side of their middle finger, extend over the second knuckle and terminate a short distance from the finger crotch between the person's middle finger and index finger. The second stay 440 formed in second side 420g of middle finger region 420 is substantially identically configured to first stay 430. First stay 430 and second stay 440 are opposed to one another and laterally aligned with one another.

In accordance with an aspect of the present disclosure, a second stay is provided in each of the digit regions of glove 410. FIG. 12 shows a second stay 436 provided in thumb region 416, a second stay 438 provided in index finger region 418, a second stay 440 provided in middle finger region 420, a second stay 42 provided in ring finger region 422, and a second stay 444 provided in little finger region 424. Each second stay 436, 438, 440, 442, 444 comprises a concave indentation formed in the second side of the associated one of the thumb region 416, index finger region 418, middle finger region 420, ring finger region 422, and little finger region 424. By way of example, FIG. 15B shows that first stay 430 is located opposite to and laterally aligned with second stay 440 in middle finger region 420. First stay 430 and second stay 440 are oriented substantially parallel to longitudinal axis “Y” of middle finger region 420. Similarly, first stay 426 and second stay 436 are located opposite to and laterally aligned with one another, and are both oriented substantially parallel to the longitudinal axis of thumb region 416; first stay 428 and second stay 438 are located opposite to and laterally aligned with one another, and substantially parallel to the longitudinal axis of index finger region 418; first stay 432 and second stay 442 are located opposite to and laterally aligned with one another, and substantially parallel to the longitudinal axis of ring finger region 422; and first stay 434 and second stay 444 are located opposite to and laterally aligned with one another, and substantially parallel to the longitudinal axis of little finger region 424. The concavity of the first and second stays of any one of the digit regions is such that the stays open away from one another and the width W1″ (FIG. 15C) between the opposed interior surfaces of the stays (such as first stay 430 and second stay 440) is reduced relative to the width “W2” between opposing interior surfaces of the rest of the remaining portion.

The concave indentation which constitutes each of the first stay 430 and the second stay 440 only extends around part of a total circumference of remaining portion 420b of middle finger region 420. The circumference is oriented at ninety degrees, i.e., orthogonally, relative to the longitudinal axis “Y” (FIG. 15C). As illustrated, the first stay 430 extends for less than one quarter of the total circumference of the remaining portion 420b as can be seen in FIG. 15C. Similarly, the second stay 440 extends for less than one quarter of the total circumference of the remaining portion 420b. FIG. 15C also shows that the concave indentations of first stay 430 and second stay 440 form projections which extend into the portion of the interior cavity 410a defined by the middle finger region 420 of glove 410. The reduced width “W1” between the projections of these stays 430, 440 will bring the first stay 430 and second stay 440 into contact with the person's middle finger received in middle finger region 420 and will frictionally engage the same as has been described earlier herein. This frictional engagement will reduce the tendency of the middle finger region 420 to slide relative to the middle finger during performance of a task while wearing glove 410. The first and second stays on the other digit regions will similarly frictionally engage the person's other digits and thereby reduce the tendency for relative movement between the digit regions and the person's fingers and thumbs while wearing glove 410.

Referring now to FIGS. 15A through 15C, the concave indentation which constitutes each of first stay 430 and second stay 440 extends around less than a quarter of the total circumference of the middle finger region 420. As a consequence, an “un-indented” section of middle finger region 420 is located between the end of first stay 430 and the end second stay 440 on each of the front 420d and back 420e of middle finger region 420. The “un-indented” regions are indicated by the reference characters 446 and 448 in FIGS. 15A and 15C.

In accordance with another aspect of the present disclosure, an exterior surface of glove 410 along first stays 426, 428, 430, 432, and 434, and along second stays 436, 438, 440, 442, and 444 is textured. In one embodiment the exterior surface of the glove along the stays is micro-etched to create the texturing. In one embodiment, the micro-etching creates a sand pattern texture that occurs only on the first stays 426, 428, 430, 432, and 434 and second stays 436, 438, 440, 442, and 444. It will be understood that in other embodiments, other patterns, such as a diamond pattern or a herringbone pattern, or any other desired pattern, may be provided on the first stays and second stays by any other process.

Glove 410 is used in a substantially identical manner to glove 10 and therefore will not be described in much detail hereafter other than to state that when the appropriate digit of the person's hand is received in one of the digit regions of the glove 410 which includes first stays and second stays, the curvature of the first stays and second stays “flattens out” (similar to what is illustrated in FIGS. 6A and 6B with respect to glove 10. The flattened out interior surface of the first stay and second stay remains in physical contact with the person's digit and helps to ensure that the associated digit region of glove 410 remains in a relatively fixed position with respect to the person's digit. In other words, the first stay and second stay help to ensure that the digit region doesn't slide longitudinally along the person's finger or thumb as they bend and flex their finger or thumb. This arrangement helps the person to retain their tactile sensitivity and dexterity even though they are wearing glove 410.

The micro-etch treatment or texturing provided on each of the first stays and second stays of glove 410 through 410D aids in improving the grip-ability of glove 410. The rest of the exterior surface of the glove other than the micro-etched first stays and second stays is smooth, i.e., free of texturing. The texturing of the stays helps a person wearing glove 410 to better grip objects in their hand. The micro-etching also strengthens the regions of the glove which include first stays 426, 428, 430, 432, 434 and second stays 436, 438, 440, 442, and 444.

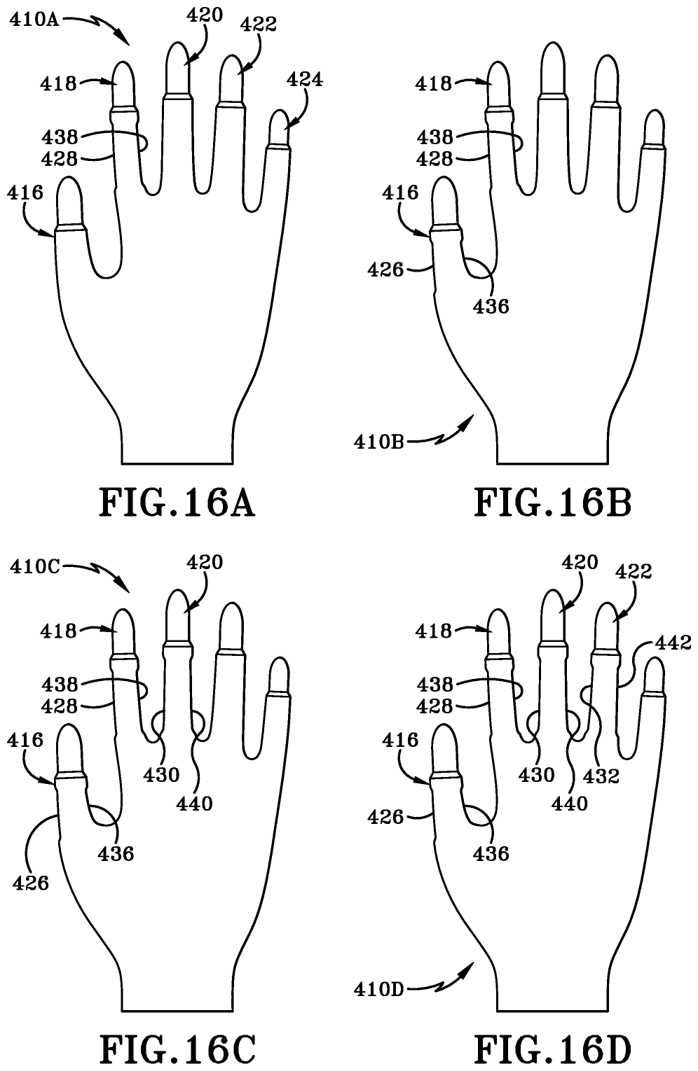

FIG. 16A through 16D show a second example, third example, fourth example, and fifth example, respectively, of the fifth embodiment of the glove 410. The second example glove, designated as glove 410A is substantially identical in structure and function to glove 10A, except for the provision of first and second stays on the first side and second side of any single digit region instead of on the front and back of a single digit region. By way of example only, in FIG. 16A index finger region is provided with a first stay 428 on a first side and a second stay 438 on a second side. The third example glove, designated as glove 410B is substantially identical in structure and function to glove 10B, except for the provision of the first and second stays on the first side and second side of any two digit regions instead of on the front and back of two digit regions. By way of example only, FIG. 16B shows a first stay 426 on a first side of thumb region 416 and a second stay 436 on the second side; and a first stay 428 on a first side of index finger region 418 and a second stay 438 on a second side thereof. The fourth example glove, designated as glove 410C in FIG. 16C is substantially identical in structure and function to glove 10C, except for the provision of the first and second stays on the first side and second side of any three digit regions instead of on the front and back thereof. By way of example only, FIG. 16C shows a first stay 426 on a first side of thumb region 416 and a second stay 436 on the second side thereof, a first stay 428 on a first side of index finger region 418 and a second stay 438 on a second side thereof, and a first stay 430 on a first side of middle finger region 420 and a second stay 440 on a second side thereof. The fifth example glove, designated as glove 410D in FIG. 16D is substantially identical in structure and function to glove 10D, except for the provision of the first and second stays on the first side and second side of any four digit regions instead of on the front and back thereof. By way of example only, FIG. 16D shows a first stay 426 on a first side of thumb region 416 and a second stay 436 on the second side thereof, a first stay 428 on a first side of index finger region 418 and a second stay 438 on a second side thereof, a first stay 430 on a first side of middle finger region 420 and a second stay 440 on a second side thereof, and a first stay 432 on a first side of ring finger region 422 and a second stay on a second side thereof.

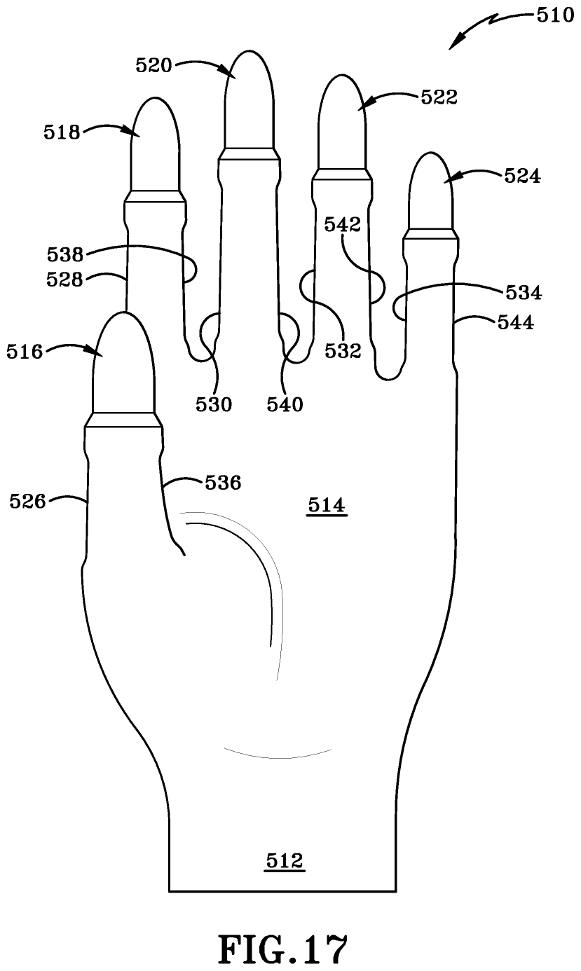

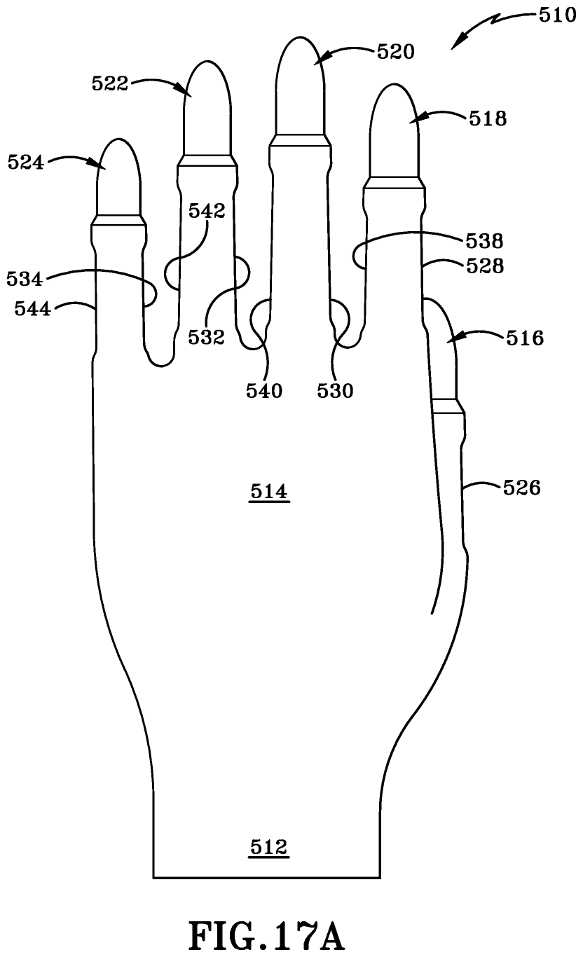

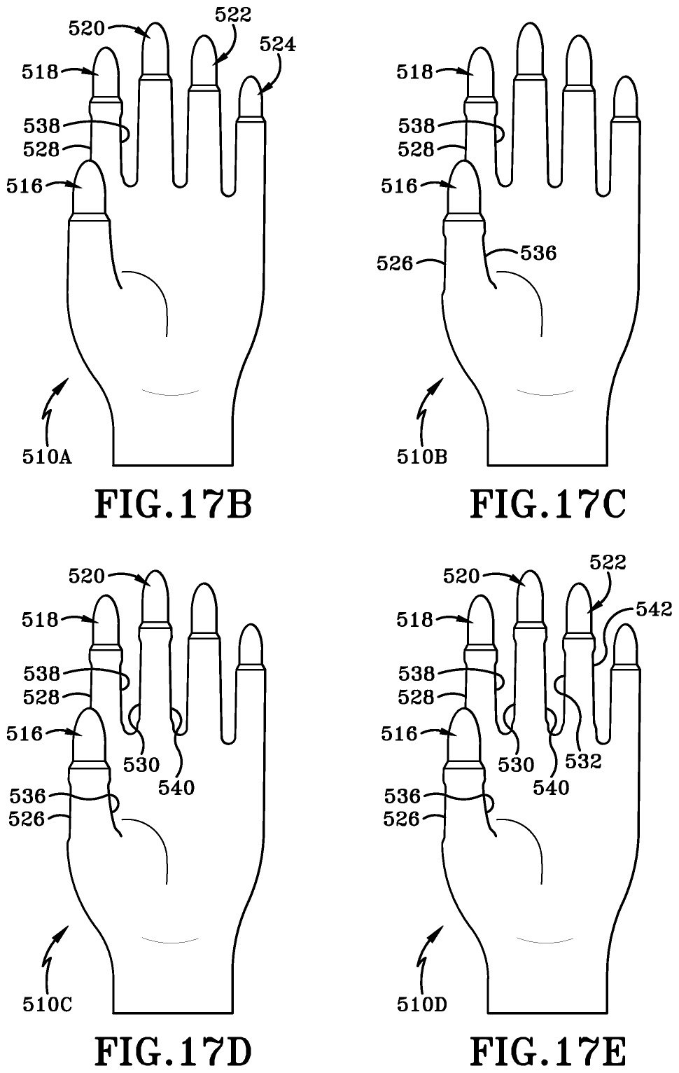

Referring to FIGS. 17-17A show a first example of a sixth embodiment of a glove in accordance with the present disclosure, generally indicated at 510. Glove 510 is substantially identical in structure and function to glove 410 except that glove 510 is a hand-specific glove and not an ambidextrous glove like glove 410.

Glove 510 includes a wrist region 512, a palm region 514, and digit regions which extend outwardly from the palm region 514. The digit regions include a thumb region 516, an index finger region 518, a middle finger region 520, a ring finger region 522, and a little finger region 524. Apart from the glove 510 being a hand-specific glove, all of the component parts of the glove are substantially identical in structure and function to glove 410. In particular, thumb region 516 is identical to thumb region 416; index finger region 618 is identical to index finger region 418, middle finger region 520 is identical to middle finger region 420, ring finger region 522 is identical to ring finger region 422, and little finger region 524 is identical to little finger region 424. Each of these digit regions includes a fingertip region that is identical in structure and function to the associated fingertip region 416a, 418a, 420a, 422a, and 424a. Each of these digit regions includes a remaining portion that is identical in structure and function to the associated remaining portion 416b, 418b, 420b, 422b, and 424b. Each of these digit regions includes a transition portion that is identical in structure and function to the associated transition portion 416c, 418c, 420c, 422c, and 422d. For clarity of illustration none of the fingertip region, transition portion, and remaining portion have been numbered in FIGS. 17 and 17A.

In accordance with an aspect of the present disclosure each of the thumb region 516, index finger region 518, middle finger region 520, ring finger region 522, and little finger region 524 includes at least one gripping zone. The at least one gripping zone comprises at least a first stay. The at least one gripping zone may further include a second stay. In particular, thumb region 516 includes a first stay 526 on a first side of thumb region 516 and a second stay 536 on the opposing second side of thumb region 516. Index finger region 518 includes a first stay 528 on a first side of index finger region 518 and a second stay 538 on a second side thereof. Middle finger region 520 includes a first stay 530 on a first side of middle finger region 520 and a second stay 540 on a second side thereof. Ring finger region 522 includes a first stay 532 on a first side of ring finger region 522 and a second stay 542 on a second side thereof. Little finger region 524 includes a first stay 534 on a first side of little finger region 524 and a second stay 544 on a second side thereof. First stays 526, 528, 530, 532, and 534 are identical in structure and function to first stays 426, 428, 430, 432, and 434. Second stays 536, 538, 540, 542, and 544 are identical in structure and function to second stays 436, 438, 440, 442, and 444. Each stay on glove 510 through 510D is provided with texturing, particularly via micro-etching. In one embodiment, the micro-etching will produce a sand pattern of texturing but it will be understood that other types of texturing and other patterns may be applied to the first and second stays on glove 510.

FIG. 17B through 17E show a second example, third example, fourth example, and fifth example, respectively, of the sixth embodiment of the glove 510. The second example glove, designated as glove 510A (FIG. 17B) is substantially identical in structure and function to glove 410A, except that the glove 510A is a hand-specific glove which has first and second stays on any one digit region. By way of example, glove 510A is illustrated as having a first stay 528 on a first side of index finger region 518 and a second stay 530 on a second side thereof. The third example glove, designated as glove 510B (FIG. 17C) is substantially identical in structure and function to glove 410B, except that the glove 510B is a hand-specific glove which has first and second stays on any two digit regions. By way of example only, glove 510B has a first stay 526 on a first side of thumb region 516, a second stay 536 on a second side of thumb region 516; a first stay 528 on a first side of index finger region 518, and a second stay 538 on a second side of index finger region 518. The fourth example glove, designated as glove 510C (FIG. 17D) is substantially identical in structure and function to glove 410C, except that the glove 510C is a hand-specific glove which has first and second stays on any three digit regions. By way of example only, glove 510C has a first stay 526 on a first side of thumb region 516, a second stay 536 on a second side of thumb region 516; a first stay 528 on a first side of index finger region 518, a second stay 538 on a second side of index finger region 518, a first stay 530 on a first side of middle finger region 520, and a second stay on a second side of middle finger region 520. The fifth example glove, designated as glove 510D (FIG. 17E) is substantially identical in structure and function to glove 510D, except that the glove 510D is a hand-specific glove which has first and second stays on any four digit regions. By way of example only, glove 510D has a first stay 526 on a first side of thumb region 516, a second stay 536 on a second side of thumb region 516; a first stay 528 on a first side of index finger region 518, a second stay 538 on a second side of index finger region 518, a first stay 530 on a first side of middle finger region 520, a second stay on a second side of middle finger region 520, a first stay 532 on a first side of ring finger region 522, and a second stay 542 on a second side of ring finger region 522.

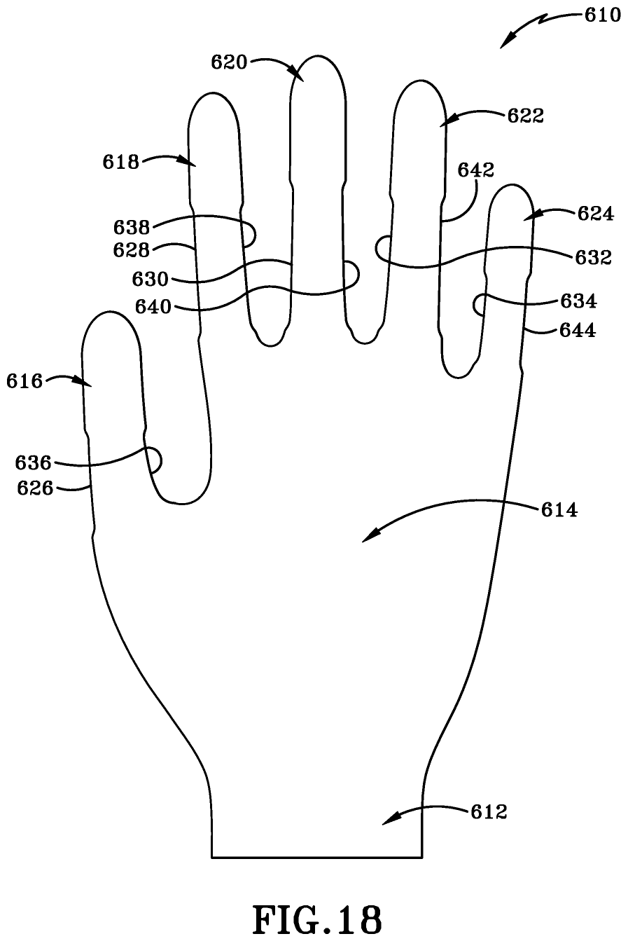

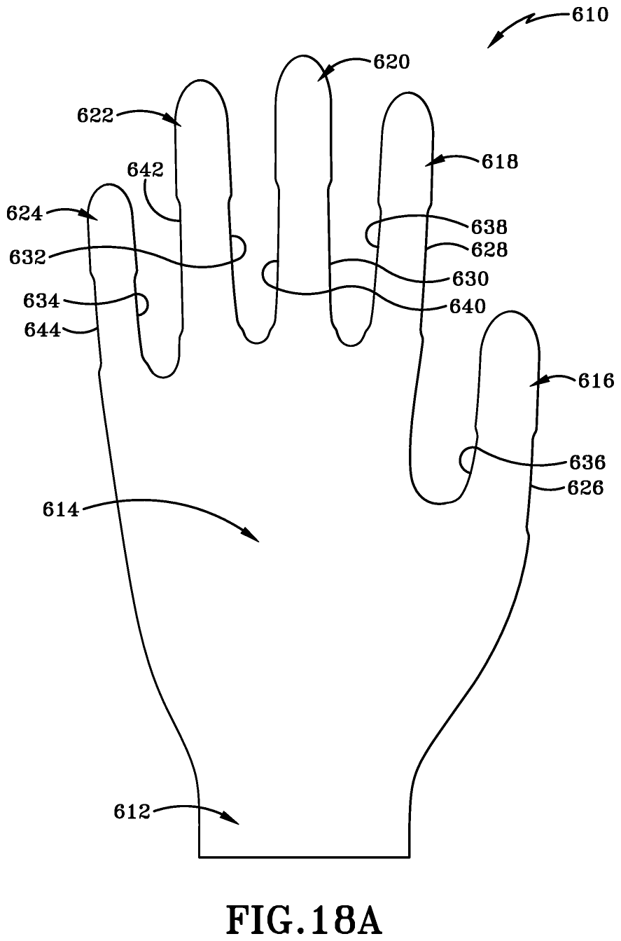

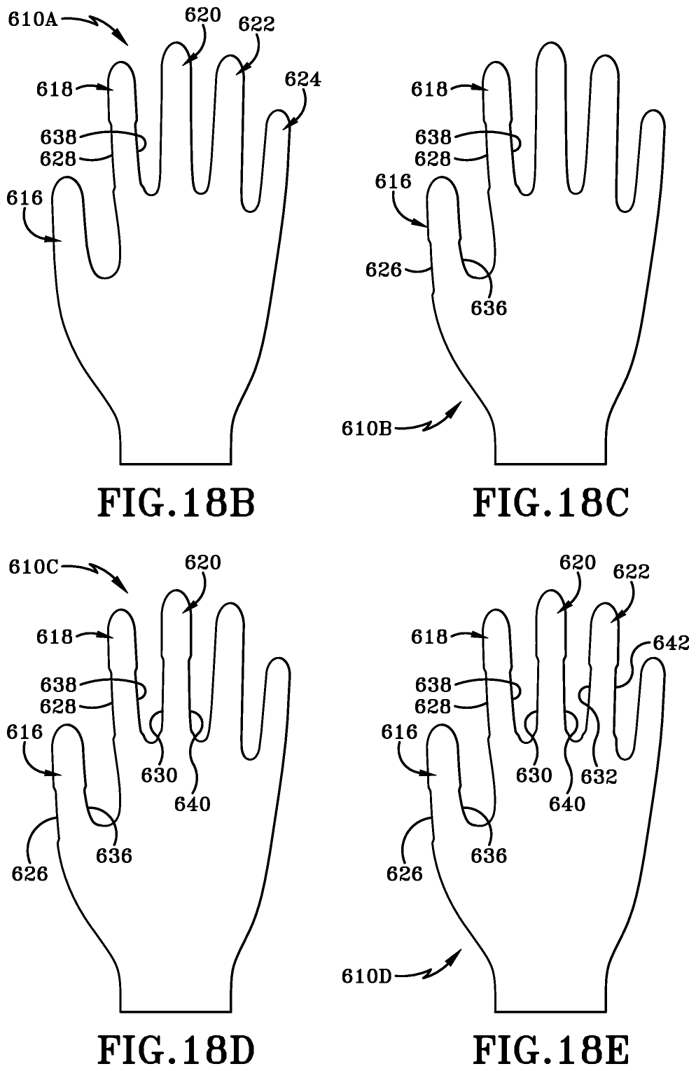

Referring to FIGS. 18-18A show a first example of a seventh embodiment of a glove in accordance with the present disclosure, generally indicated at 610. Glove 610 is substantially identical in structure and function to glove 410 except that glove 610 does not include the reduced-circumference fingertip regions of glove 410 or the transition portions which flare outwardly from the fingertip regions to the remaining portion of each digit region. Instead, each digit region of glove 610 gradually tapers in circumference moving in a direction away from the palm region 614 to a tip of the associated digit region. In other words, glove 610 is substantially similar to glove 110 except for the placement of the first stays and second stays on the respective digit regions. In glove 110 the first stay and second stay of each digit region are formed respectively on the front and back of the digit region. In glove 610, a first stay is formed in the first side of each digit region and the second stay is formed in the second side thereof.

Glove 610 includes a wrist region 612, palm region 614, and digit regions which extend outwardly from the palm region 614. The digit regions include a thumb region 616, an index finger region 618, a middle finger region 620, a ring finger region 622, and a little finger region 624. In accordance with an aspect of the present disclosure each of the thumb region 616, index finger region 618, middle finger region 620, ring finger region 622, and little finger region 624 includes at least one gripping zone. The at least one gripping zone comprises at least a first stay. The at least one gripping zone may further include a second stay. In particular, thumb region 616 includes a first stay 626 on a first side of thumb region 616 and a second stay 636 on the opposing second side of thumb region 616. Index finger region 618 includes a first stay 628 on a first side of index finger region 618 and a second stay 638 on a second side thereof. Middle finger region 620 includes a first stay 630 on a first side of middle finger region 620 and a second stay 640 on a second side thereof. Ring finger region 622 includes a first stay 632 on a first side of ring finger region 622 and a second stay 642 on a second side thereof. Little finger region 624 includes a first stay 634 on a first side of little finger region 624 and a second stay 644 on a second side thereof. First stays 626, 628, 630, 632, and 634 are identical in structure and function to first stays 426, 428, 430, 432, and 434. Second stays 636, 638, 640, 642, and 644 are identical in structure and function to second stays 436, 438, 440, 442, and 444. Each stay on glove 610 through 610D is provided with texturing, particularly via micro-etching. In one embodiment, the micro-etching will produce a sand pattern of texturing but it will be understood that any other texturing pattern produces by any other means may be applied to each of the first stays and second stays on glove 610.

FIG. 18B through 18E show a second example, third example, fourth example, and fifth example, respectively, of the seventh embodiment of the glove 610. The second example glove, designated as glove 610A (FIG. 18B) is substantially identical in structure and function to glove 410A, except that the glove 610A does not include the reduced-circumference fingertip regions and the tapering circumference transition portions. Glove 610A has first and second stays on the first and second sides, respectively, of any one of the digit regions. By way of example only, first and second stays 628, 638 are provided on opposing sides of index finger region 618. The third example glove, designated as glove 610B (FIG. 18C) is substantially identical in structure and function to glove 410B, except that the glove 610B does not include the reduced-circumference fingertip regions and the tapering circumference transition portions. Glove 610B has first and second stays on the first and second sides, respectively, of any two of the digit regions. By way of example only, first and second stays 626, 636 are provided on opposing sides of thumb region 616, and first and second stays 628, 638 are provided on opposing sides of index finger region 618. The fourth example glove, designated as glove 610C (FIG. 18D) is substantially identical in structure and function to glove 410C, except that the glove 610A does not include the reduced-circumference fingertip regions and the tapering circumference transition portions. Glove 610C has first and second stays on the first and second sides, respectively, of any three of the digit regions. By way of example only, first and second stays 626, 636 are provided on opposing sides of thumb region 616, first and second stays 628, 638 are provided on opposing sides of index finger region 618, and first and second stays 630, 640 are provided on opposing sides of middle finger region 620. The fifth example glove, designated as glove 610D is substantially identical in structure and function to glove 610D (FIG. 18E), except that the glove 610D does not include the reduced-circumference fingertip regions and the tapering circumference transition portions. Glove 610D has first and second stays on the first and second sides, respectively, of any four of the digit regions. By way of example only, first and second stays 626, 636 are provided on opposing sides of thumb region 616, first and second stays 628, 638 are provided on opposing sides of index finger region 618, first and second stays 630, 640 are provided on opposing sides of middle finger region 620, and first and second stays 632, 642 are provided on opposing sides of ring finger region 622.

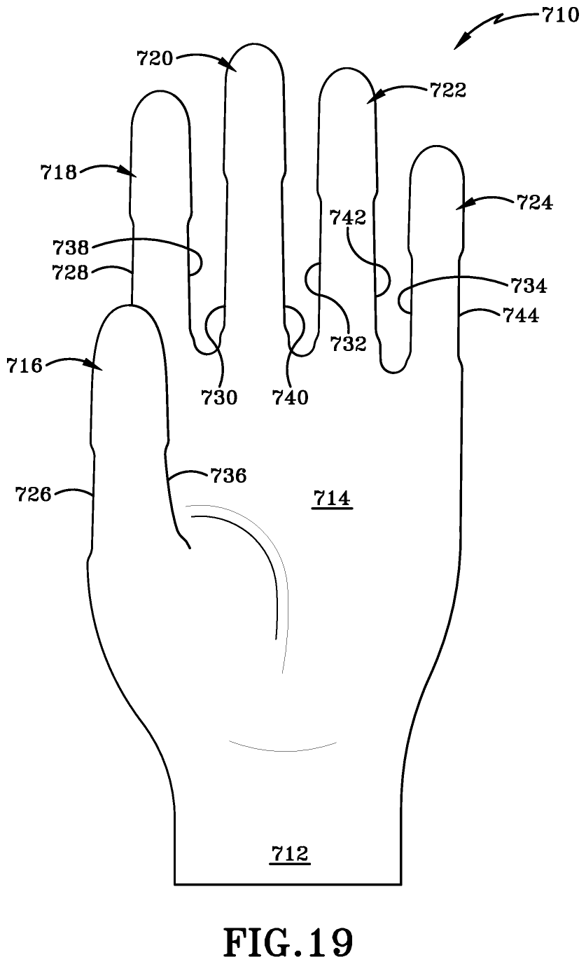

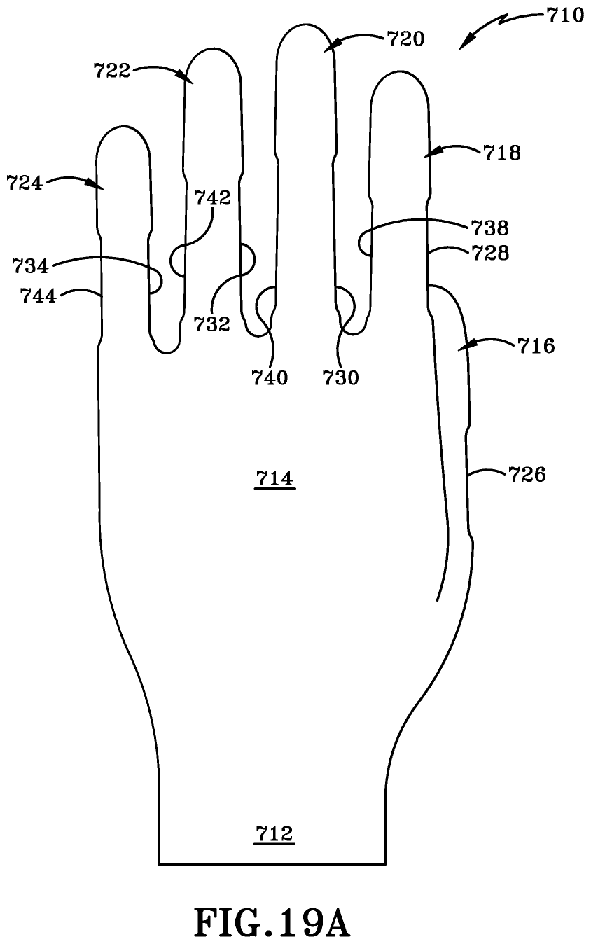

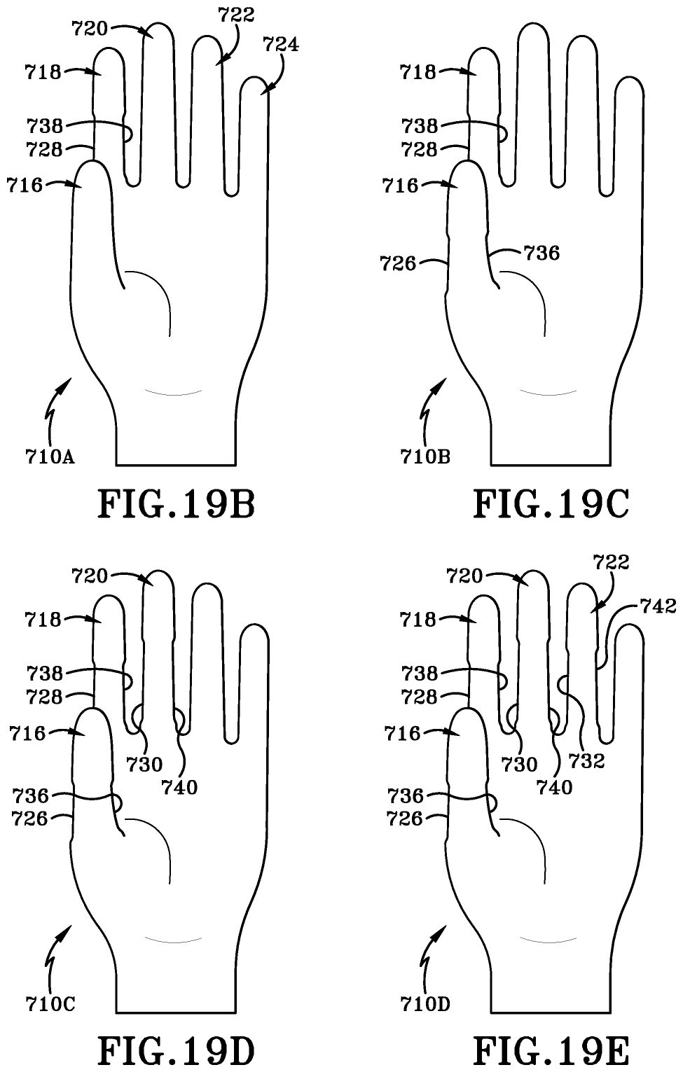

Referring to FIGS. 19-19A show a first example of an eighth embodiment of a glove in accordance with the present disclosure, generally indicated at 710. Glove 710 is substantially identical in structure and function to glove 610 except that glove 710 is a hand-specific glove instead of an ambidextrous glove. All other features of glove 710 are identical in structure and function to glove 610 and therefore will not be discussed in much detail hereafter.

Glove 710 includes a wrist region 712, palm region 714, and digit regions which extend outwardly from the palm region 714. The digit regions include a thumb region 716, an index finger region 718, a middle finger region 720, a ring finger region 722, and a little finger region 724. In accordance with an aspect of the present disclosure each of the thumb region 716, index finger region 718, middle finger region 720, ring finger region 722, and little finger region 724 includes at least one gripping zone. The at least one gripping zone comprises at least a first stay. The at least one gripping zone may further include a second stay. In particular, thumb region 716 includes a first stay 726 on a first side of thumb region 716 and a second stay 736 on the opposing second side of thumb region 716. Index finger region 718 includes a first stay 728 on a first side of index finger region 718 and a second stay 738 on a second side thereof. Middle finger region 720 includes a first stay 730 on a first side of middle finger region 720 and a second stay 740 on a second side thereof. Ring finger region 722 includes a first stay 732 on a first side of ring finger region 722 and a second stay 742 on a second side thereof. Little finger region 724 includes a first stay 734 on a first side of little finger region 724 and a second stay 744 on a second side thereof. First stays 726, 728, 730, 732, and 734 are identical in structure and function to first stays 626, 628, 630, 632, and 634. Second stays 736, 738, 740, 742, and 744 are identical in structure and function to second stays 636, 638, 640, 642, and 644.

Each stay on glove 710 through 710D is provided with texturing, particularly via micro-etching. In one embodiment, the micro-etching will produce a sand pattern of texturing but it will be understood that any other texturing pattern produces by any other means may be applied to each of the first stays and second stays on glove 710.

FIG. 19B through 19E show a second example, third example, fourth example, and fifth example, respectively, of the eighth embodiment of the glove 710. The second example glove, designated as glove 710A (FIG. 19B) is substantially identical in structure and function to glove 610A, except that the glove 710A is a hand-specific glove instead of being an ambidextrous glove. Glove 710A has first and second stays on the first and second sides, respectively, of any one of the digit regions. By way of example only, first and second stays 728, 738 are provided on opposing sides of index finger region 618. The third example glove, designated as glove 710B (FIG. 19C) is substantially identical in structure and function to glove 610B, except that the glove 710B is a hand-specific glove instead of being an ambidextrous glove. Glove 710B has first and second stays on the first and second sides, respectively, of any two of the digit regions. By way of example only, first and second stays 726, 736 are provided on opposing sides of thumb region 716, and first and second stays 728, 738 are provided on opposing sides of index finger region 718. The fourth example glove, designated as glove 710C (FIG. 19D) is substantially identical in structure and function to glove 610C, except that the glove 710A is a hand-specific glove instead of being an ambidextrous glove. Glove 710C has first and second stays on the first and second sides, respectively, of any three of the digit regions. By way of example only, first and second stays 726, 736 are provided on opposing sides of thumb region 716, first and second stays 728, 738 are provided on opposing sides of index finger region 718, and first and second stays 730, 740 are provided on opposing sides of middle finger region 720. The fifth example glove, designated as glove 710D (FIG. 19E) is substantially identical in structure and function to glove 610D, except that the glove 710D is a hand-specific glove instead of being an ambidextrous glove. Glove 710D has first and second stays on the first and second sides, respectively, of any four of the digit regions. By way of example only, first and second stays 726, 736 are provided on opposing sides of thumb region 716, first and second stays 728, 738 are provided on opposing sides of index finger region 718, first and second stays 730, 740 are provided on opposing sides of middle finger region 720, and first and second stays 732, 742 are provided on opposing sides of ring finger region 722.

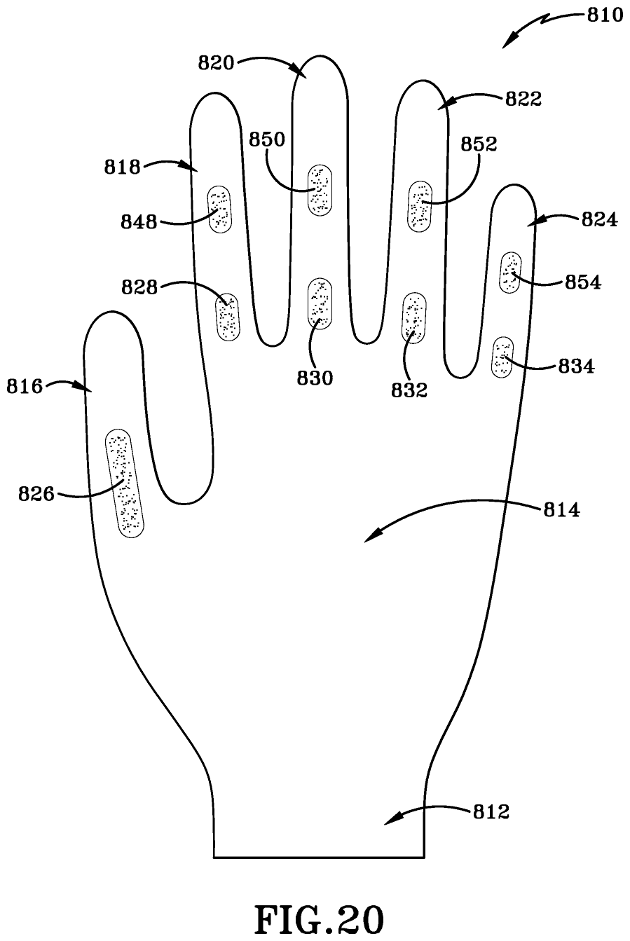

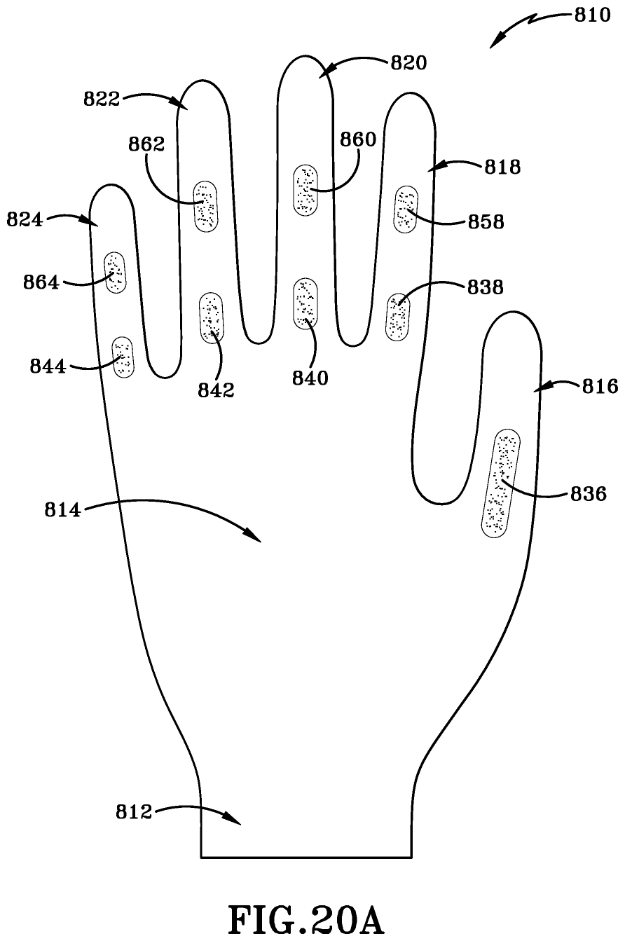

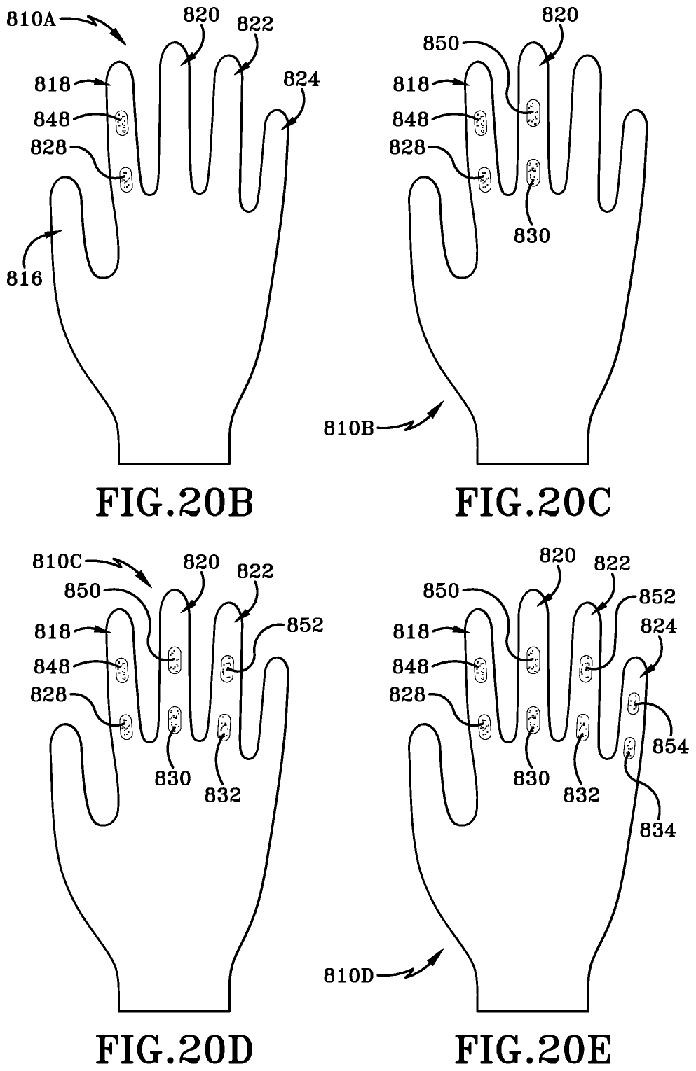

Referring to FIGS. 20-20A show a first example of a ninth embodiment of a glove in accordance with the present disclosure, generally indicated at 810. Glove 810 is substantially identical in structure and function to glove 210 (FIGS. 9-9A) except that glove 810 has a single opposed pair of stays on thumb region 816 and two opposed pairs of stays on all other digit regions. Furthermore, at least the two opposed pair of stays on all the other digit regions are of a different size relative to the stays on glove 210 and the stays on glove 810 are placed at a different location relative to the stays on glove 210. This will be described in greater detail hereafter. All other features of glove 810 are identical in structure and function to glove 210 and therefore will not be discussed in much detail hereafter.

Glove 810 includes a wrist region 812, a palm region 814, and digit regions which extend outwardly from the palm region 814. The digit regions include a thumb region 816, an index finger region 818, a middle finger region 820, a ring finger region 822, and a little finger region 824. In accordance with an aspect of the present disclosure each of the thumb region 816, index finger region 818, middle finger region 820, ring finger region 822, and little finger region 824 includes at least one gripping zone. The at least one gripping zone comprises at least a first stay. The at least one gripping zone may further comprise a second stay. In particular, thumb region 816 includes a first stay 826 on the front of thumb region 816 and a second stay 836 on the back of thumb region 816. First stay 826 and second stay 828 are substantially identical to first stay 226 and second stay 228 on glove 210. Index finger region 818 includes a first stay 828 on the front of index finger region 818 and a second stay 838 on the back thereof. Middle finger region 820 includes a first stay 830 on the front of middle finger region 820 and a second stay 840 on the back thereof. Ring finger region 822 includes a first stay 832 on the front of ring finger region 822 and a second stay 842 on the back thereof. Little finger region 824 includes a first stay 834 on the front of little finger region 824 and a second stay 844 on the back thereof.

First stays 828, 830, 832, 834 are substantially similar in structure and function to first stays 228, 230, 232, and 234 except, as will be discussed hereafter, for the size and location of the first stays on glove 810 relative to the first stays on glove 210. Second stays 838, 840, 842, 844 are substantially similar in structure and function to second stays 238, 240, 242, and 244 except for the size and location of the second stays as will be discussed hereafter. In accordance with an aspect of the present disclosure, the location of first stays 828, 830, 832, 834 and second stays 838, 840, 842, 844 is different from the location of the first and second stays on glove 210. First stays 828, 830, 832, 834 and second stays 838, 840, 842, 844 are located a between palm region 814 and where a person's second knuckle will be positioned when glove 810 is worn. This is in contrast to glove 210 where the stays 238, 240, 242, 244, 238, 240, 242, and 242 extend from a short distance away from palm region 214, over where the second knuckle of the person's finger will be positioned when the glove is worn, and terminate a short distance from where the first knuckle of the person's finger will be positioned when glove 210 is worn. In order for first stays 828, 830, 832, 834 and second stays 838, 840, 842, 844 to be located as described, these gripping zones are shorter than the first and second stays on glove 210.

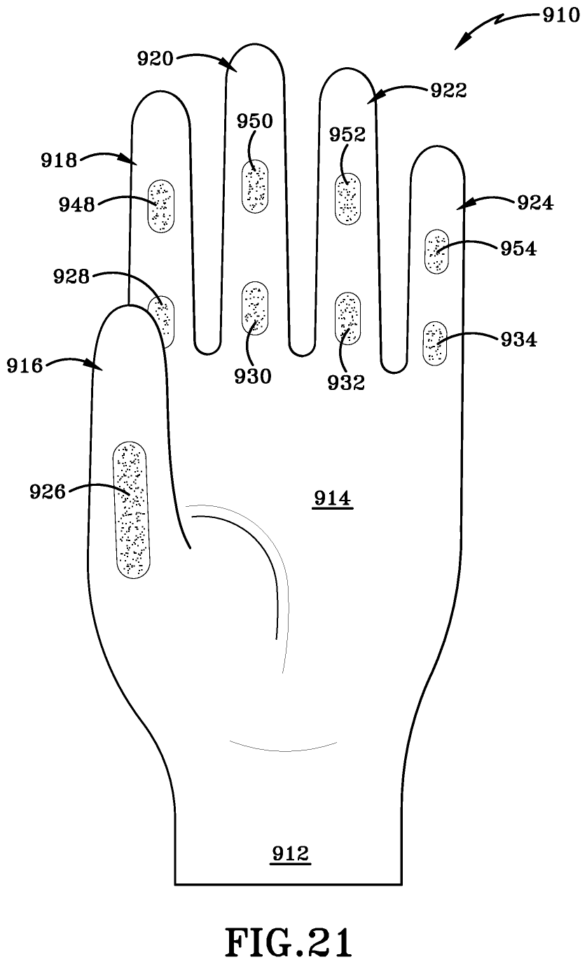

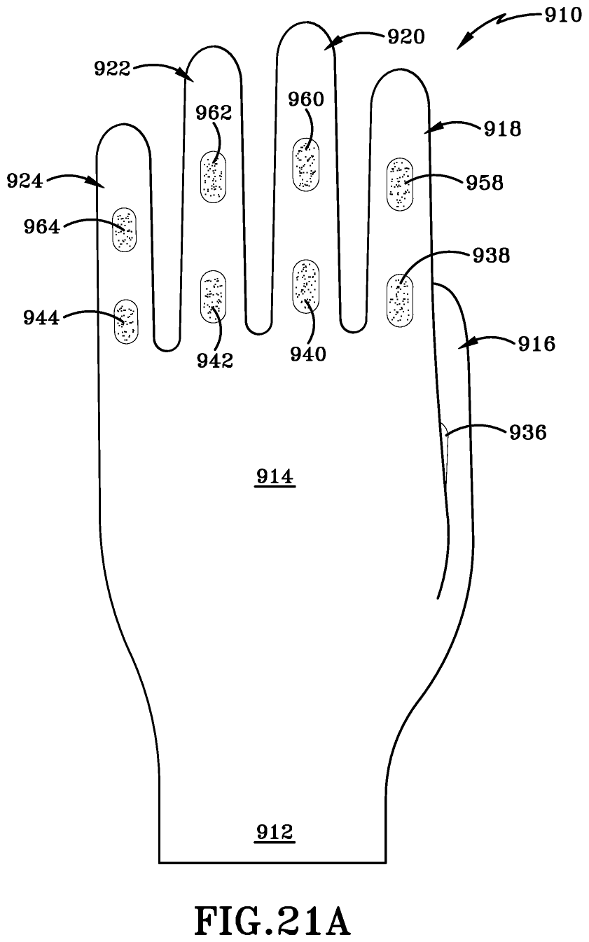

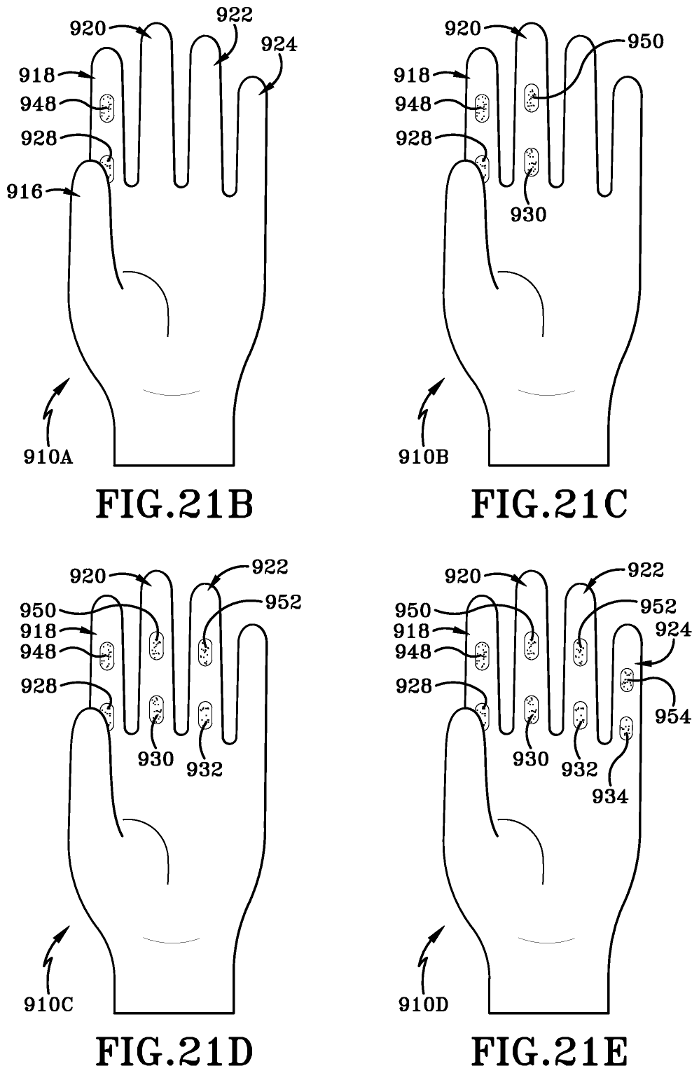

A further difference between glove 810 and glove 210 is that glove 810 further includes a second pair of gripping zones on at least the index finger region 818, middle finger region 820, ring finger region 822, and little finger region 824. As illustrated in FIGS. 20 and 21, each of the index finger region 818, middle finger region 820, ring finger region 822, and little finger region further includes a second pair of opposed gripping zones comprising a third stay provided on the front of the associated digit region and a fourth stay on the back of the associated digit region. The second pair of opposed gripping zones are spaced a distance longitudinally outwardly away from the first pair of opposed gripping zones. The second pair of opposed gripping zones will be located on the digit region between the first pair of opposed gripping zones and the tip of the digit region. In some embodiments, the second pair of opposed gripping zones will be located on the digit region between where the first knuckle and the second knuckle of the person's hand will be positioned when the glove is worn. The third and fourth stays of the second gripping zones are identical in structure and function to the first pair of gripping zones provided on index finger region 828, middle finger region 830, ring finger region 832, and little finger region 834. Third stay and fourth stay are opposed and are laterally aligned with one another. Each of the third stay and the fourth stay is substantially parallel to the longitudinal axis of the associated digit region and is textured in an identical manner to the first stay and second stay provided on the same digit region.

It will be understood that in some instances two longitudinally spaced apart pairs of gripping zones may be provided on thumb region 816 of glove 810. It is noted, however, that providing two longitudinally spaced apart pairs of gripping zones on thumb region 816 provides substantially the same benefits as providing a single pair of longer length gripping zones on thumb region 816 because a person's thumb only has a single knuckle.

FIG. 20 shows a third stay 848 located a distance longitudinally outwardly from the first stay 828 on index finger region 818; a third stay 850 located a distance longitudinally outwardly from first stay 830 on middle finger region 820; a third stay 852 located a distance longitudinally outwardly from first stay 832 on ring finger region 822; and a third stay 854 located a distance longitudinally outwardly from first stay 834 on little finger region 824. FIG. 20A shows a fourth stay 858 located a distance longitudinally outwardly from the second stay 838 on index finger region 818; a fourth stay 860 located a distance longitudinally outwardly from second stay 840 on middle finger region 820; a fourth stay 822 located a distance longitudinally outwardly from second stay 842 on ring finger region 822; and a fourth stay 864 located a distance longitudinally outwardly from second stay 844 on little finger region 824. Each pair of gripping zones helps to ensure there is less slippage of the glove material relative to the person's finger between the knuckles on those fingers and between the lower knuckle and the palm of the person's hand.

FIG. 20B through 20E show a second example, third example, fourth example, and fifth example, respectively, of the ninth embodiment of the glove 810. The second example glove, designated as glove 810A (FIG. 20B) is substantially identical in structure and function to glove 210A, except that the glove 810A includes two longitudinally-spaced apart pairs of gripping zones on any one single digit region. The two longitudinally spaced apart pairs of gripping zones may particularly be provided on any one of the index finger region 818, middle finger region 820, ring finger region 822, and little finger region 824. By way of example only, FIG. 20B shows index finger region 818 including a first stay 828 and a second stay 848. It will be understood that opposed to first stay 828 may be a second stay (identical to second stay 838 shown in FIG. 20A) and that opposed to third stay 848 may be a fourth stay (identical to fourth stay 858 shown in FIG. 20A).

The third example glove, designated as glove 810B (FIG. 20C) is substantially identical in structure and function to glove 210B, except that the glove 810B includes two longitudinally-spaced apart gripping zones on any two digit regions, with each gripping zone being oriented substantially parallel to the longitudinal axis of the respective digit region. By way of example only, FIG. 20C shows first stay 828 and third stay 848 on index finger region 818, and first stay 830 and third stay 850 on middle finger region 820. It will be understood that opposed to first and third stays 828, 848 on index finger region 818 may be second and fourth stays (identical to second and fourth stays 838, 858 shown in FIG. 20A) and that opposed to first and third stays 830, 850 on middle finger region may be second and fourth stays (identical to second and fourth stays 840, 860 shown in FIG. 20A).

The fourth example glove, designated as glove 810C (FIG. 20D) is substantially identical in structure and function to glove 210C, except that the glove 810C includes two longitudinally-spaced apart gripping zones on any three digit regions. By way of example only, FIG. 20D shows first stay 828 and third stay 848 on index finger region 818, first stay 830 and third stay 850 on middle finger region 820, and first stay 832 and third stay 852 on ring finger region 822. It will be understood that opposed to first and third stays 828, 848 on index finger region 818 may be second and fourth stays (identical to second and fourth stays 838, 858 shown in FIG. 20A), opposed to first and third stays 830, 850 on middle finger region may be second and fourth stays (identical to second and fourth stays 840, 860 shown in FIG. 20A), and opposed to first and third stays 832, 852 on ring finger region 822 may be second and fourth stays (identical to second and fourth stays 842, 862 shown in FIG. 20A).

The fifth example glove, designated as glove 810D (FIG. 20E) is substantially identical in structure and function to glove 210D, except that the glove 810D includes two longitudinally-spaced apart gripping zones on all four digit regions but relative to glove 810 does not include a single pair of gripping zones on thumb region 816. By way of example only, FIG. 20E shows first stay 828 and third stay 848 on index finger region 818, first stay 830 and third stay 850 on middle finger region 820, first stay 832 and third stay 852 on ring finger region 822, and first stay 834 and third stay 854 on little finger region 824. It will be understood that opposed to first and third stays 828, 848 on index finger region 818 may be second and fourth stays (identical to second and fourth stays 838, 858 shown in FIG. 20A), opposed to first and third stays 830, 850 on middle finger region may be second and fourth stays (identical to second and fourth stays 840, 860 shown in FIG. 20A), opposed to first and third stays 832, 852 on ring finger region 822 may be second and fourth stays (identical to second and fourth stays 842, 862 shown in FIG. 20A), and opposed to first and third stays 834, 854 on little finger region 824 may be second and fourth stays (identical to second and fourth stays 844 and 864 shown in FIG. 20A).

It will be understood that in some embodiments of the glove 810 there may be no gripping zones on the thumb region 816 and in other embodiments there may be two gripping zones on the thumb region 816. In yet other embodiments, it will be understood that digit regions other than the thumb region 816 may include only a single set of gripping zones while other digit regions include two gripping zones thereon. Any permutation or combination of single sets of gripping zones plus double sets of gripping zones may be provided on the ninth embodiment glove based on the type of function that is to be performed while wearing the gloves. As with glove 210, on glove 810 each stay is provided with texturing, particularly via micro-etching. In one embodiment, the micro-etching will produce a sand pattern of texturing. It will be understood that any other texture pattern may be applied to glove 810 in any other manner.

Referring to FIGS. 21-21A show a first example of a tenth embodiment of a glove in accordance with the present disclosure, generally indicated at 910. Glove 910 is substantially identical in structure and function to glove 810 (FIGS. 20-20A) except that glove 910 is a hand-specific glove instead of an ambidextrous glove. All other features of glove 910 are identical in structure and function to glove 810 and therefore will not be discussed in much detail hereafter.

Glove 910 includes a wrist region 912, a palm region 914, and digit regions which extend outwardly from the palm region 914. The digit regions include a thumb region 916, an index finger region 918, a middle finger region 920, a ring finger region 922, and a little finger region 924. In accordance with an aspect of the present disclosure each of the thumb region 916, index finger region 918, middle finger region 920, ring finger region 922, and little finger region 924 includes at least one gripping zone. In particular, at least one of the digit regions includes at least two longitudinally spaced apart gripping zones. FIGS. 21 and 21A show thumb region 916 includes a first stay 926 on the front of thumb region 916 and a second stay 936 on the back of thumb region 916. Index finger region 918 includes a first stay 928 on the front of index finger region 918 and a second stay 938 on the back thereof. Middle finger region 920 includes a first stay 930 on the front of middle finger region 920 and a second stay 940 on the back thereof. Ring finger region 922 includes a first stay 932 on the front of ring finger region 922 and a second stay 942 on the back thereof. Little finger region 924 includes a first stay 934 on the front of little finger region 924 and a second stay 944 on the back thereof. First stays 926, 928, 930, 932, and 934 are identical in structure and function to first stays 826, 828, 830, 832, and 834. Second stays 936, 938, 940, 942, and 944 are identical in structure and function to second stays 836, 838, 840, 842, and 844.

In accordance with an aspect of the present disclosure, each of the index finger region 918, middle finger region 920, ring finger region 922, and little finger region 924 of glove 910 includes a second pair of opposed gripping zones. Each gripping zone comprises a third stay provided on the front of the associated digit region and a fourth stay provided on the back of the associated digit region. FIG. 21 shows a third stay 948 located a distance longitudinally outwardly from the first stay 928 on index finger region 918 moving in a direction away from palm region 910 and towards the tip of the associate digit region. FIG. 21 shows a third stay 950 located a distance longitudinally outwardly from first stay 930 on middle finger region 920; a third stay 952 located a distance longitudinally outwardly from first stay 932 on ring finger region 922; and a third stay 954 located a distance longitudinally outwardly from first stay 934 on little finger region 924. Third stays 948, 950, 952 and 954 are identical in structure and function to third stays 848, 850, 852, and 854. FIG. 21A shows a fourth stay 958 located a distance longitudinally outwardly from the second stay 938 on index finger region 918; a fourth stay 960 located a distance longitudinally outwardly from second stay 940 on middle finger region 920; a fourth stay 922 located a distance longitudinally outwardly from second stay 942 on ring finger region 922; and a fourth stay 964 located a distance longitudinally outwardly from second stay 944 on little finger region 924. Fourth stays 958, 960, 962 and 964 are identical in structure and function to fourth stays 858, 860, 862, and 864.

It should be noted that each of the first, second, third, and fourth stays provided on the digit regions of glove 910 is a longitudinally-extending concave indentation which forms a projection into the portion of the interior cavity 910a (FIG. 21) defined by the respective digit region. The projection will come into abutting physical contact with the person's finger or thumb received within any particular digit region and will thereby tend to frictionally keep the digit region of glove 910 in place on a person's thumb or finger during use, particularly over a sustained period of time.

FIG. 21B through 21E show a second example, third example, fourth example, and fifth example, respectively, of the tenth embodiment of the glove 910. The second example glove, designated as glove 910A (FIG. 21B) is substantially identical in structure and function to glove 810A, except that the glove 910A is a hand-specific glove which includes two longitudinally-spaced apart pairs of gripping zones on any one single digit region. The two longitudinally spaced apart pairs of gripping zones may particularly be provided on any one of the index finger region 918, middle finger region 920, ring finger region 922, and little finger region 924. By way of example only, FIG. 21B shows index finger region 918 including a first stay 928 and a second stay 948 on the front thereof. It will be understood that, on the back of index finger region 918, opposed to first stay 928, there may be a second stay (identical to second stay 938 shown in FIG. 21A) and that opposed to third stay 948 may be a fourth stay (identical to fourth stay 958 shown in FIG. 21A).

The third example glove, designated as glove 910B (FIG. 21C) is substantially identical in structure and function to glove 810B, except that the glove 910B is a hand specific glove which includes two longitudinally-spaced apart gripping zones on any two digit regions. By way of example only, FIG. 21C shows first stay 928 and third stay 948 on index finger region 918, and first stay 930 and third stay 950 on middle finger region 920. It will be understood that second and fourth stays (identical to second and fourth stays 938, 958 shown in FIG. 21A) may be opposed to first and third stays 928, 948 on index finger region 918 and second and fourth stays (identical to second and fourth stays 940, 960 shown in FIG. 21A) may be opposed to first and third stays 930, 950 on middle finger region 920.

The fourth example glove, designated as glove 910C (FIG. 21D) is substantially identical in structure and function to glove 810C, except that the glove 910C is a hand specific glove which includes two longitudinally-spaced apart gripping zones on any three digit regions. By way of example only, FIG. 21D shows first stay 928 and third stay 948 on index finger region 918, first stay 930 and third stay 950 on middle finger region 920, and first stay 932 and third stay 952 on ring finger region 922. It will be understood that second and fourth stays (identical to second and fourth stays 938, 958; 940, 960; and 942, 962 shown in FIG. 21A) may be provided on each of the index finger region 918, middle finger region 920, and ring finger region 922, respectively.

The fifth example glove, designated as glove 910D (FIG. 21E) is substantially identical in structure and function to glove 810D, except that the glove 910D is a hand specific glove which includes two longitudinally-spaced apart gripping zones on all four digit regions but, relative to glove 910, does not include a single pair of gripping zones on thumb region 916. By way of example only, FIG. 21E shows first stay 928 and third stay 948 on index finger region 918, first stay 930 and third stay 950 on middle finger region 920, first stay 932 and third stay 952 on ring finger region 922, and first stay 934 and third stay 954 on little finger region 924. It will be understood that second and fourth stays (identical to second and fourth stays 938, 958; 940, 960; 942, 962; and 944, 964 shown in FIG. 21A) may be provided on each of the index finger region 918, middle finger region 920, ring finger region 922, and little finger region, respectively.

It will be understood that in some embodiments there may be two longitudinally-spaced apart pairs of gripping zones on at least one, two, or three of the index finger region 918, middle finger region 920, ring finger region 922, and little finger region 922 and the thumb region 916 may include a single gripping zone thereon. In other embodiments there may be two longitudinally-spaced apart pairs of gripping zones on the thumb region 916 and one of the other digit regions may only include one pair of gripping zones thereon. Any permutation or combination of single pairs of gripping zones plus double pairs of gripping zones may be provided on the ninth embodiment glove based on the type of function that is to be performed while wearing the gloves.

Each stay on glove 910 is provided with texturing, particularly via micro-etching. In one embodiment, the micro-etching will produce a sand pattern of texturing. It will be understood that in other embodiments any other type of texture may be provided on any of the stays on glove 910 with the texture being formed in any suitable manner.

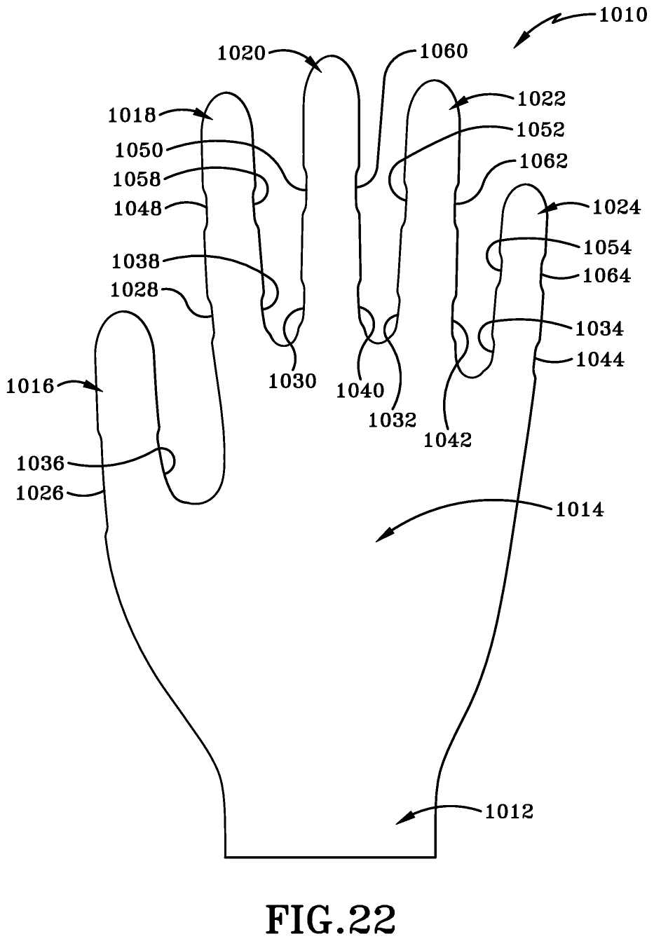

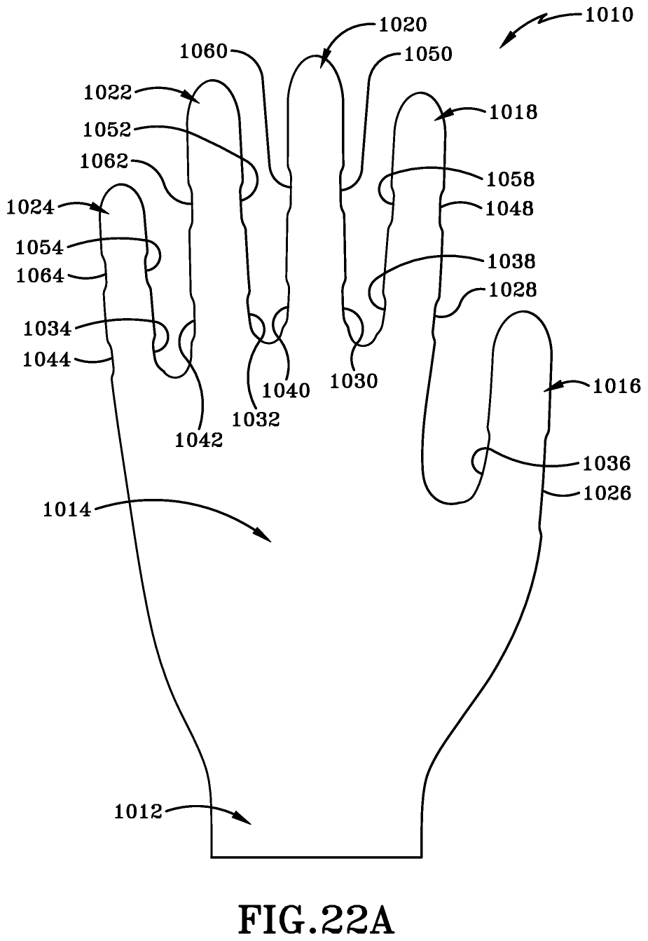

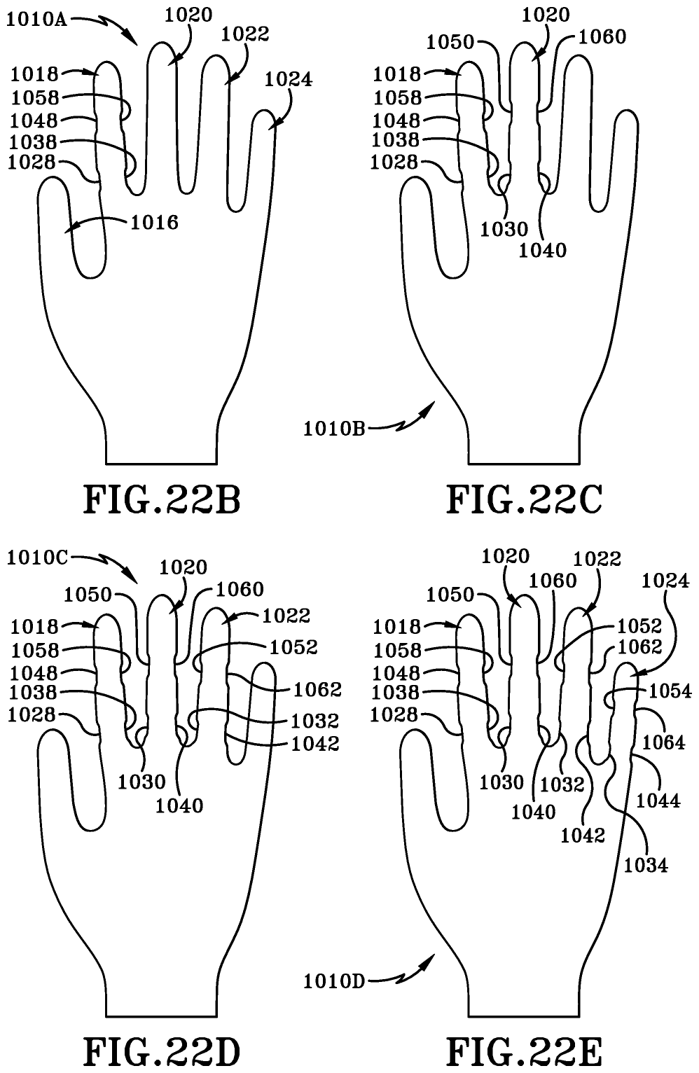

Referring to FIGS. 22-22A show a first example of an eleventh embodiment of a glove in accordance with the present disclosure, generally indicated at 1010. Glove 1010 is substantially identical in structure and function to glove 810 (FIGS. 20-20A) except that in glove 1010 the longitudinally-spaced apart pairs of gripping zones are provided on the first side and the second side of the various digit regions instead of on the front and back of those digit regions. Each gripping zone is oriented substantially parallel to the longitudinal axis of the associated digit region. Each gripping zone on glove 1010 is furthermore substantially identical in structure and function to the first stay and second stay illustrated on the various digit regions of glove 610 illustrated in FIGS. 18-18E. All other features of glove 1010 are identical in structure and function to glove 810 and therefore will not be discussed in much detail hereafter.

Glove 1010 includes a wrist region 1012, a palm region 1014, and digit regions which extend outwardly from the palm region 1014. The digit regions include a thumb region 1016, an index finger region 1018, a middle finger region 1020, a ring finger region 1022, and a little finger region 1024. In accordance with an aspect of the present disclosure each of the thumb region 1016, index finger region 1018, middle finger region 1020, ring finger region 1022, and little finger region 1024 includes at least one gripping zone. The at least one gripping zone comprises at least a first stay formed in the first side of the respective digit region and an opposed second stay formed in the second side of the respective digit region. In particular, thumb region 1016 includes a first stay 1026 on the first side of thumb region 1016 and a second stay 1036 on the second side of thumb region 1016. Index finger region 1018 includes a first stay 1028 on the first side of index finger region 1018 and a second stay 1038 on the second side thereof. Middle finger region 1020 includes a first stay 1030 on the first side of middle finger region 1020 and a second stay 1040 on the second side thereof. Ring finger region 1022 includes a first stay 1032 on the first side of ring finger region 1022 and a second stay 1042 on the second side thereof. Little finger region 1024 includes a first stay 1034 on the first side of little finger region 1024 and a second stay 1044 on the second side thereof.

First stays 1026, 1028, 1030, 1032, and 1034 are identical in structure and function to first stays 826, 828, 830, 832, and 834 except for their placement on the first side of the related digit region instead of on the front thereof. Second stays 1036, 1038, 1040, 1042, and 1044 are identical in structure and function to second stays 836, 838, 840, 842, and 844, except with respect to their placement on the second side of the related digit region instead of on the back thereof.

In accordance with an aspect of the present disclosure, each of the index finger region 1018, middle finger region 1020, ring finger region 1022, and little finger region 1024 includes a second pair of opposed gripping zones which is longitudinally spaced apart from the first pair of gripping zones. As discussed previously herein, the first pair of opposed gripping zones is located between the palm region of the glove and the part of the digit region which is positioned between where a second knuckle of a person's hand will be located when the glove 1010 is worn. In accordance with the present disclosure, the second pair of opposed gripping zones will be located on the digit region between the first pair of opposed gripping zones and the tip of the digit region. In some embodiments, the second pair of opposed gripping zones will be located on the digit region between where the first knuckle and the second knuckle of the person's hand will be positioned when the glove is worn. The second pair of gripping zones is identical in structure and function to the first pair of gripping zones. Each of these additional gripping zones may include a third stay provided on the first side of the associated digit region and a fourth stay on the second side of the associated digit region. Each of the third stay and the fourth stay is substantially parallel to the longitudinal axis of the associated digit region.

FIG. 22 shows a third stay 1048 located a distance longitudinally outwardly from the first stay 1028 on first side of index finger region 1018; a third stay 1050 located a distance longitudinally outwardly from first stay 1030 on the first side of middle finger region 1020; a third stay 1052 located a distance longitudinally outwardly from first stay 1032 on the first side of ring finger region 1022; and a third stay 1054 located a distance longitudinally outwardly from first stay 1034 on the first side of little finger region 1024. FIG. 22A shows a fourth stay 1058 located a distance longitudinally outwardly from the second stay 1038 on the second side of index finger region 1018; a fourth stay 1060 located a distance longitudinally outwardly from second stay 1040 on the second side of middle finger region 1020; a fourth stay 1022 located a distance longitudinally outwardly from second stay 1042 on the second side of ring finger region 1022; and a fourth stay 1064 located a distance longitudinally outwardly from second stay 1044 on the second side of little finger region 1024.

FIG. 22B through 22E show a second example, third example, fourth example, and fifth example, respectively, of the eleventh embodiment of the glove 1010. The second example glove, designated as glove 1010A (FIG. 22B) is substantially identical in structure and function to glove 1010, except that the glove 1010A only has a first pair of gripping zones and a second pair of gripping zones on a single digit region of the glove. By way of example only, first and second stays 1028 and 1038 are provided as the first pair of gripping zones on index finger region 1018 of glove 1010A, and third and fourth stays 1048 and 1058 are provided as the second pair of gripping zones on index finger region 1018. It will be understood that any other of the digit regions of the glove 1010 may instead be provided with the two pairs of longitudinally-spaced apart gripping zones.

The third example glove, designated as glove 1010B (FIG. 22C) is substantially identical in structure and function to glove 1010, except that the glove 1010B only includes two longitudinally-spaced apart gripping zones on any two digit regions. By way of example only, first and second stays 1028 and 1038 and third and fourth stays 1048 and 1058 are provided on index finger region 1018 of glove 1010B. Additionally, first and second stays 1030 and 1040, and third and fourth stays 1050 and 1060 are provided on middle finger region 1020 of glove 1010B. It will be understood that any other two of the digit regions of the glove 1010 may instead be provided with the two pairs of longitudinally-spaced apart gripping zones.

The fourth example glove, designated as glove 1010C (FIG. 22D) is substantially identical in structure and function to glove 1010, except that the glove 1010C only includes two longitudinally-spaced apart gripping zones on any three digit regions. By way of example only, first and second stays 1028, 1038 and third and fourth stays 1048, 1058 are provided on index finger region 1018; first and second stays 1030, 1040 and third and fourth stays 1050, 1060 are provided on middle finger region 1020; and first and second stays 1032, 1042 and third and fourth stays 1052, 1062 are provided on ring finger region 1022 of glove 1010B. It will be understood that any other three of the digit regions of the glove 1010 may instead be provided with the two pairs of longitudinally-spaced apart gripping zones.

The fifth example glove, designated as glove 1010D (FIG. 22E) is substantially identical in structure and function to glove 1010, except that the glove 1010D includes two longitudinally-spaced apart gripping zones on any four of the digit regions. By way of example only, the two longitudinally-spaced apart gripping zones are provided on index finger region 1018, middle finger region 1020, ring finger region 1022, and little finger region 1024. Glove 1010D differs from glove 1010 in that there are no gripping zones on thumb region 1016.

In other embodiments not shown herein, glove 1010D may differ from glove 1010 in that there may be two longitudinally-spaced apart pairs of gripping zones provided on thumb region 1016 instead of only a single pair of gripping zones being provided thereon. In yet other embodiments, one of the index finger region 1018, middle finger region 1020, ring finger region 1022, and little finger region 1024 may not include any gripping zones thereon or may only include one pair of gripping zones thereon and the thumb region 1016 may include two pair of gripping zones thereon. Any permutation or combination of single sets of gripping zones plus double sets of gripping zones on the various digit regions may be provided on the eleventh embodiment glove based on the type of function that is to be performed while wearing the gloves.

Each stay of glove 1010 is provided with texturing, particularly via micro-etching. In one embodiment, the micro-etching will produce a sand pattern of texturing. It will be understood that any other texturing configuration may be provided on any of the stays of glove 1010, with that texture being produced in any suitable manner thereon.

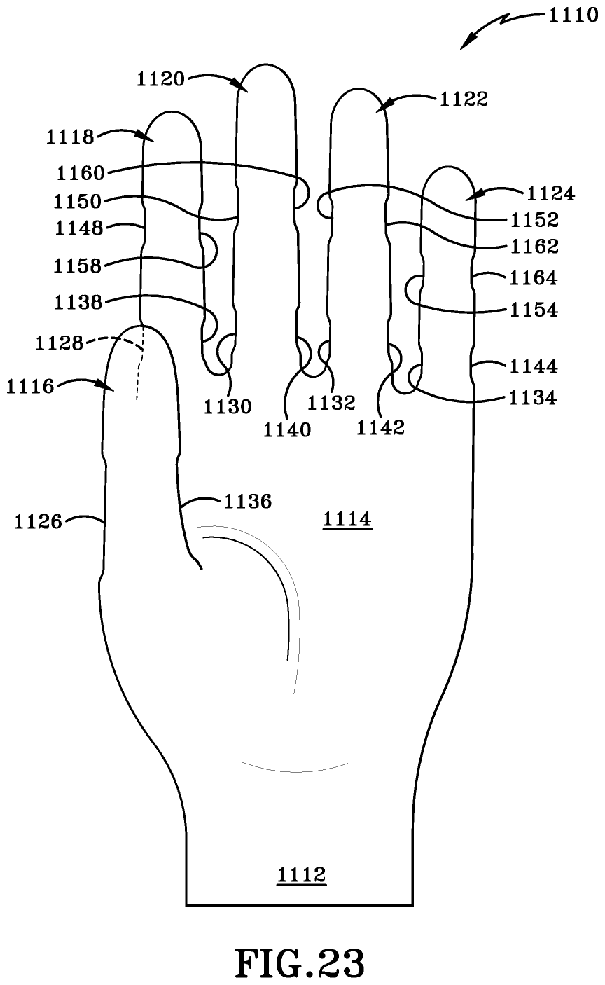

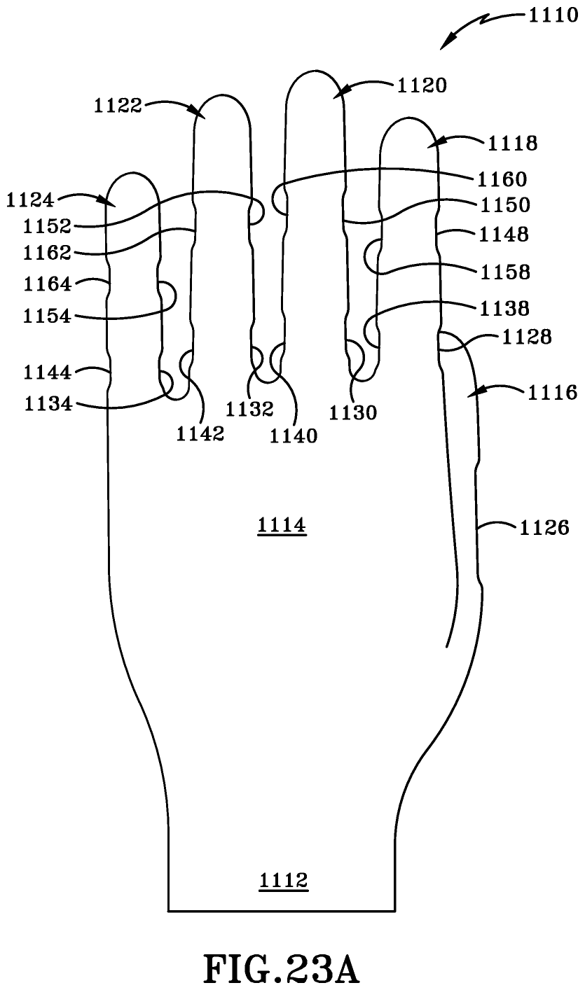

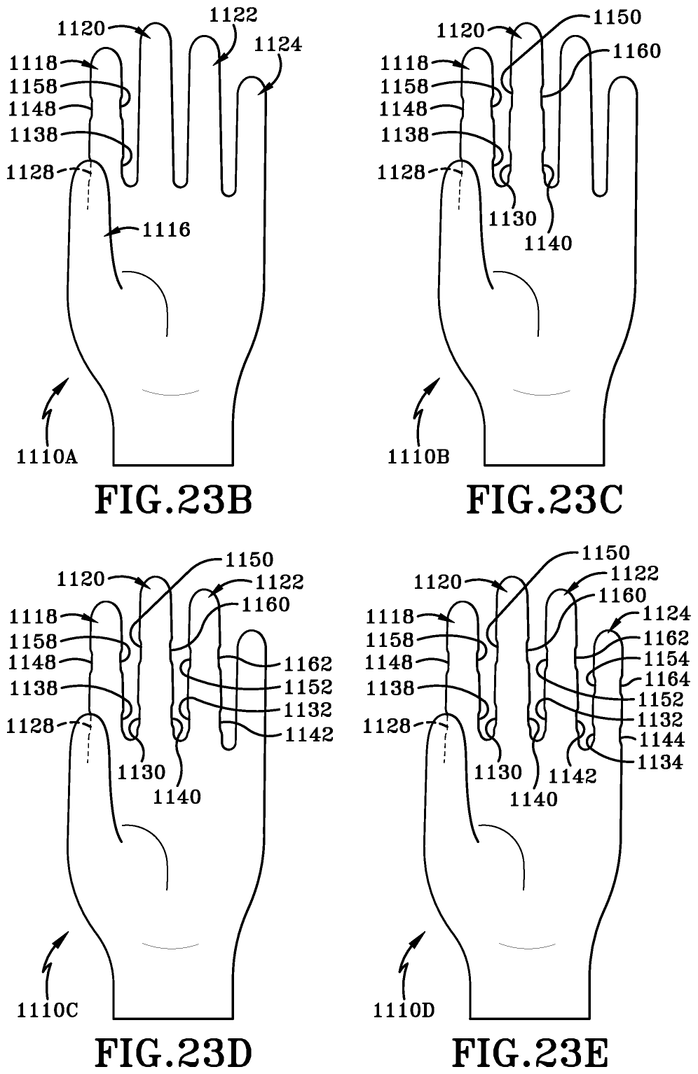

Referring to FIGS. 23-23A show a first example of a twelfth embodiment of a glove in accordance with the present disclosure, generally indicated at 1110. Glove 1110 is substantially identical in structure and function to glove 1010 (FIGS. 22-22A) except that glove 1110 is a hand-specific glove instead of an ambidextrous glove. All other features of glove 1110 are identical in structure and function to glove 1010 and therefore will not be discussed in much detail hereafter.

Glove 1110 includes a wrist region 1112, a palm region 1114, and digit regions which extend outwardly from the palm region 1114. The digit regions include a thumb region 1116, an index finger region 1118, a middle finger region 1120, a ring finger region 1122, and a little finger region 1124. In accordance with an aspect of the present disclosure each of the thumb region 1116, index finger region 1118, middle finger region 1120, ring finger region 1122, and little finger region 1124 includes at least one pair of gripping zones. The at least pair of gripping zones comprises at least a first stay and an opposed second stay which are provided in the first side and second side of the various digit regions. In particular, thumb region 1116 includes a first stay 1126 on the first side of thumb region 1116 and a second stay 1136 on the second side of thumb region 1116. Index finger region 1118 includes a first stay 1128 on the first side of index finger region 1118 and a second stay 1138 on the second side thereof. Middle finger region 1120 includes a first stay 1130 on the first side of middle finger region 1120 and a second stay 1140 on the second side thereof. Ring finger region 1122 includes a first stay 1132 on the first side of ring finger region 1122 and a second stay 1142 on the second side thereof. Little finger region 1124 includes a first stay 1134 on the first side of little finger region 1124 and a second stay 1144 on the second side thereof. First stays 1126, 1128, 1130, 1132, and 1134 are identical in structure and function to first stays 1026, 1028, 1030, 1032, and 1034. Second stays 1136, 1138, 1140, 1142, and 1144 are identical in structure and function to second stays 1036, 1038, 1040, 1042, and 1044.

In accordance with an aspect of the present disclosure, each of the index finger region 1118, middle finger region 1120, ring finger region 1122, and little finger region includes a second pair of opposed gripping zones. Each gripping zone comprises a third stay on the first side of the associated digit region and a fourth stay on the second side of the associated digit region. FIG. 23 shows a third stay 1148 located a distance longitudinally outwardly from the first stay 1128 on the first side of index finger region 1118; a third stay 1150 located a distance longitudinally outwardly from first stay 1130 on the first side of middle finger region 1120; a third stay 1152 located a distance longitudinally outwardly from first stay 1132 on the first side of ring finger region 1122; and a third stay 1154 located a distance longitudinally outwardly from first stay 1134 on the first side of little finger region 1124. Third stays 1148, 1150, 1152, and 1154 are identical in structure and function to third stays 1048, 1050, 1052, and 1054.

FIG. 23A shows a fourth stay 1158 located a distance longitudinally outwardly from the second stay 1138 on the second side of index finger region 1118; a fourth stay 1160 located a distance longitudinally outwardly from second stay 1140 on the second side of middle finger region 1120; a fourth stay 1122 located a distance longitudinally outwardly from second stay 1142 on the second side of ring finger region 1122; and a fourth stay 1164 located a distance longitudinally outwardly from second stay 1144 on the second side of little finger region 1124. Fourth stays 1158, 1160, 1162, and 1164 are identical in structure and function to fourth stays 1058, 1060, 1062, and 1064.

FIG. 23B through 23E show a second example, third example, fourth example, and fifth example, respectively, of the twelfth embodiment of the glove 1110. The second example glove, designated as glove 1110A (FIG. 23B) is substantially identical in structure and function to glove 1010A, except that the glove 1110A is a hand-specific glove. The third example glove, designated as glove 1110B (FIG. 23C) is substantially identical in structure and function to glove 1010B, except that the glove 1110B is a hand-specific glove. The fourth example glove, designated as glove 1110C (FIG. 23D) is substantially identical in structure and function to glove 1010C, except that the glove 1110C is a hand-specific glove. The fifth example glove, designated as glove 1110D (FIG. 23E) is substantially identical in structure and function to glove 1010D, except that the glove 1110D is a hand-specific glove.

FIG. 23B through 23E show a second example, third example, fourth example, and fifth example, respectively, of the eleventh embodiment of the glove 1110. The second example glove, designated as glove 1110A (FIG. 23B) is substantially identical in structure and function to glove 1110, except that the glove 1110A only has a first pair of gripping zones and a second pair of gripping zones on a single digit region of the glove. By way of example only, first and second stays 1128 and 1138 are provided as the first pair of gripping zones on index finger region 1118 of glove 1110A, and third and fourth stays 1148 and 1158 are provided as the second pair of gripping zones on index finger region 1118. It will be understood that any other of the digit regions of the glove 1110 may instead be provided with the two pairs of longitudinally-spaced apart gripping zones.

The third example glove, designated as glove 1110B (FIG. 23C) is substantially identical in structure and function to glove 1110, except that the glove 1110B only includes two longitudinally-spaced apart gripping zones on any two digit regions. By way of example only, first and second stays 1128 and 1138 and third and fourth stays 1148 and 1158 are provided on index finger region 1118 of glove 1110B. Additionally, first and second stays 1130 and 1140, and third and fourth stays 1150 and 1160 are provided on middle finger region 1120 of glove 1110B. It will be understood that any other two of the digit regions of the glove 1110 may instead be provided with the two pairs of longitudinally-spaced apart gripping zones.

The fourth example glove, designated as glove 1110C (FIG. 23D) is substantially identical in structure and function to glove 1110, except that the glove 1110C only includes two longitudinally-spaced apart gripping zones on any three digit regions. By way of example only, first and second stays 1128, 1138 and third and fourth stays 1148, 1158 are provided on index finger region 1118; first and second stays 1130, 1140 and third and fourth stays 1150, 1160 are provided on middle finger region 1120; and first and second stays 1132, 1142 and third and fourth stays 1152, 1162 are provided on ring finger region 1122 of glove 1110B. It will be understood that any other three of the digit regions of the glove 1110 may instead be provided with the two pairs of longitudinally-spaced apart gripping zones.

The fifth example glove, designated as glove 1110D (FIG. 23E) is substantially identical in structure and function to glove 1110, except that the glove 1110D includes two longitudinally-spaced apart gripping zones on any four of the digit regions. By way of example only, the two longitudinally-spaced apart gripping zones are provided on index finger region 1118, middle finger region 1120, ring finger region 1122, and little finger region 1124. Glove 1110D differs from glove 1110 in that there are no gripping zones on thumb region 1116.

In other embodiments not shown herein, glove 1110D may differ from glove 1110 in that there may be two longitudinally-spaced apart pairs of gripping zones provided on thumb region 1116 instead of only a single pair of gripping zones being provided thereon. In yet other embodiments, one of the index finger region 1118, middle finger region 1120, ring finger region 1122, and little finger region 1124 may not include any gripping zones thereon or may only include one pair of gripping zones thereon and the thumb region 1116 may include two pair of gripping zones thereon. Any permutation or combination of single sets of gripping zones plus double sets of gripping zones on the various digit regions may be provided on the eleventh embodiment glove based on the type of function that is to be performed while wearing the gloves.

Each stay of glove 1110 through 1110D is provided with texturing, particularly via micro-etching. In one embodiment, the micro-etching will produce a sand pattern of texturing. It will be understood that any other texturing configuration may be provided on any of the stays of glove 1110 through 1110D, with that texture being produced in any suitable manner thereon.

It will be understood that while one or more digit region in every embodiment of the glove disclosed herein is indicated as having at least one gripping zone therein which is comprised of a first stay and a second stay, in an alternative embodiment the gripping zone may comprise only one of the first stay and the second stay.

In each of the glove embodiments disclosed herein where the at least one gripping zone comprises a first stay and a second stay, those first and second stays are described as being arranged opposed to one another and laterally aligned with one another. It will be understood however, that in other embodiment the first stay and the second stay may not be laterally aligned with one another and/or the first stay and the second stay may not be opposed to one another. For example, there may be a lateral misalignment between the first stay and the second stay and/or one of the first stay and the second stay may be provided on the front or back of the associated digit region and the other of the first stay and the second stay may be provided on the first side or second side thereof.

Still further, while the first stay and second stay have been described herein as being formed on the front and back of the associated digit region or formed in the first side and second side of the associated digit region, it will be understood that in other embodiments, the first stay and second stay may be formed partially in the front or back and partially formed in the associated first side or second side.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A glove comprising:
a wrist region;
a palm region extending outwardly from the wrist region;
a plurality of digit regions extending outwardly from the palm region;
at least one gripping zone provided on at least one digit region of the plurality of digit regions;
wherein the at least one gripping zone is oriented substantially parallel to an imaginary longitudinal axis of the at least one digit region, wherein the imaginary longitudinal axis extends from a tip of the at least one digit region to the palm region;
wherein a respective digit region of the plurality of digit regions includes a first circumference which includes the at least one gripping zone and a second circumference which does not include the at least one gripping zone; and
wherein the first circumference is smaller than the second circumference.

2. The glove according to claim 1, wherein the at least one gripping zone comprises a concave indentation formed in the at least one digit region.

3. The glove according to claim 2, wherein the concave indentation is of a length extending parallel to the imaginary longitudinal axis and extends for a circumferential distance along a circumference of the at least one digit region, where the circumference is orthogonal to the imaginary longitudinal axis; and wherein the length of the concave indentation is greater than the circumferential distance.

4. The glove according to claim 2, wherein the concave indentation projects into an interior cavity defined by the at least one digit region and is configured to frictionally engage a person's finger or thumb received within the interior cavity.

5. The glove according to claim 1, wherein the at least one digit region has a circumference and the at least one gripping zone extends for less than a quarter of the circumference of the at least one digit region.

6. The glove according to claim 1, wherein the at least one gripping zone is provided in one or both of a front and a back of the at least one digit region.

7. The glove according to claim 1, wherein the at least one gripping zone is provided in one or both of a first side and a second side of the at least one digit region.

8. The glove according to claim 1, wherein the at least one gripping zone comprises a first stay and a second stay, wherein the first stay and the second stay are opposed to one another.

9. The glove according to claim 8, wherein the first stay and the second stay are laterally aligned with one another.

10. The glove according to claim 8, wherein each of the first stay and the second stay extend for less than a quarter of a circumference of the at least one digit region.

11. The glove according to claim 8, wherein an end of the first stay and an end the second stay are circumferentially spaced a distance away from one another.

12. The glove according to claim 8, wherein the first stay is provided in a front of the at least one digit region and the second stay is provided in a back of the at least one digit region.

13. The glove according to claim 8, wherein the first stay is provided on a first side of the at least one digit region and the second stay is provided on a second side of the at least one digit region.

14. The glove according to claim 1, further comprising texturing of an exterior surface of the at least one gripping zone.

15. The glove according to claim 1, wherein the texturing is applied through micro-etching.

16. The glove according to claim 1, wherein each of the at least one digit region includes a fingertip region and a remaining portion, wherein the fingertip region originates at the tip of the at least one digit region and extends towards the palm region, wherein the fingertip region terminates in a location which will be adjacent to where a first knuckle of a person's finger or thumb will be when the glove is worn; wherein the remaining portion extends from the fingertip region to the palm region; and wherein the fingertip region is of a reduced circumference relative to the remaining portion.

17. The glove according to claim 16, wherein the remaining portion includes a transition portion which extends outwardly from the fingertip region, wherein the transition portion tapers in circumference moving in a direction from the palm region towards the fingertip region.

18. The glove according to claim 16, wherein the fingertip region is of a bullet-tip configuration.

19. A method comprising:
inserting a person's hand through an opening defined in a wrist region of a glove;
receiving a person's finger or thumb into a digit region of the glove, wherein the digit region has an imaginary longitudinal axis extending from a tip of the digit region to a palm region of the glove;
contacting the person's finger or thumb with at least one gripping zone provided on the digit region, wherein the at least one gripping zone is oriented substantially parallel to the imaginary longitudinal axis of the digit region;
reducing a circumference of the digit region by way of the at least one gripping zone; and
frictionally retaining the digit region in position on the person's finger or thumb through the contact between the at least one gripping zone and the person's finger or thumb.

20. The method according to claim 19, further comprising providing the at least one gripping zone as a first stay and a second stay opposed to one another, wherein each of the first stay and the second stay are formed as an arcuate indentation into an interior cavity defined by the digit region; and wherein the arcuate indentation of the first stay and the second stay frictionally engage opposing surfaces of the person's finger or thumb.
